(19) United States
(12) Patent Application Publication
(10) Pub. No.: US 2024/0404233 A1
(43) Pub. Date: Dec. 5, 2024

(54) METHODS FOR MOVING OBJECTS IN A THREE-DIMENSIONAL ENVIRONMENT

(71) Applicant: Apple Inc., Cupertino, CA (US)

(72) Inventors: Benjamin H. BOESEL, Jackson, WY (US); Jonathan RAVASZ, Sunnyvale, CA (US); Harlan B. HASKINS, Erie, CO (US); Brandon K. SCHMUCK, San Francisco, CA (US); Stephen O. LEMAY, Palo Alto, CA (US); Zoey C. TAYLOR, San Francisco, CA (US)

(21) Appl. No.: 18/731,190

(22) Filed: May 31, 2024

Related U.S. Application Data
(60) Provisional application No. 63/506,112, filed on Jun. 4, 2023.
(60) Provisional application No. 63/506,129, filed on Jun. 4, 2023.
(60) Provisional application No. 63/587,439, filed on Oct. 2, 2023.

(51) Int. Cl. G06T 19/20

(52) U.S. Cl. CPC G06T 19/20; G06T 2219/2004; G06T 2219/2016

(57) ABSTRACT

In some embodiments, a computer system facilitates the movement and/or placement of first virtual objects with respect to second virtual objects in a three-dimensional environment in accordance with some embodiments. In some embodiments, the computer system utilizes different movement algorithms for moving objects in a three-dimensional environment in accordance with some embodiments.

### CROSS-REFERENCE TO RELATED APPLICATIONS

This application claims the benefit of U.S. Provisional Application No. 63/506,112, filed Jun. 4, 2023, U.S. Provisional Application No. 63/506,129, filed Jun. 4, 2023, and U.S. Provisional Application No. 63/587,439, filed Oct. 2, 2023, the contents of which are herein incorporated by reference in their entireties for all purposes.

### TECHNICAL FIELD

The present disclosure relates generally to computer systems that provide graphical user interfaces, including but not limited to electronic devices that facilitate movement of objects in three-dimensional environments.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a first virtual object at a first location and a second virtual object at a second location, different from the first location, in a three-dimensional environment, wherein the second virtual object is a container that is able to contain the first virtual object. In some embodiments, the computer system moves the first virtual object in the three-dimensional environment in accordance with a first input corresponding to a request to move the first virtual object away from the first location in the three-dimensional environment. In this manner, in accordance with a determination that the first input corresponds to movement of the first virtual object to a third location in the three-dimensional environment that is within the threshold distance of the second location of the second virtual object, the computer system displays the first virtual object with an orientation in the three-dimensional environment that is based on an orientation of the second virtual object. In some embodiments, in accordance with a determination that the first input corresponds to movement of the first virtual object to a fourth location in the three-dimensional environment that is further than the threshold distance from the second location of the second virtual object, the computer system displays the first virtual object with an orientation that is independent of an orientation of the second virtual object.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7BB illustrate examples of a computer system facilitating the movement and/or placement of first virtual objects with respect to second virtual objects in a three-dimensional environment in accordance with some embodiments.

FIG. 8 is a flow diagram illustrating an exemplary method of facilitating the movement and/or placement of first virtual objects with respect to second virtual objects in a three-dimensional environment in accordance with some embodiments.

FIG. 9 is a flow diagram illustrating an exemplary method of utilizing different movement algorithms for moving objects in a three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a first virtual object at a first location and a second virtual object at a second location, different from the first location, in a three-dimensional environment, wherein the second virtual object is a container that is able to contain the first virtual object. In some embodiments, the computer system moves the first virtual object in the three-dimensional environment in accordance with a first input corresponding to a request to move the first virtual object away from the first location in the three-dimensional environment. In this manner, in accordance with a determination that the first input corresponds to movement of the first virtual object to a third location in the three-dimensional environment that is within the threshold distance of the second location of the second virtual object, the computer system displays the first virtual object with an orientation in the three-dimensional environment that is based on an orientation of the second virtual object. In some embodiments, in accordance with a determination that the first input corresponds to movement of the first virtual object to a fourth location in the three-dimensional environment that is further than the threshold distance from the second location of the second virtual object, the computer system displays the first virtual object with an orientation that is independent of an orientation of the second virtual object. In some embodiments, the computer system displays a virtual shadow overlaying a first virtual object when a second virtual object is moved within a threshold distance of the first virtual object.

In some embodiments, the computer system displays a first virtual object at a first location and a second virtual object at a second location, different from the first location, in a three-dimensional environment, wherein the second virtual object is a container that is able to contain the first virtual object. In some embodiments, the computer system moves the first virtual object in the three-dimensional environment in accordance with a first input including a movement component that corresponds to a request to move the first virtual object away from the first location in the three-dimensional environment. In this manner, in accordance with a determination that a viewpoint of a user of the computer system has a first orientation relative to the second virtual object, the computer system moves the first virtual object with first movement that is based on the movement component of the first input. In some embodiments, and in accordance with a determination that the viewpoint of the user of the computer system has a second orientation relative to the second virtual object, different from the first orientation, the computer system moves the first virtual object with second movement that is based on the movement component of the first input, wherein the second movement is different from the first movement.

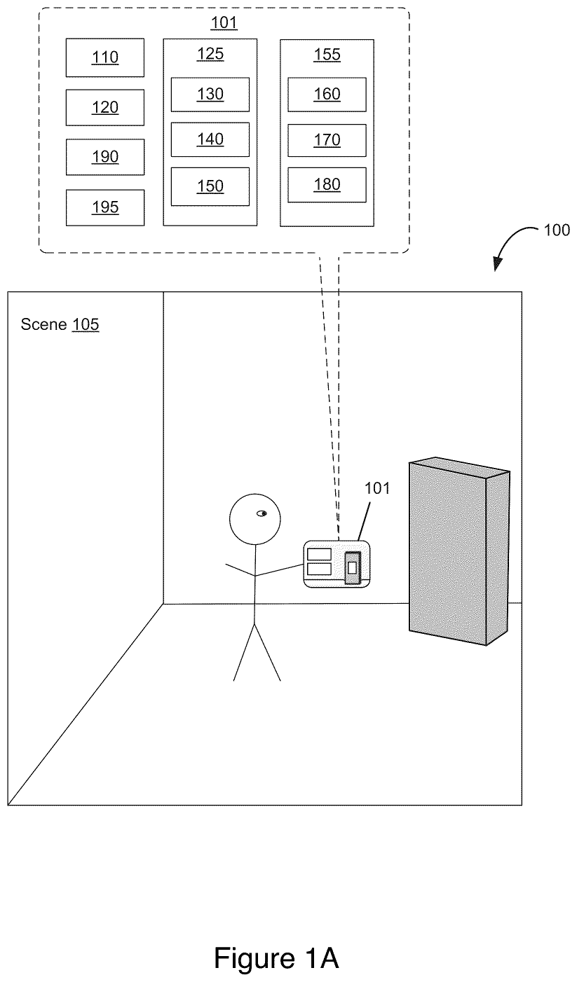

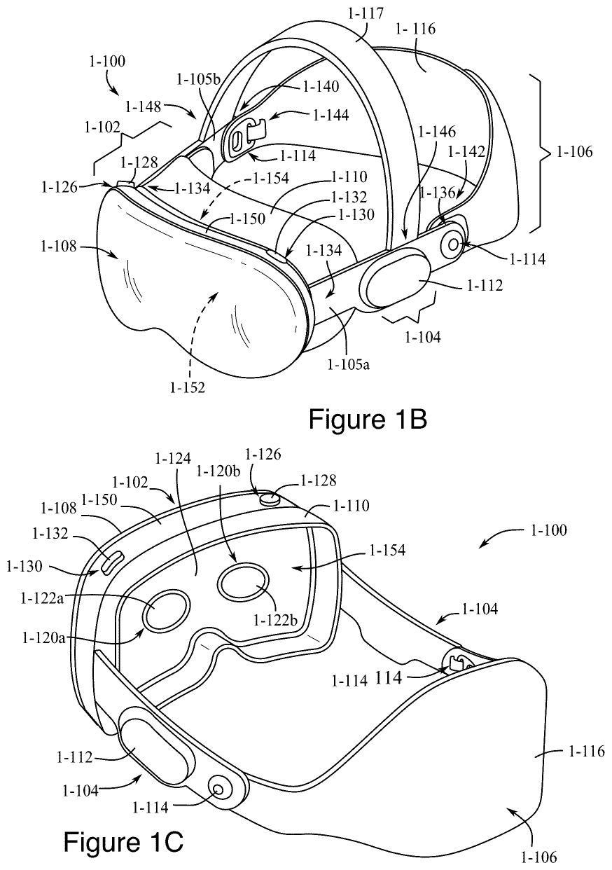

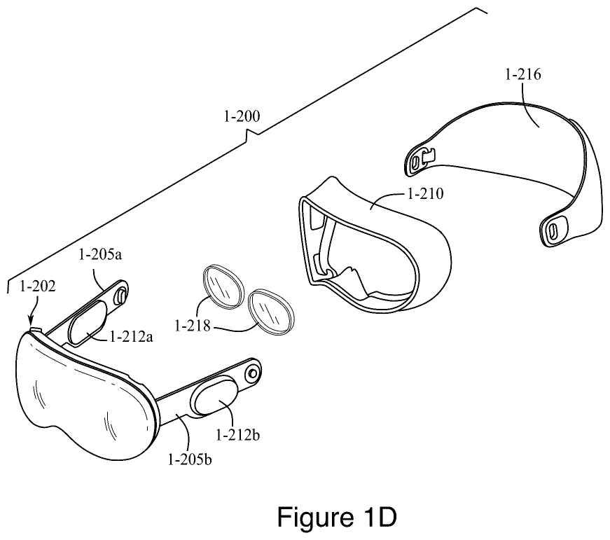

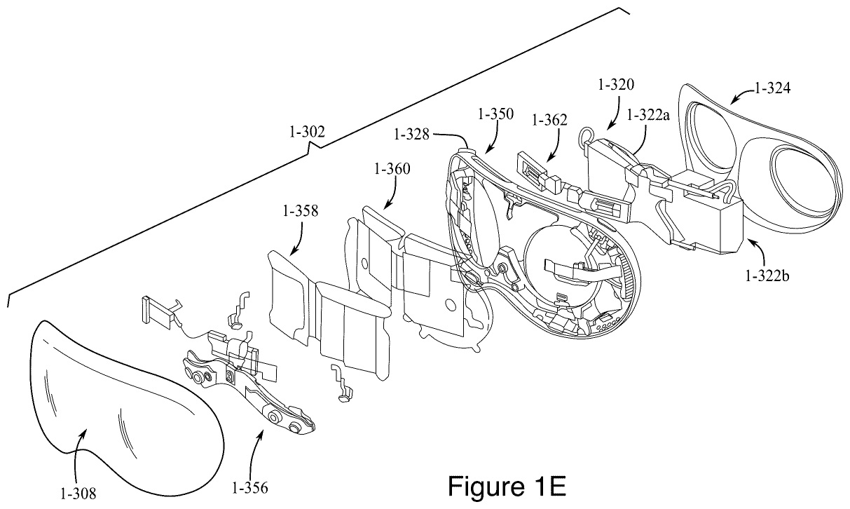

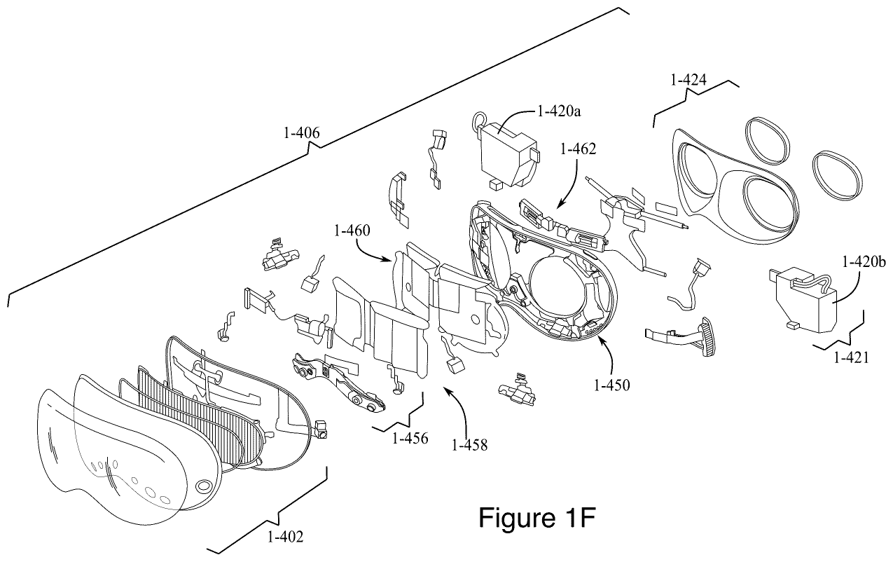

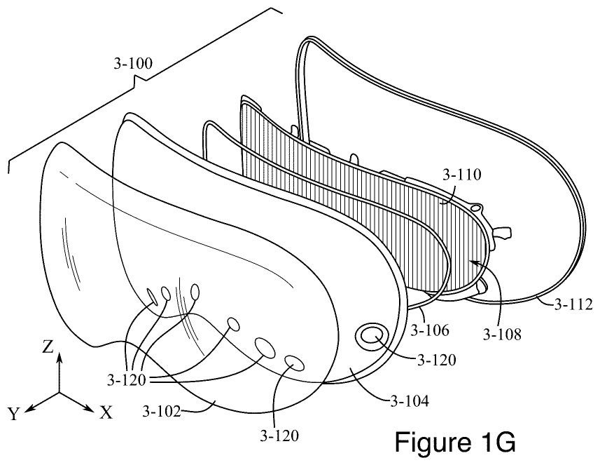

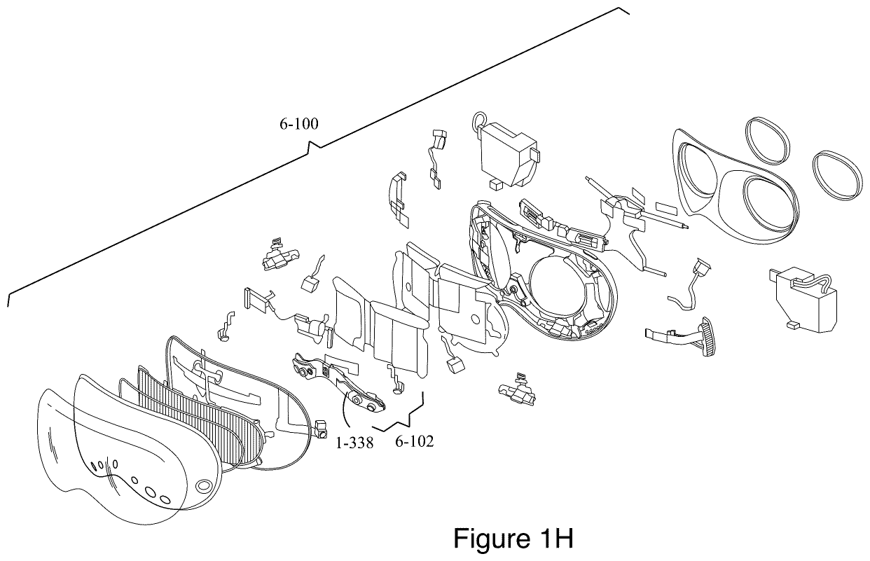

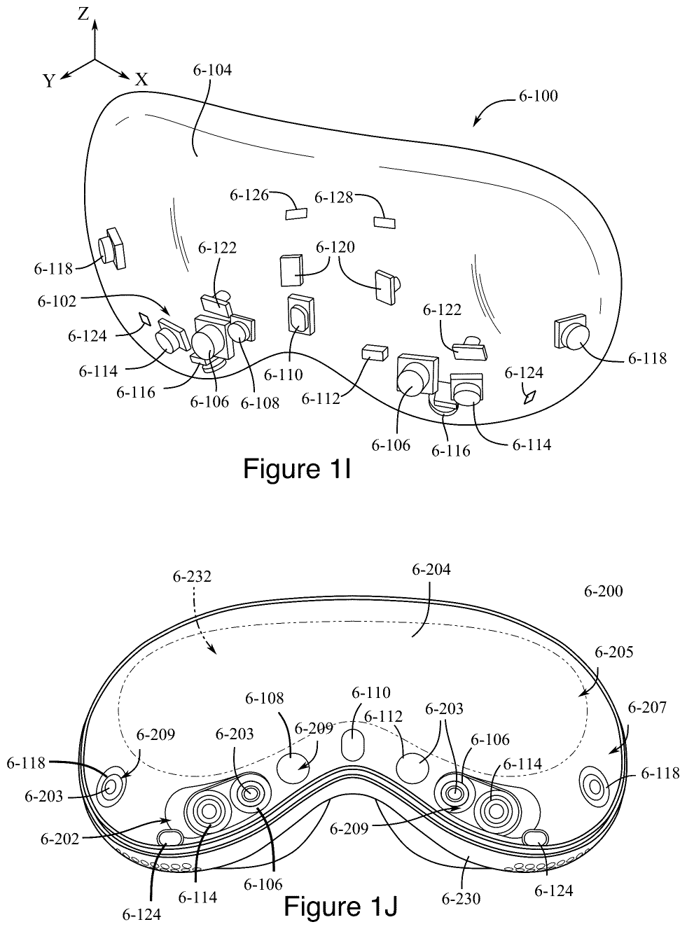

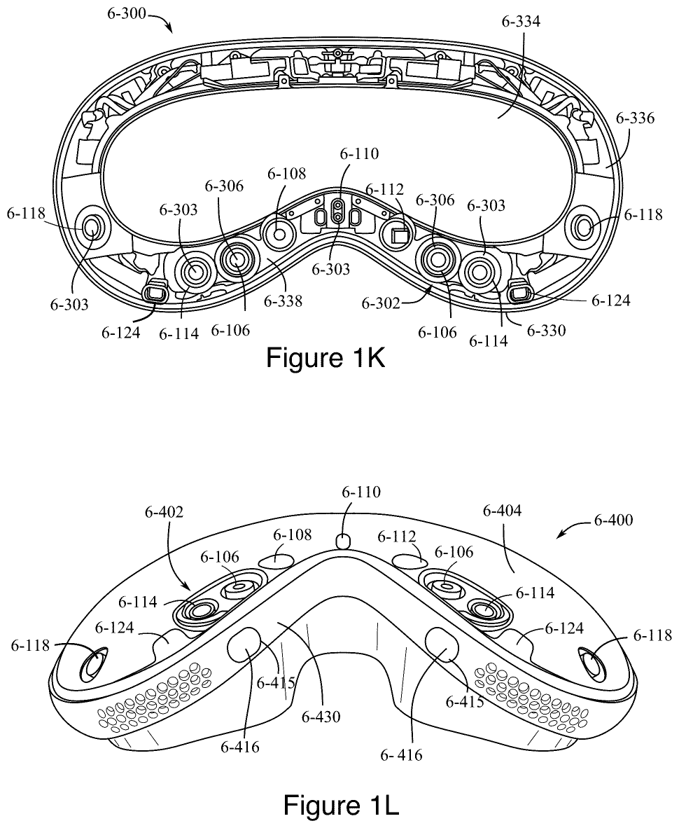

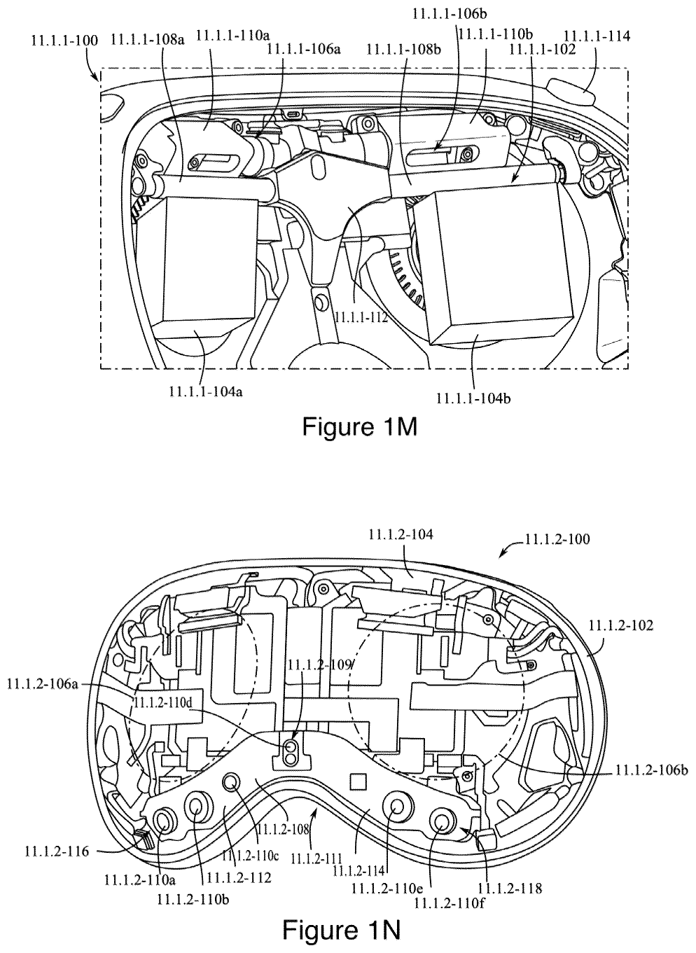

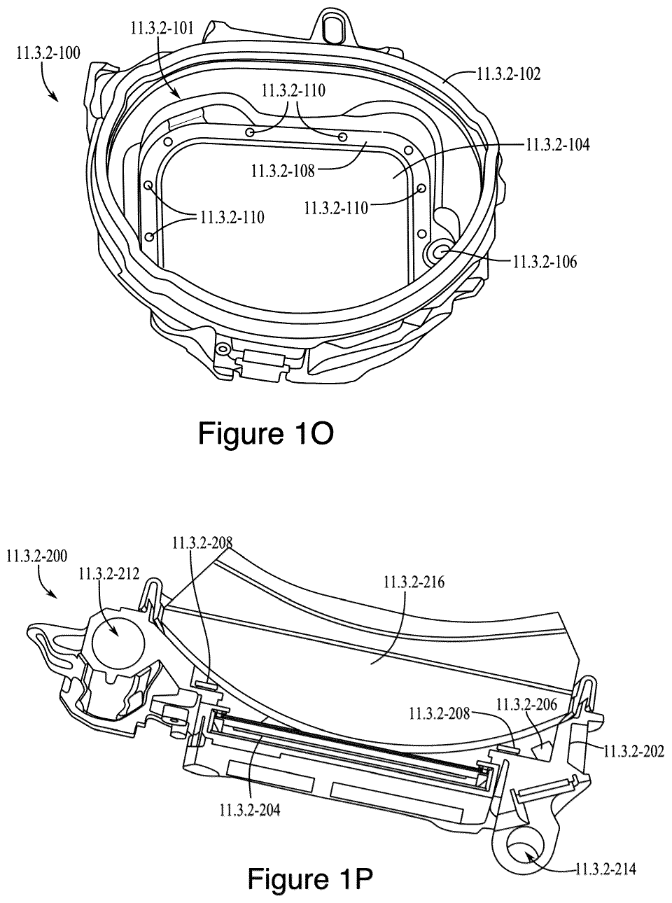

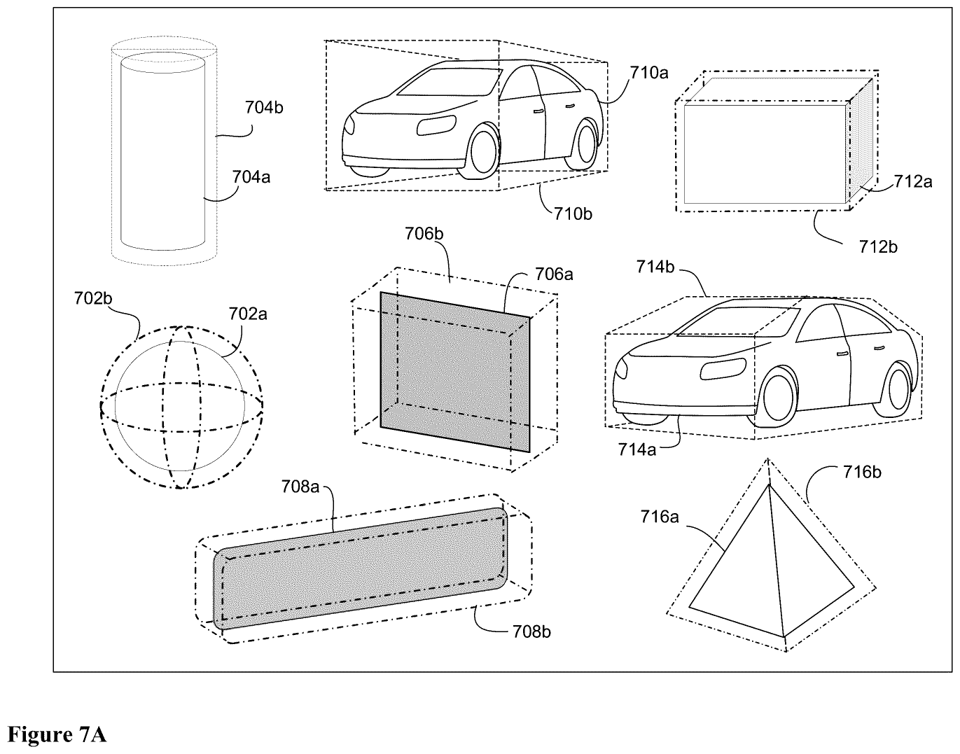

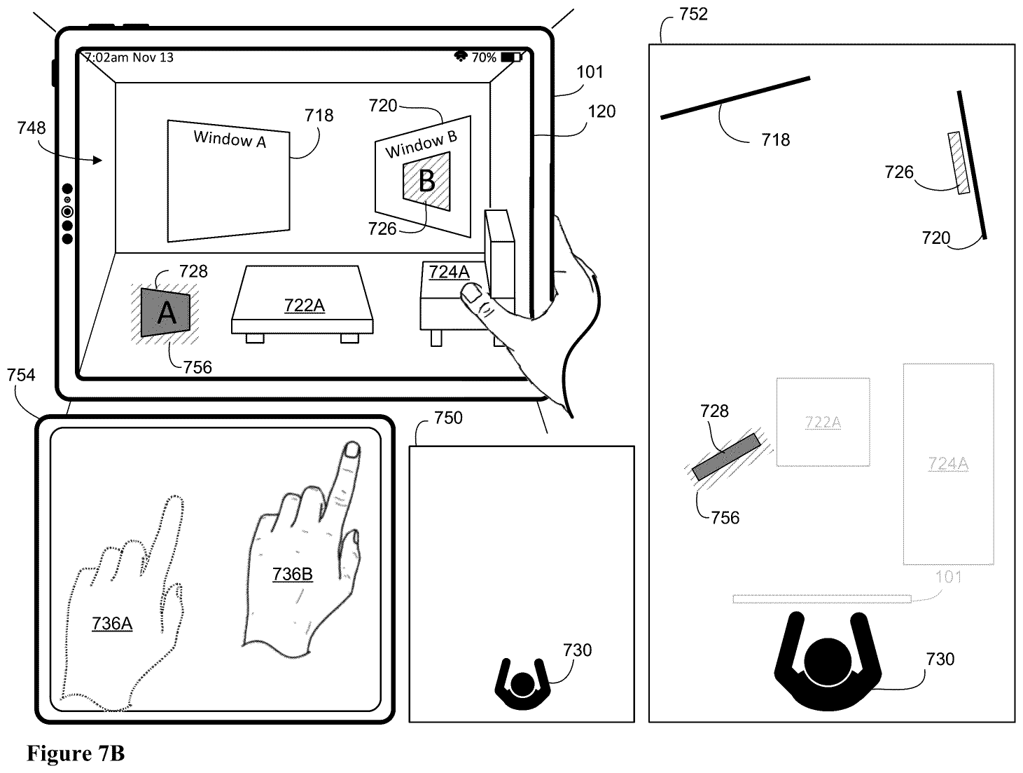

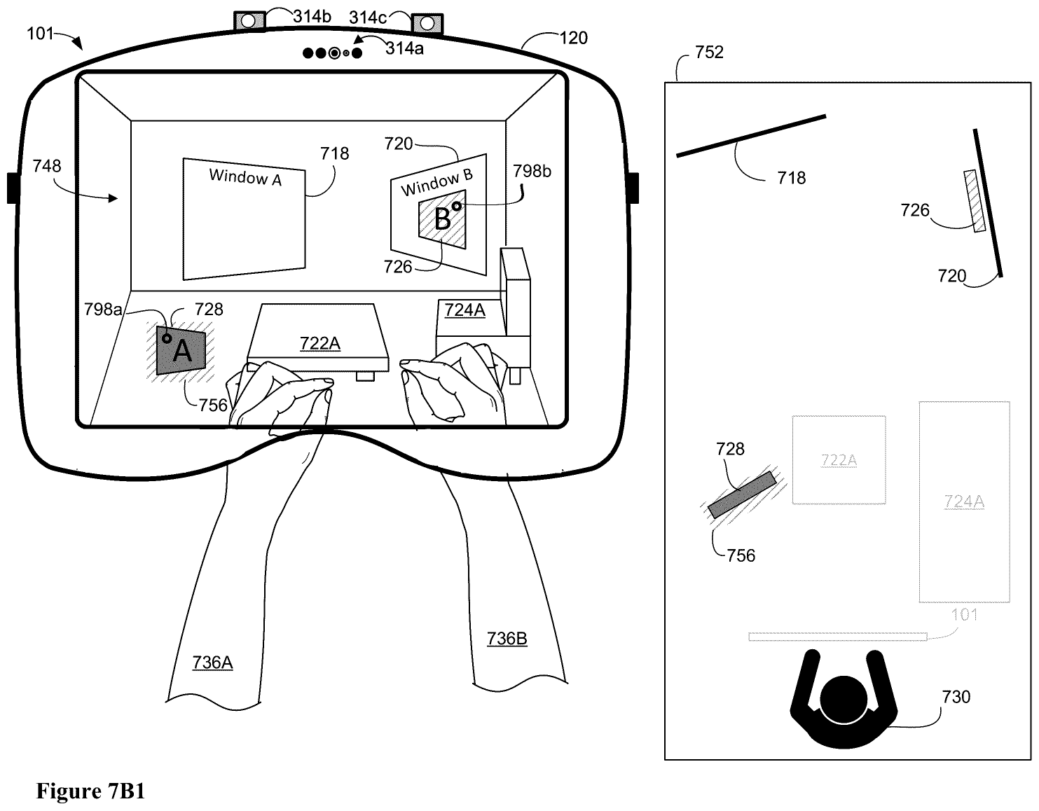

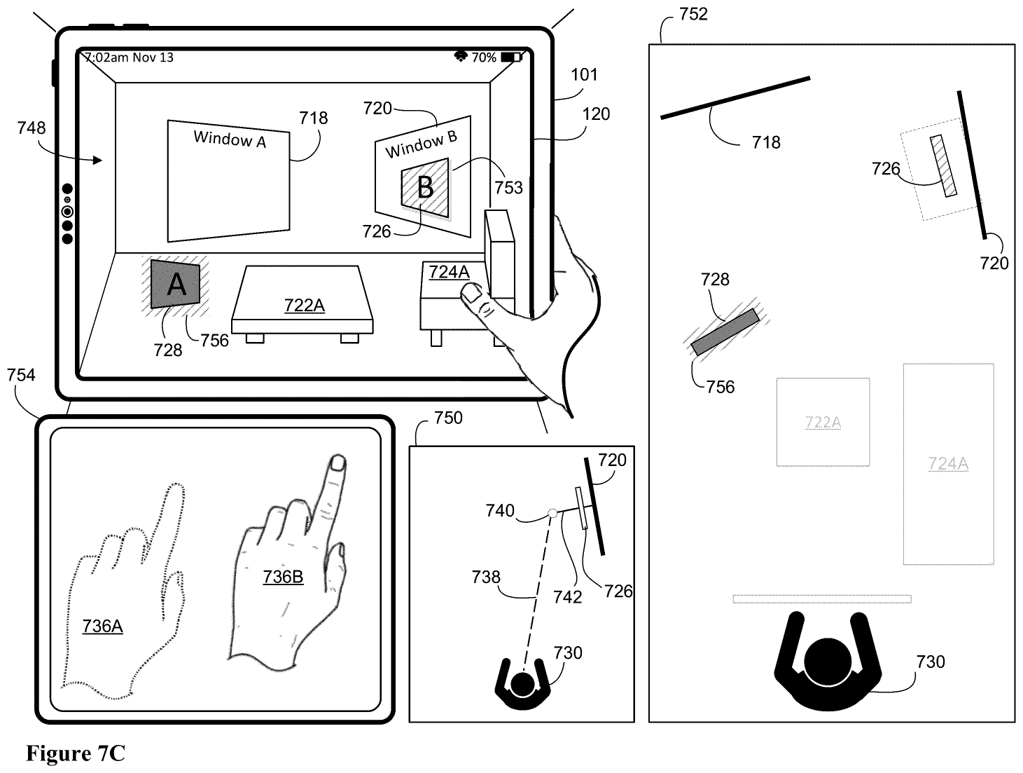

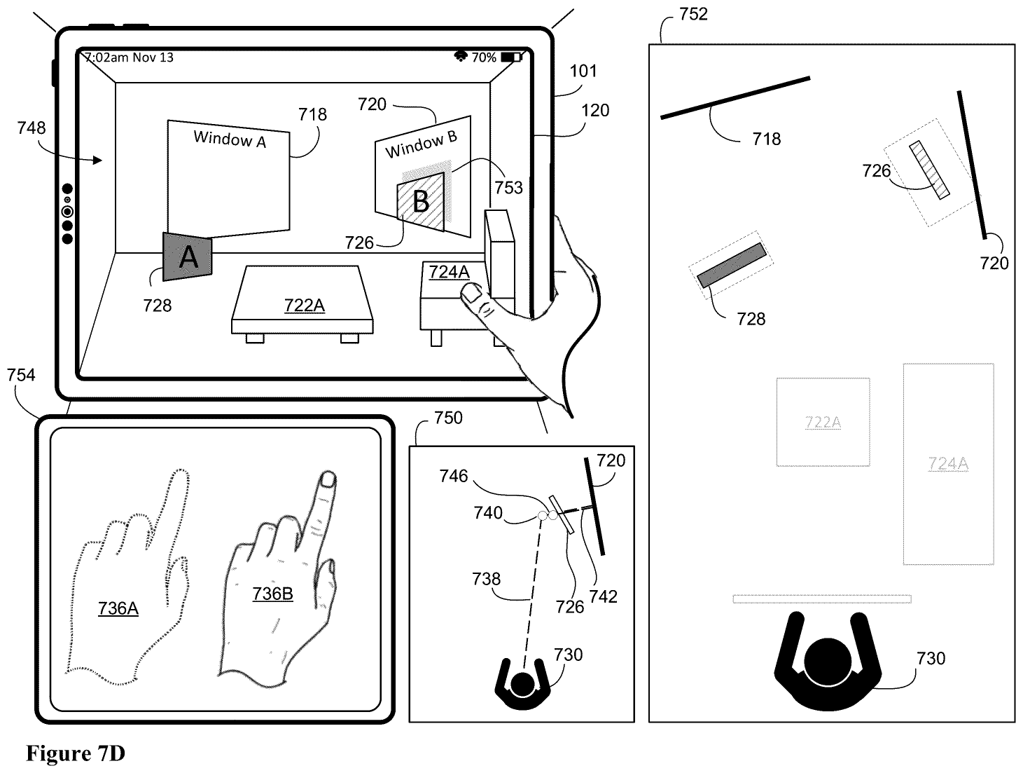

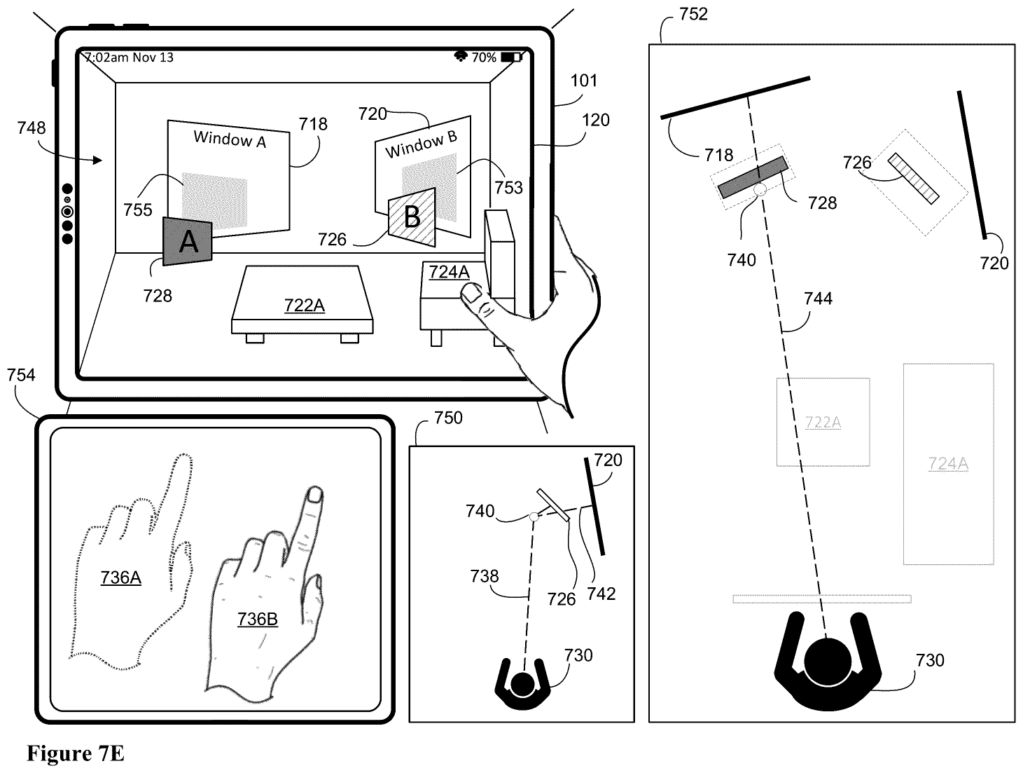

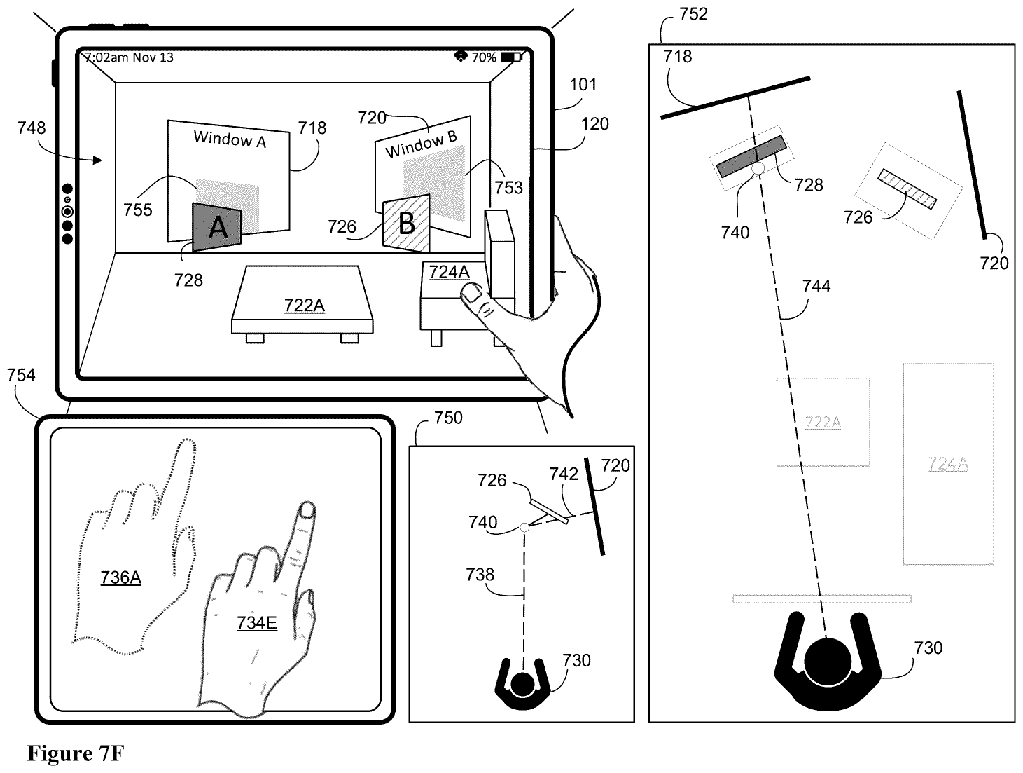

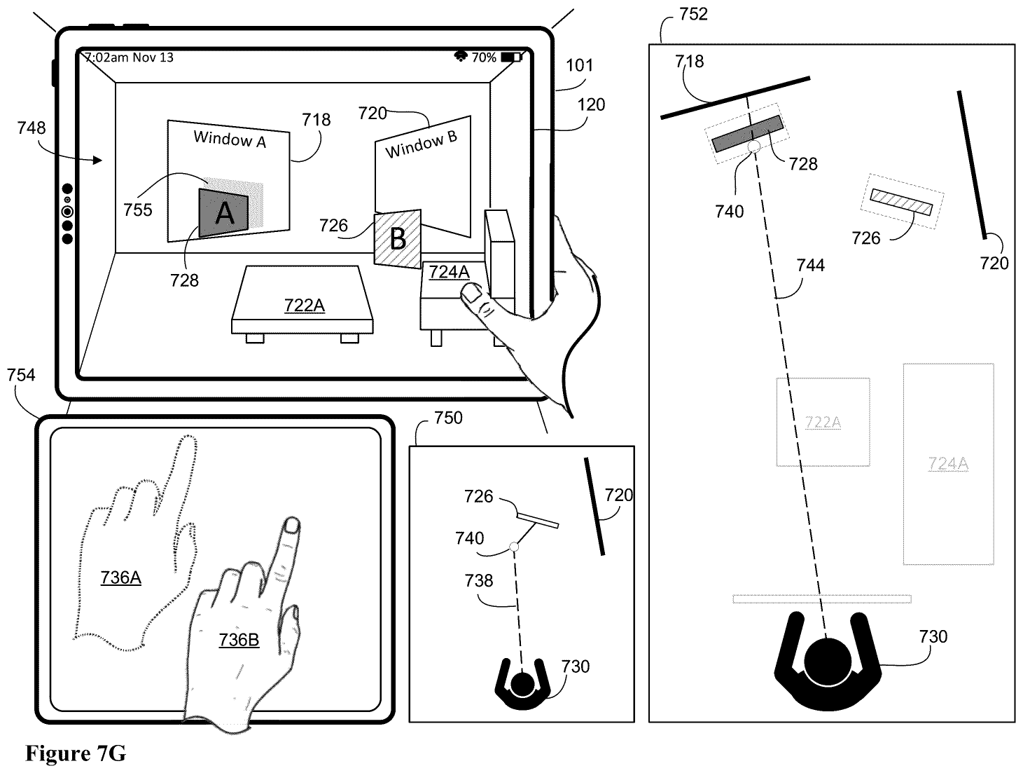

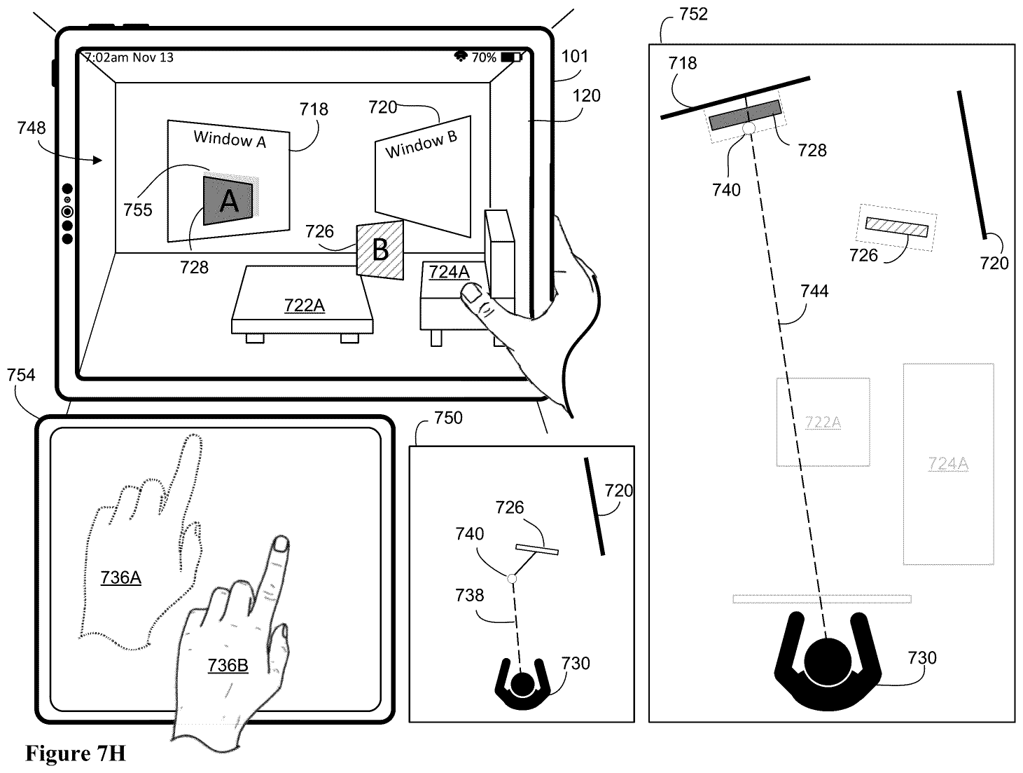

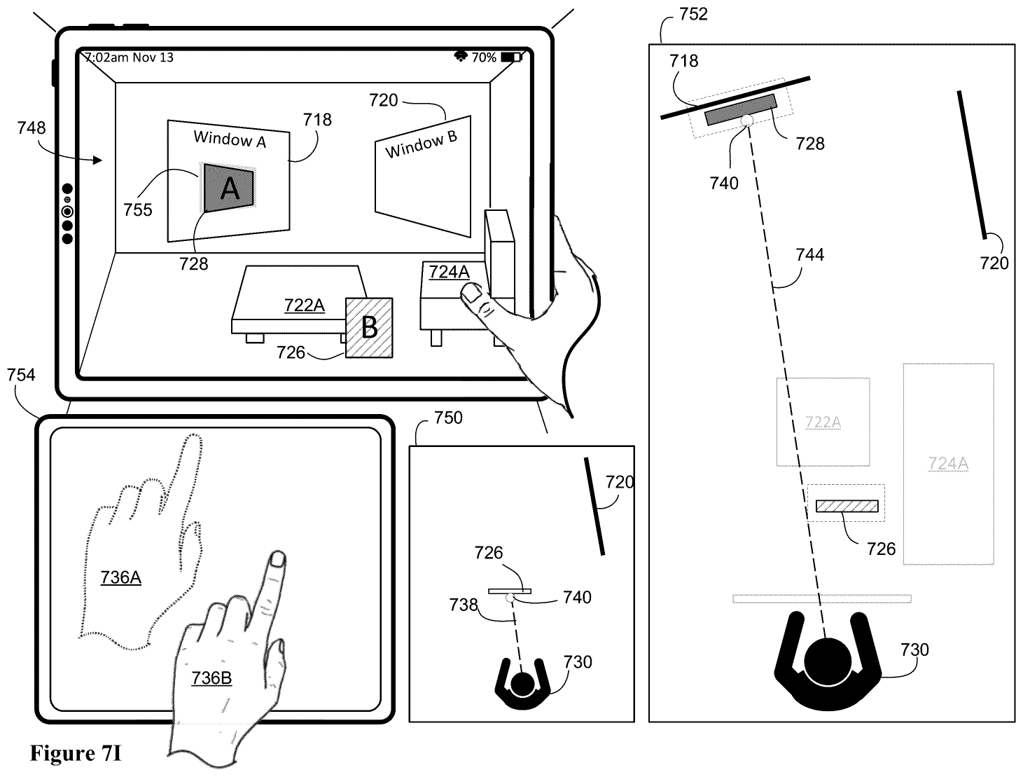

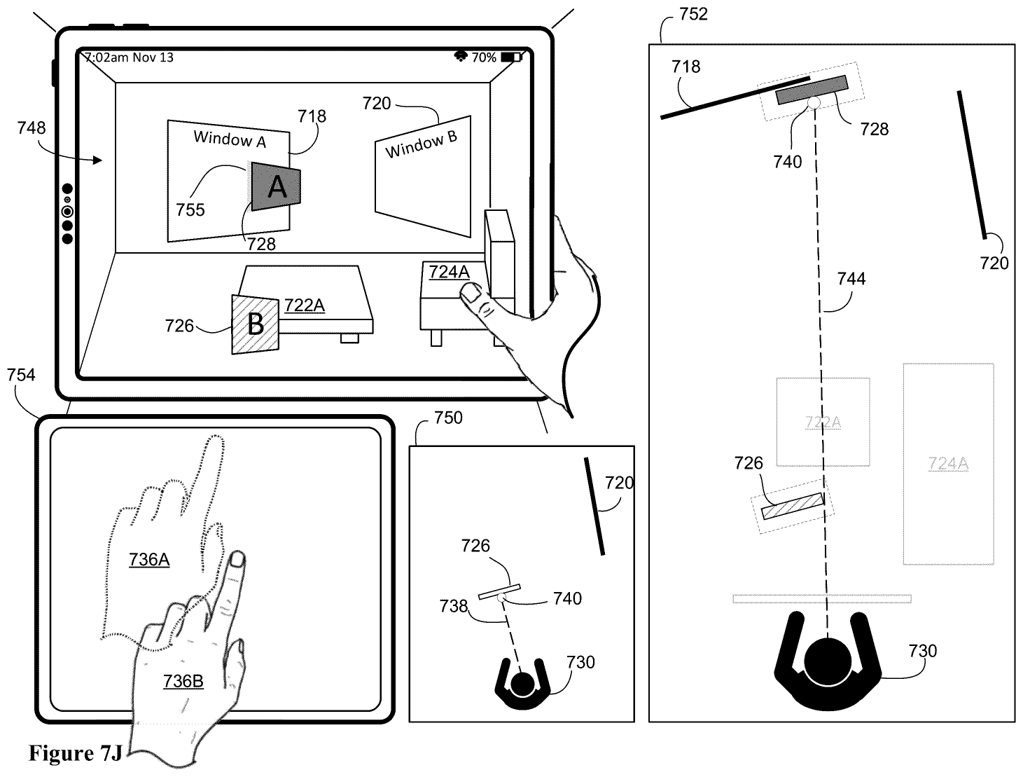

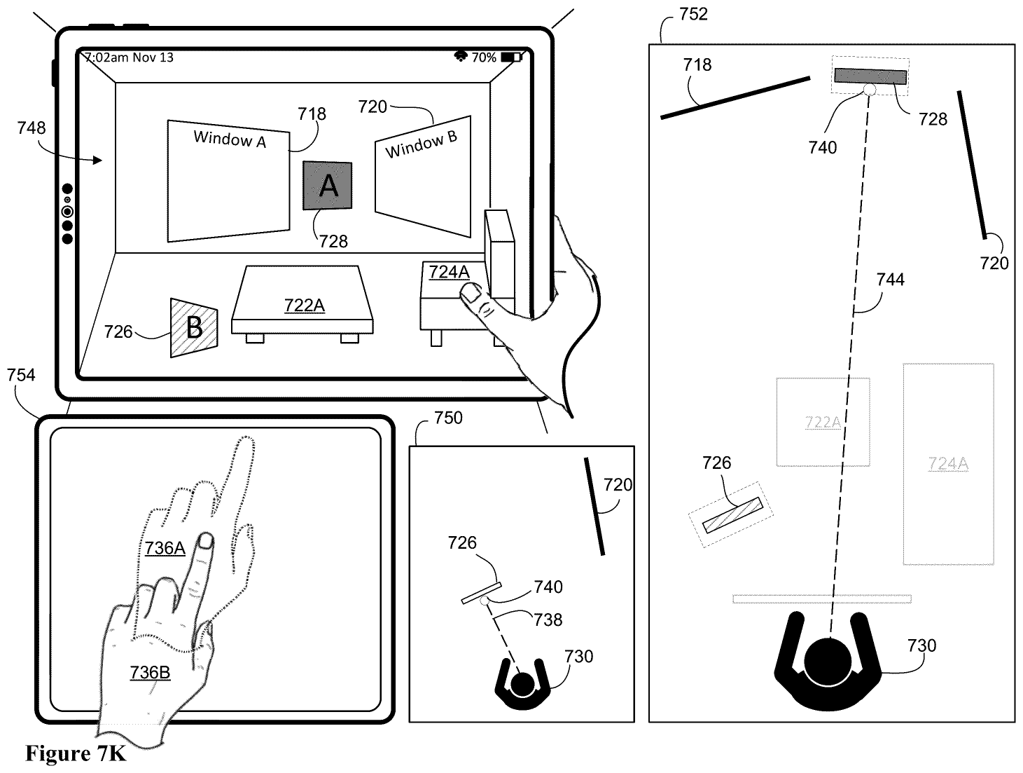

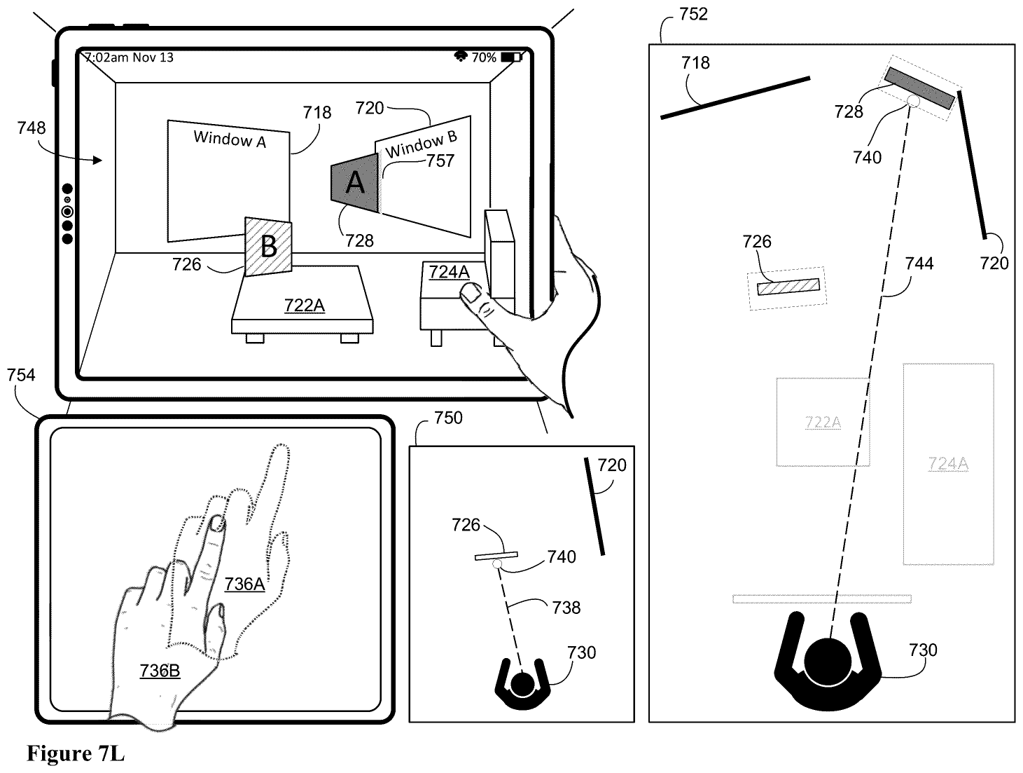

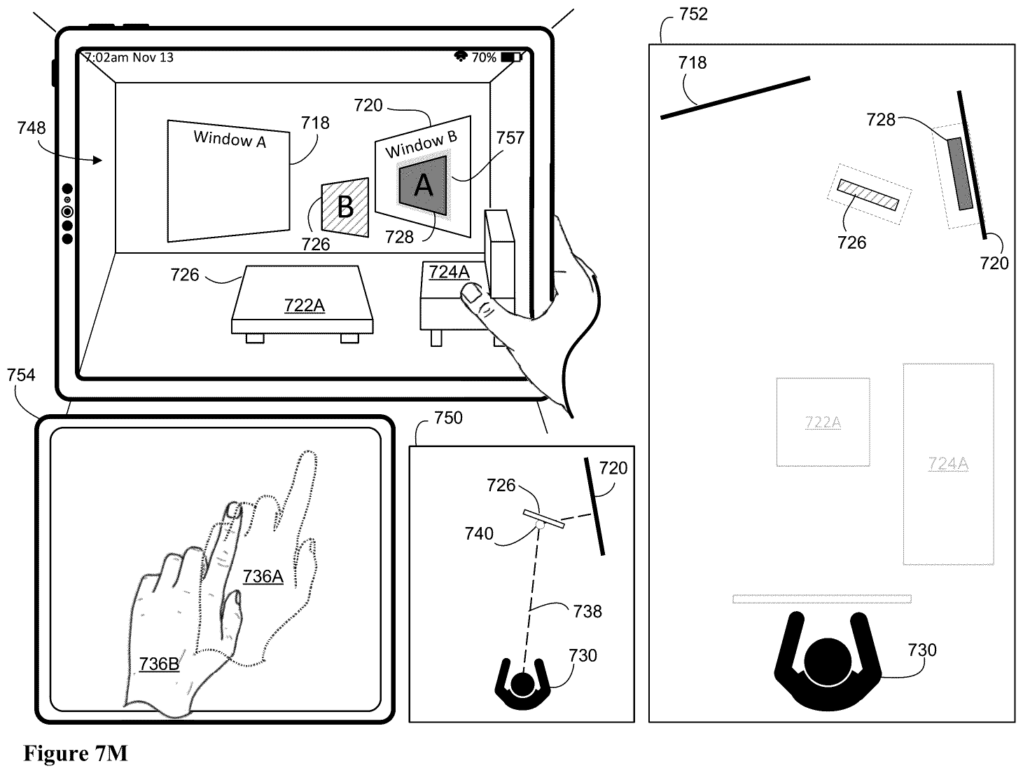

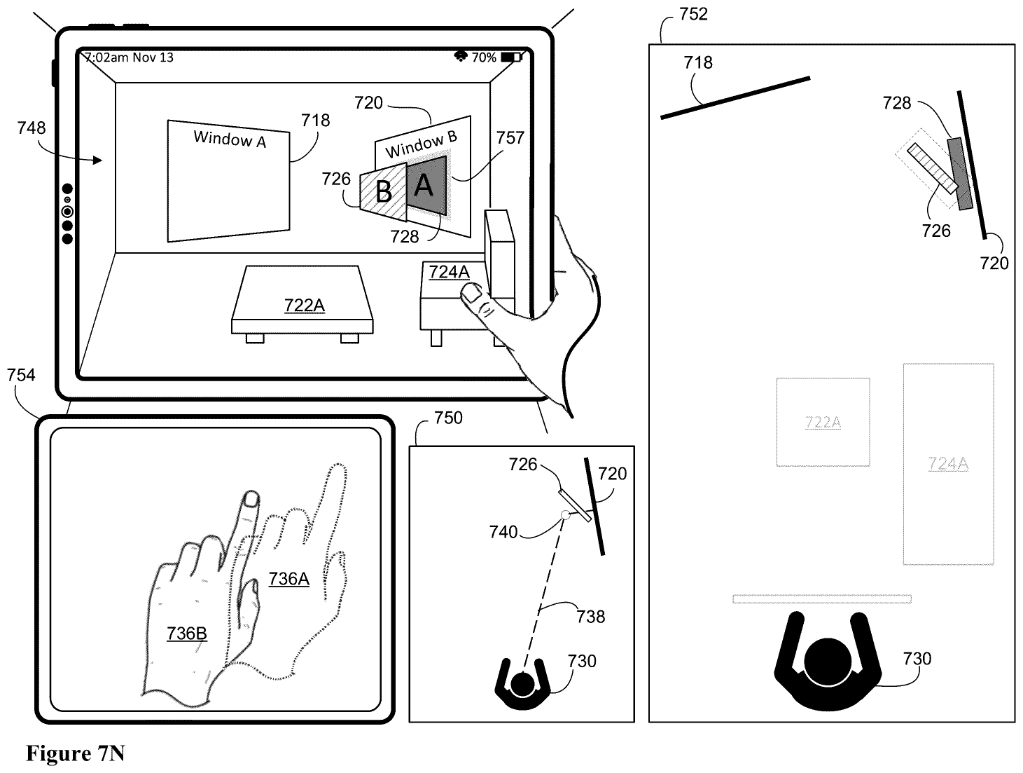

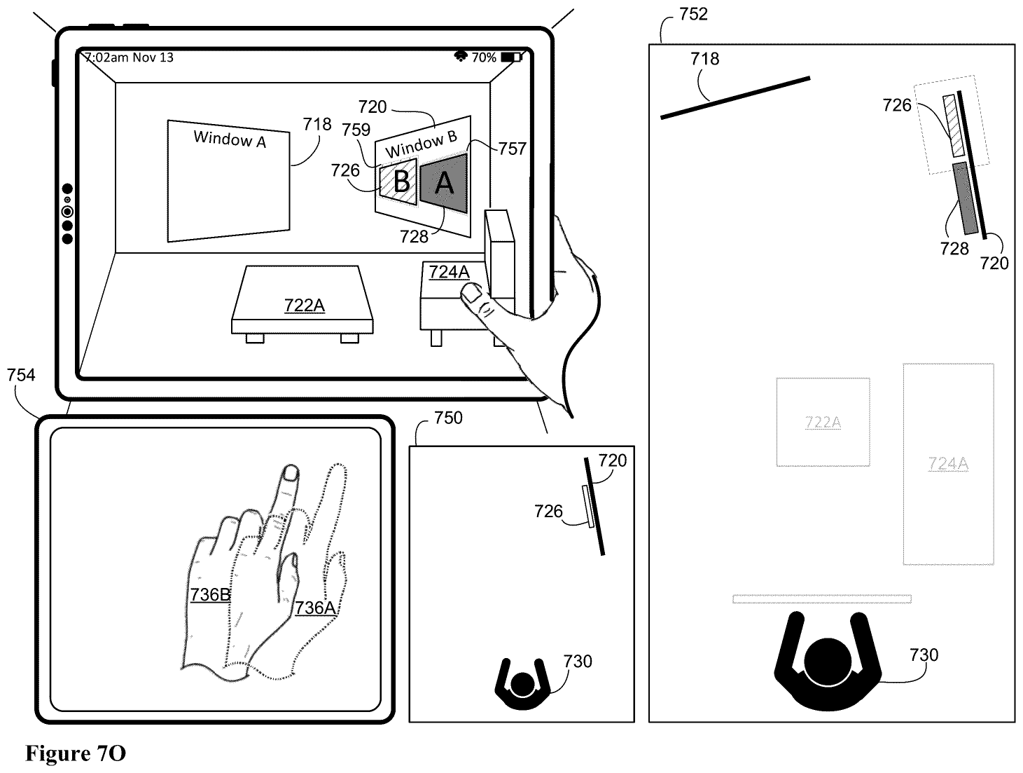

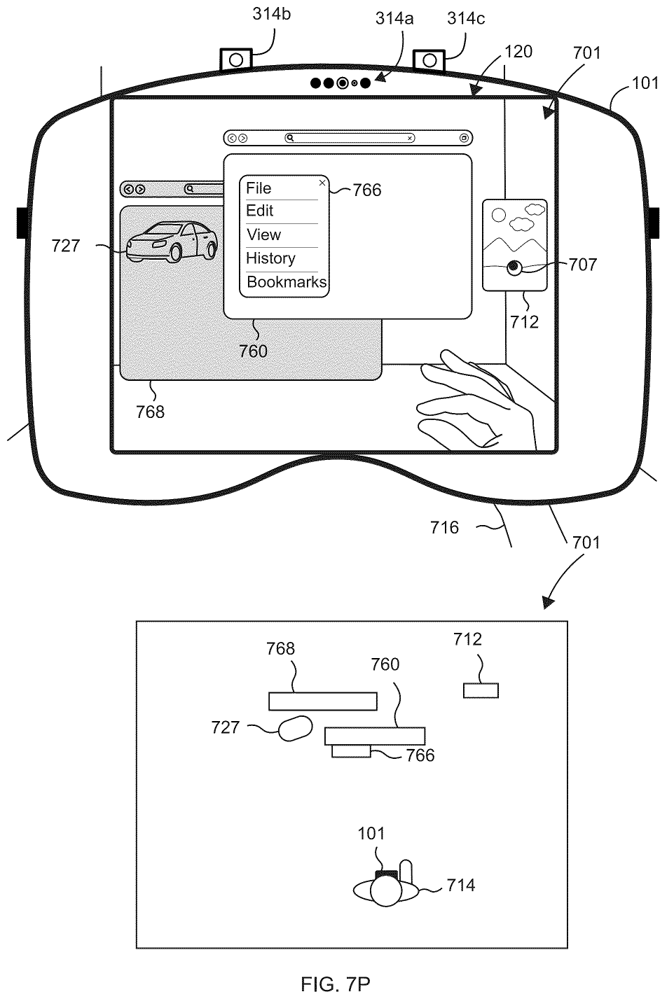

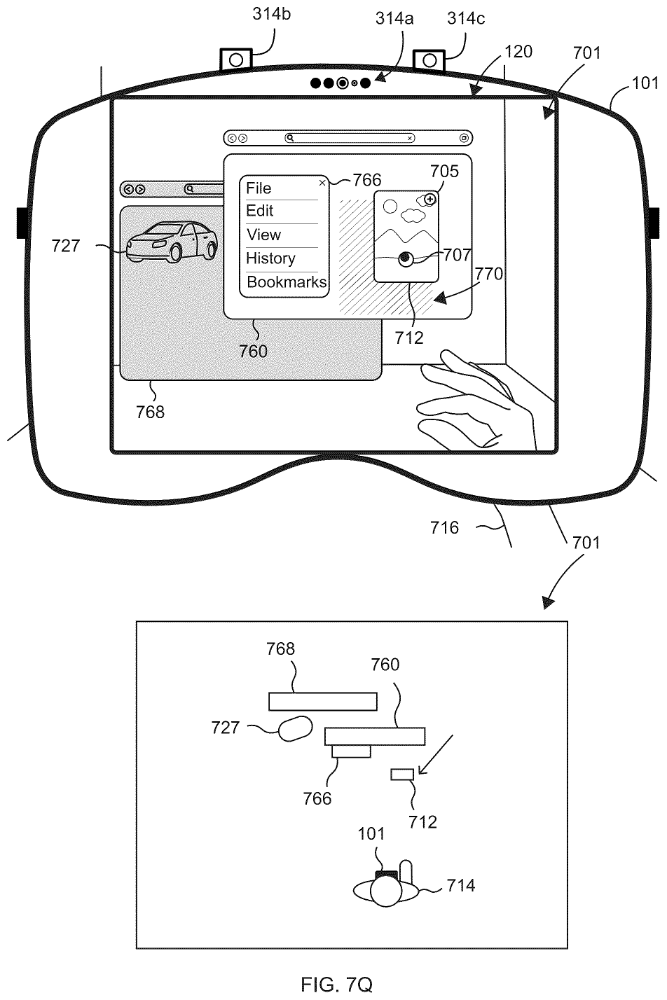

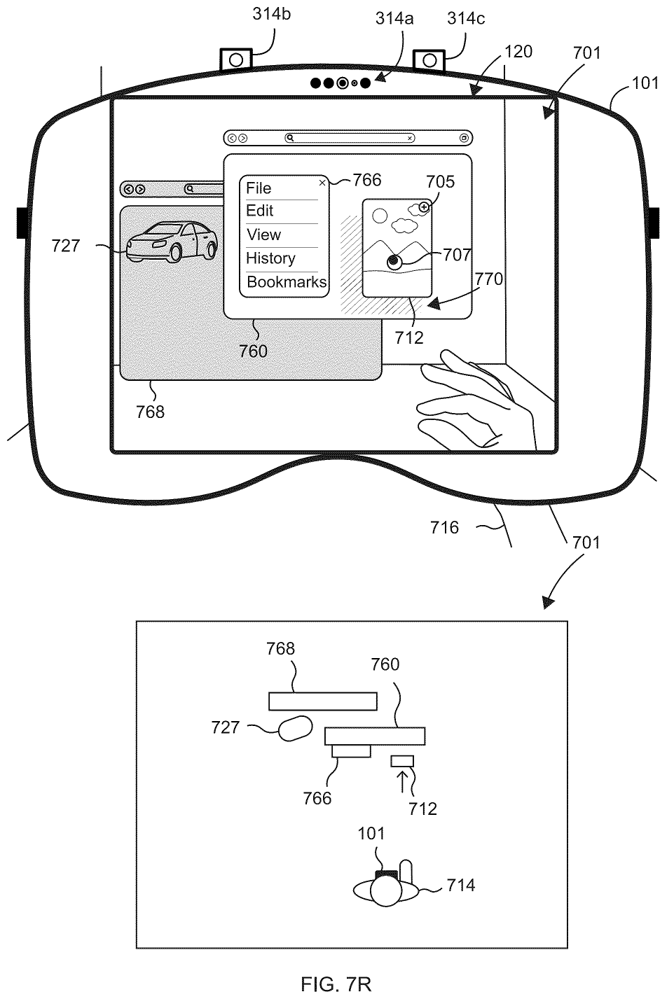

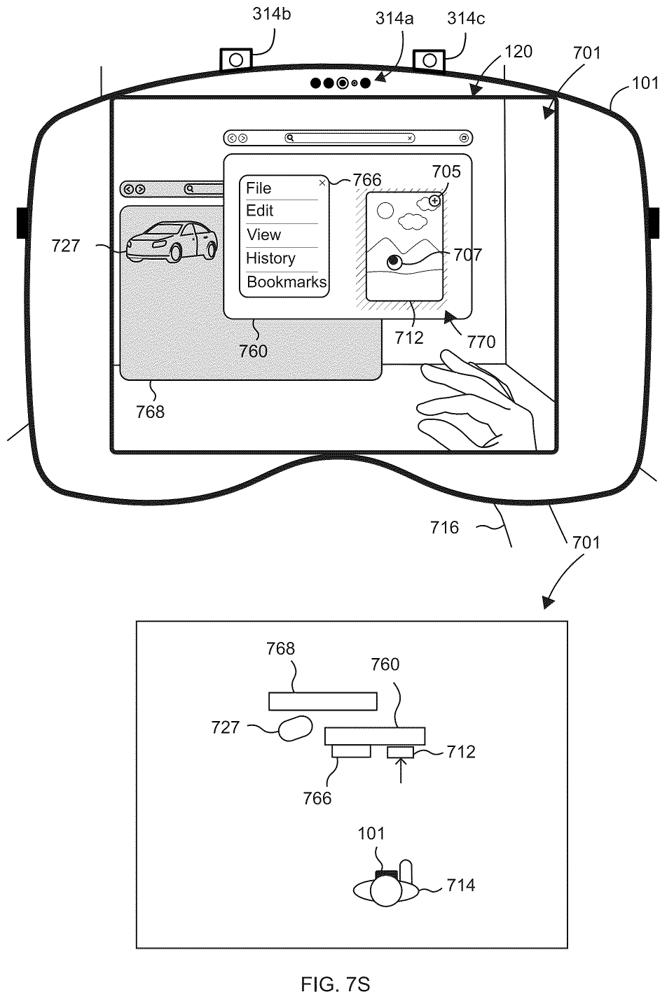

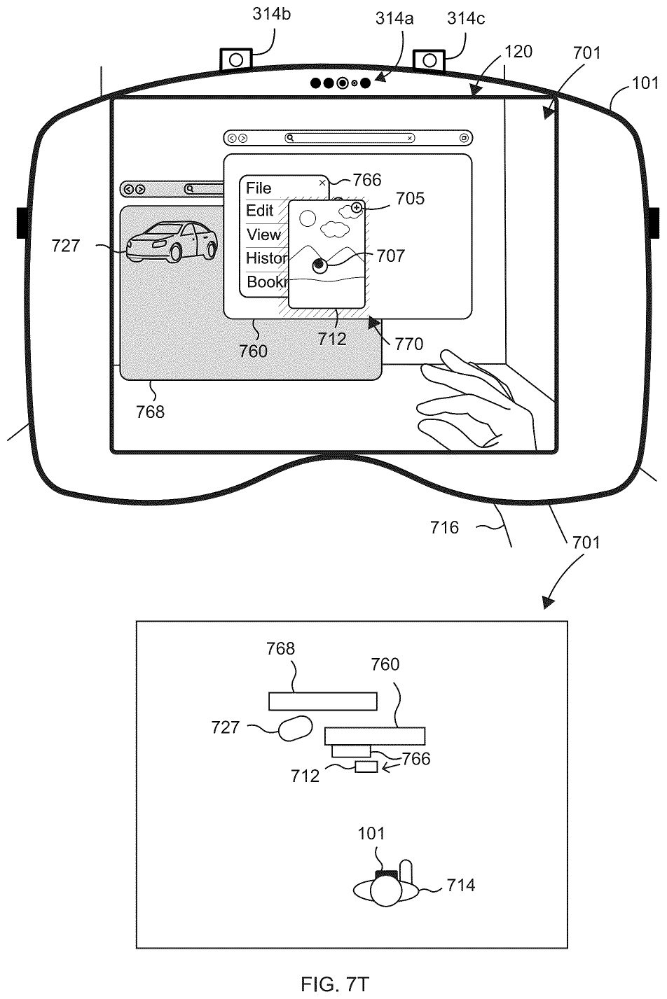

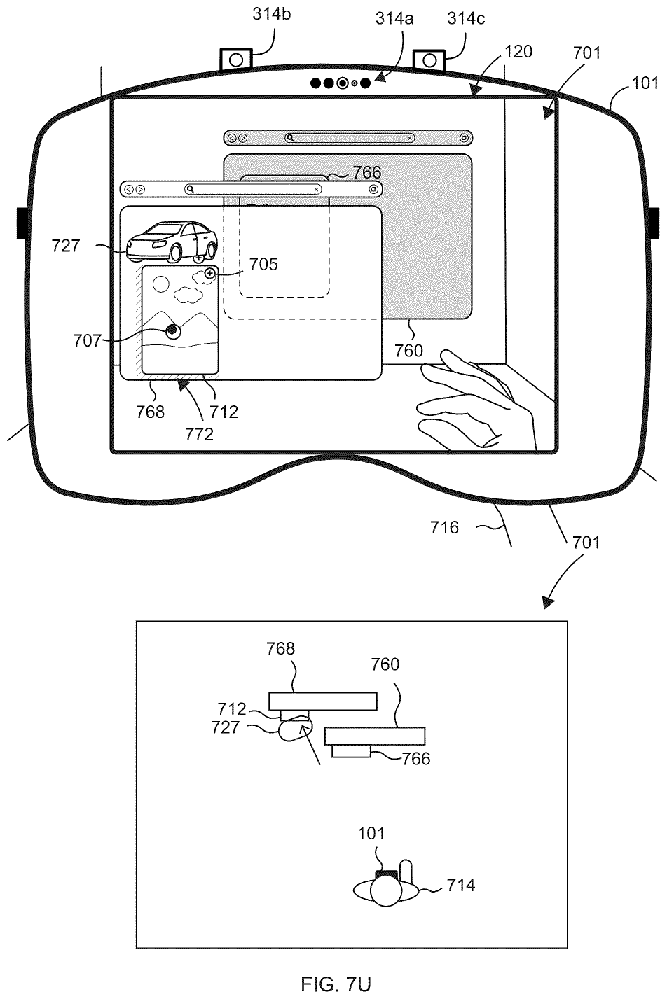

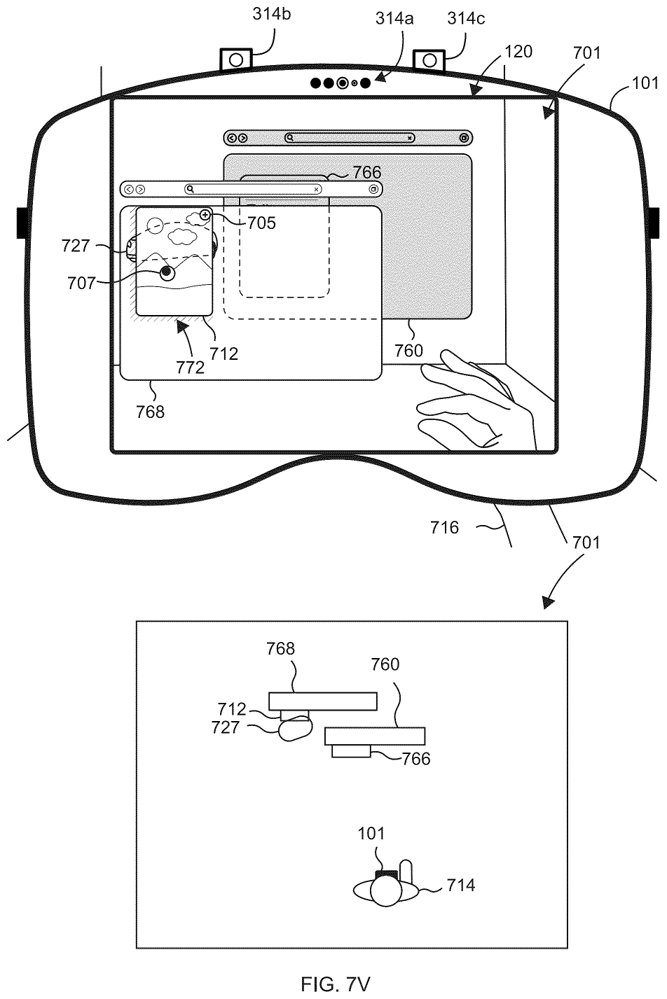

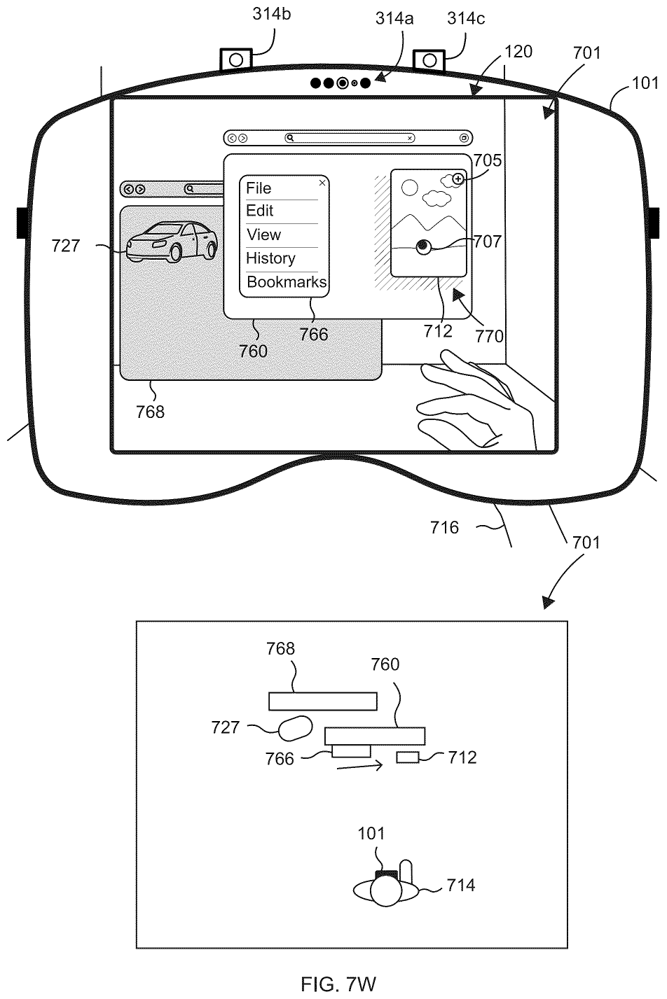

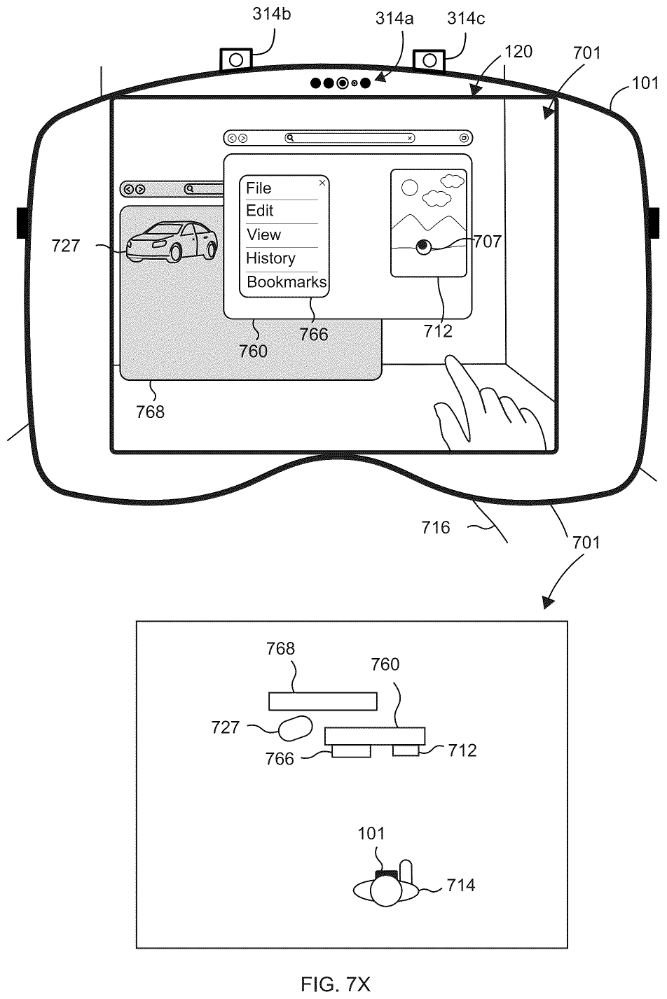

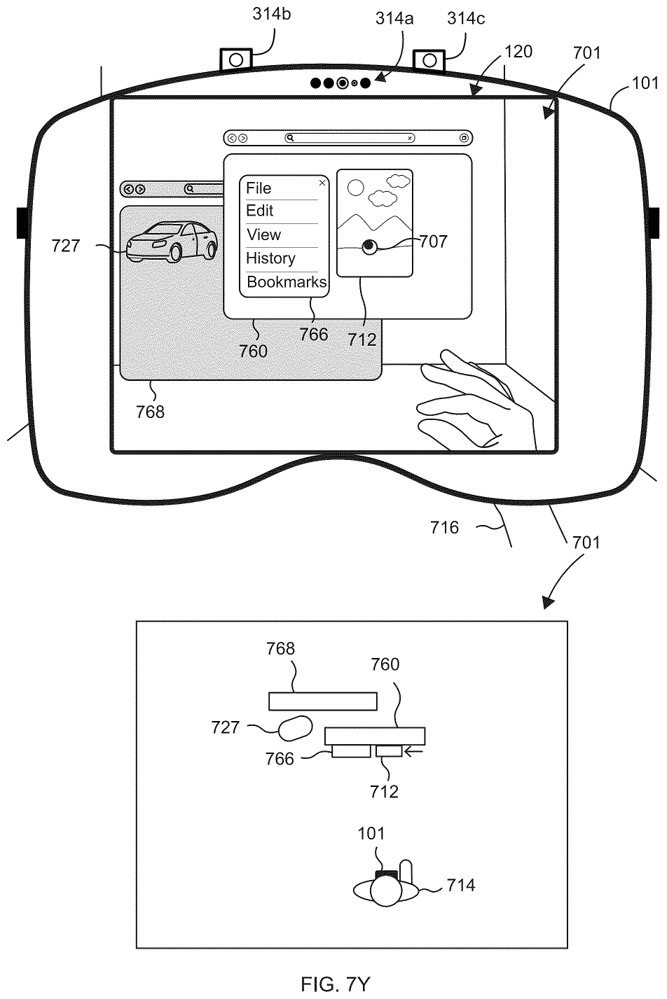

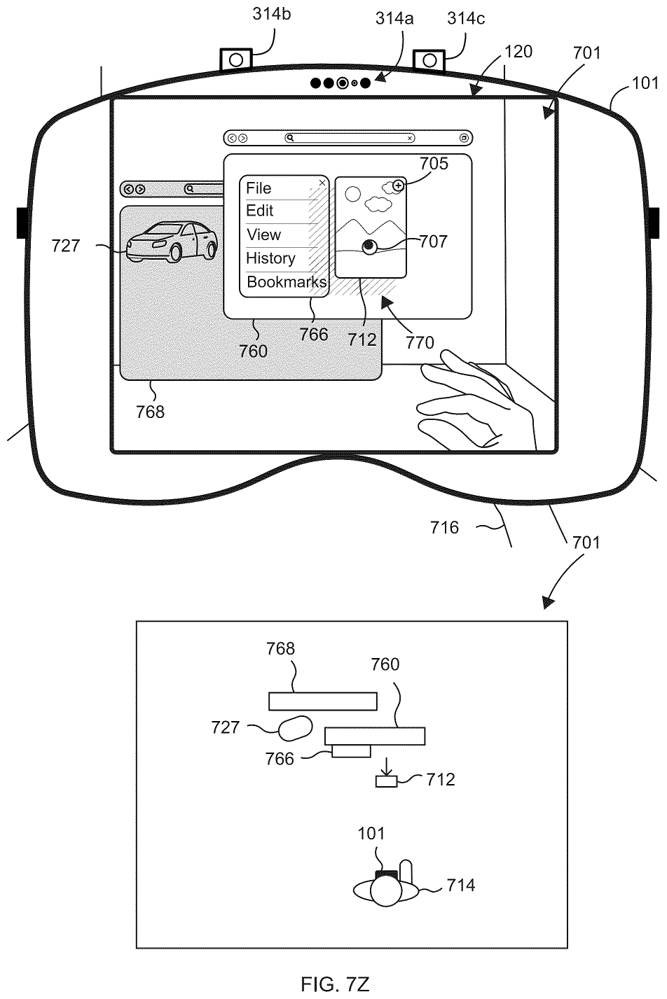

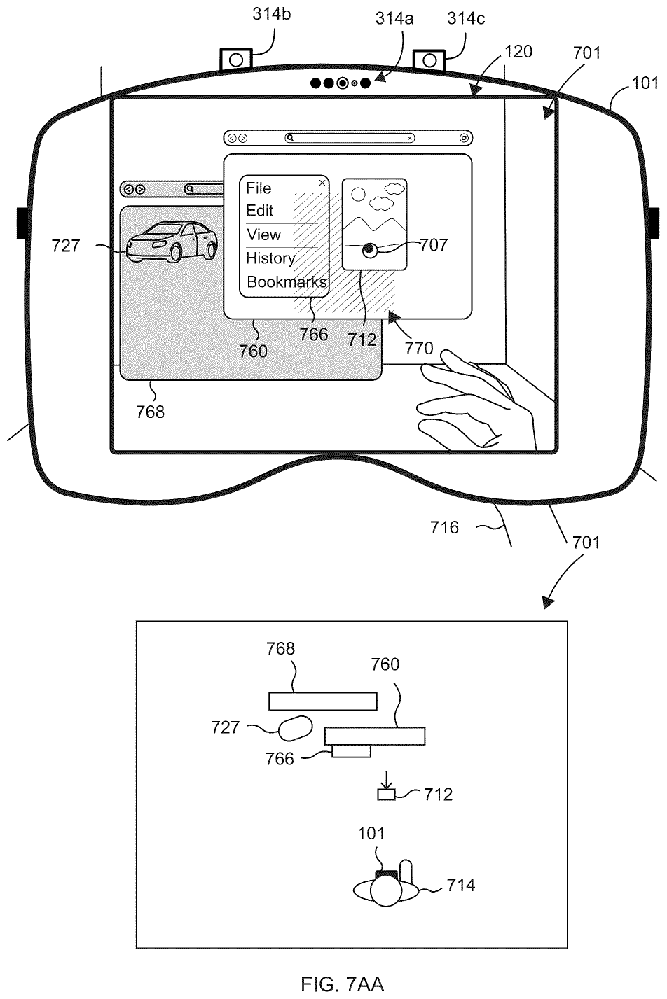

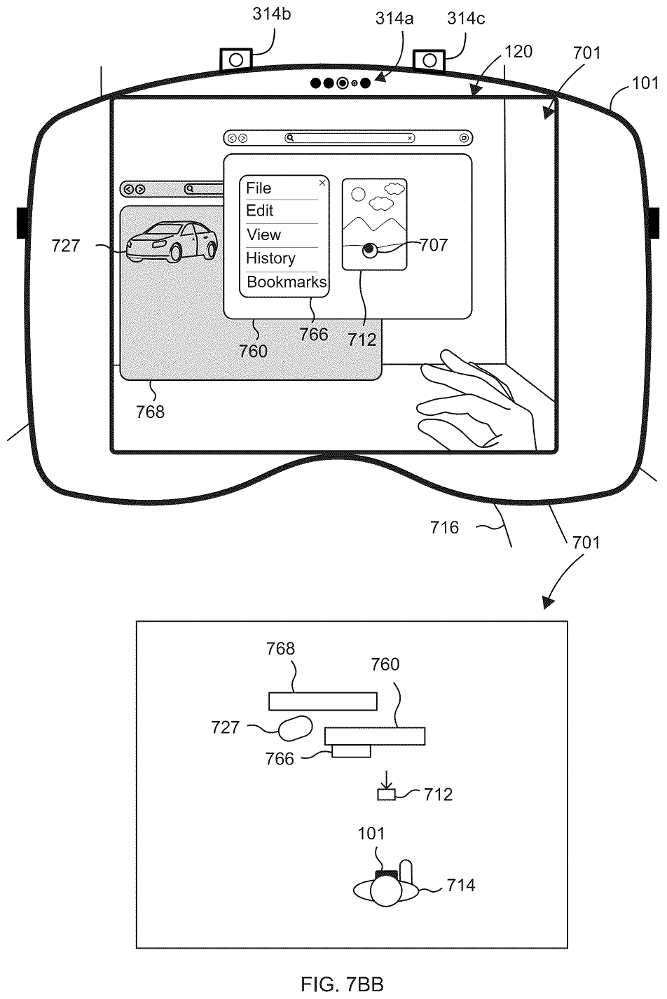

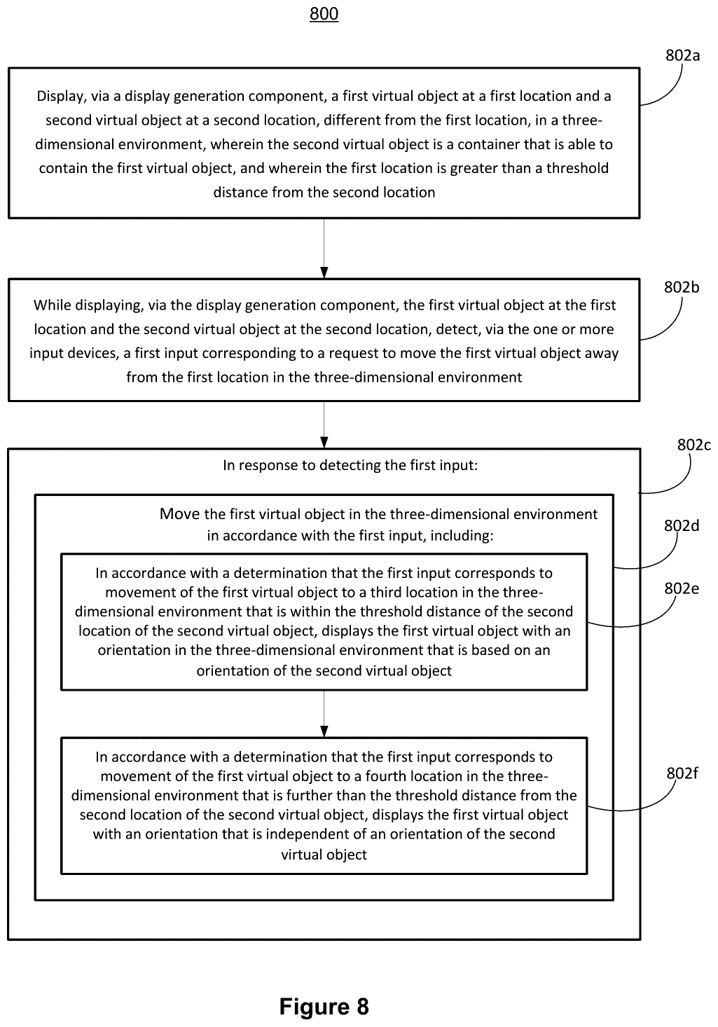

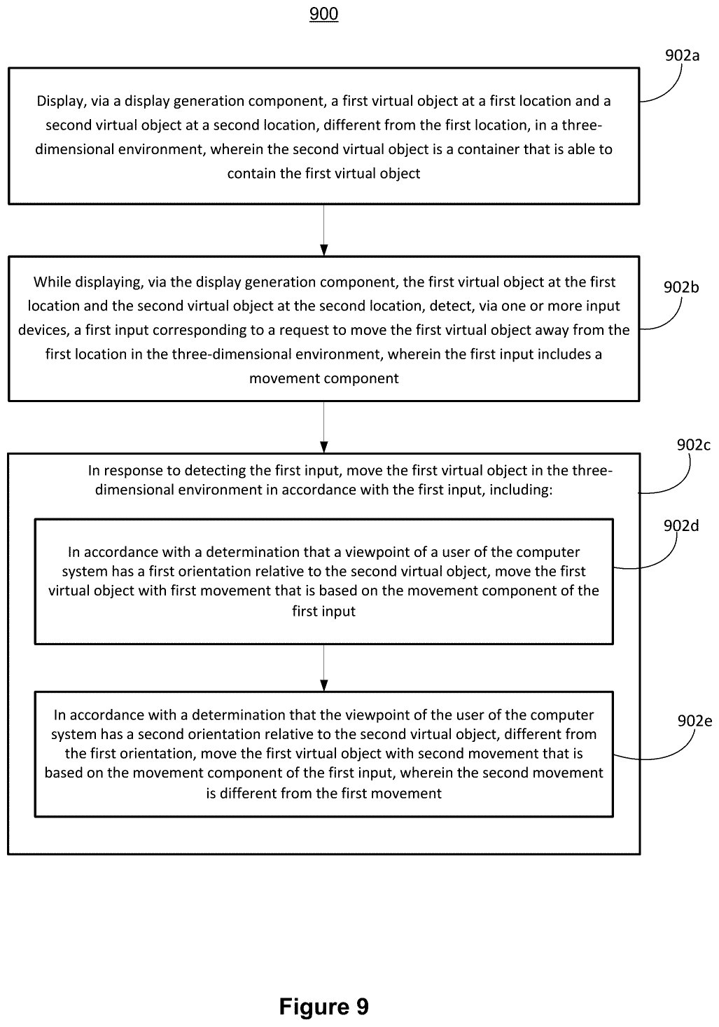

FIGS. 1A-6 provide a description of example computer systems for providing XR experiences to users (such as described below with respect to methods 800 and/or 1000). FIGS. 7A-7BB illustrate examples of a computer system facilitating movement and placement of a virtual object relative to another virtual object in a three-dimensional environment in accordance with some embodiments. FIG. 8 depicts a flow diagram of methods facilitating movement and placement of a virtual object relative to another virtual object in a three-dimensional environment in accordance with some embodiments. The user interfaces in FIGS. 7A-7BB are used to illustrate the processes in FIGS. 8 and 9. FIG. 8 depicts a flow diagram of methods for facilitating the movement and/or placement of first virtual objects with respect to second virtual objects in a three-dimensional environment in accordance with some embodiments. FIG. 9 depicts a flow diagram of methods for utilizing different movement algorithms for moving objects in a three-dimensional environment in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

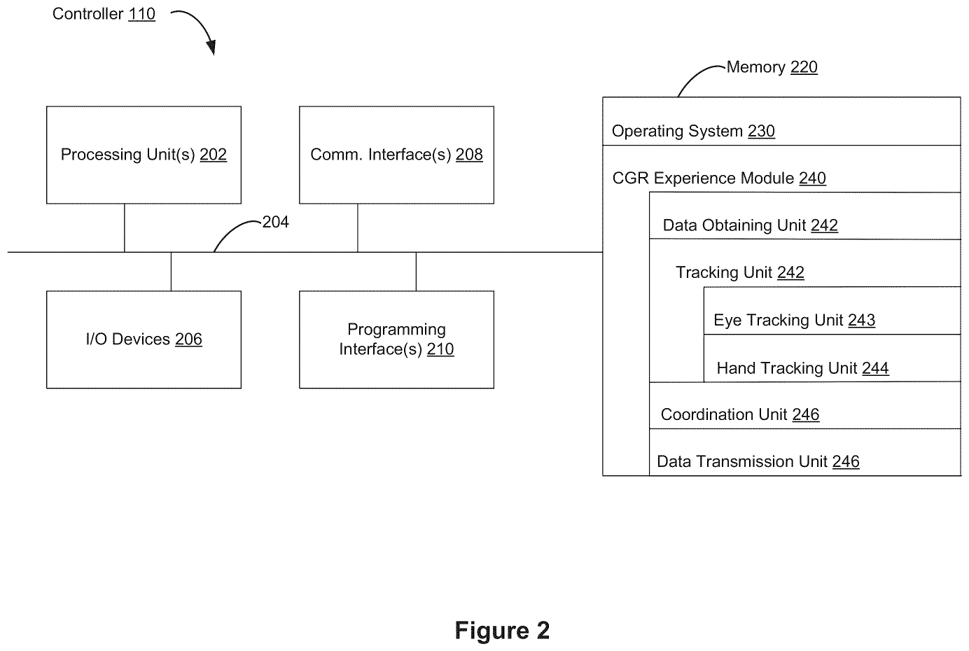

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

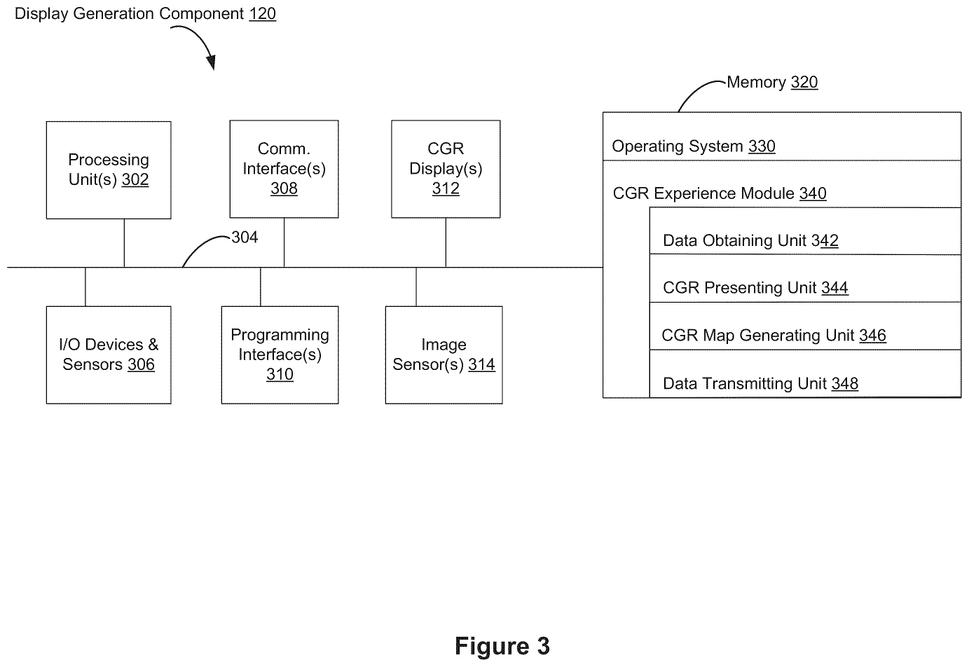

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-IF and described herein. Likewise, any of the features, components, and/or parts, including the arrangements and configurations thereof shown and described with reference to FIGS. 1B, 1C, and 1E-IF can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and IF and described herein. Likewise, any of the features, components, and/or parts, including the arrangements and configurations thereof shown and described with reference to FIGS. 1B-1D and IF can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, cither alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, cither alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

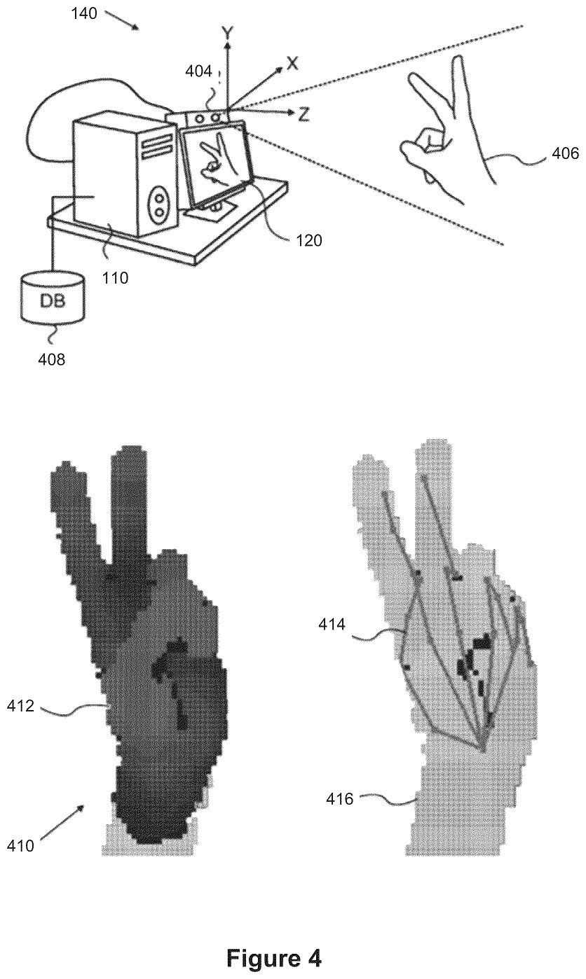

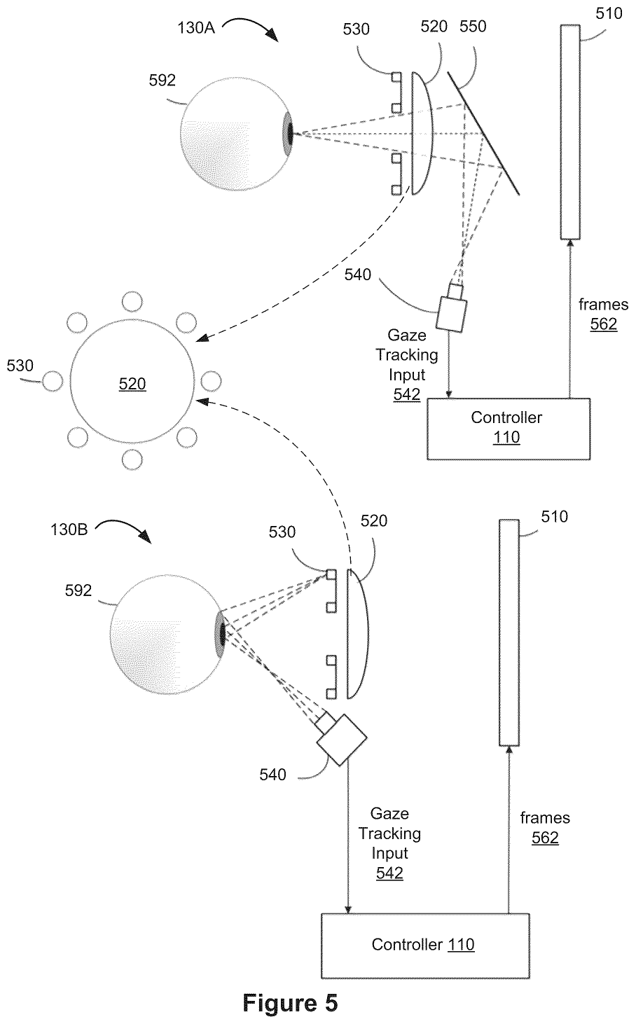

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

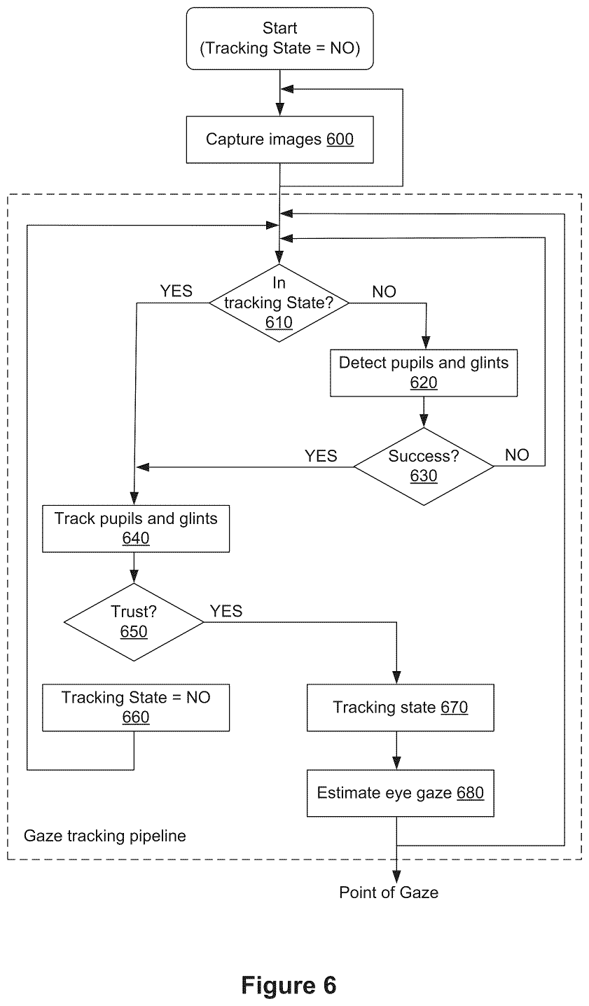

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7BB illustrate examples of a computer system facilitating the movement and/or placement of first virtual objects with respect to second virtual objects in a three-dimensional environment in accordance with some embodiments. The embodiments in these figures are used to illustrate the processes described below, including the processes described with reference to FIGS. 8 and 9.

FIG. 7A illustrates a first exemplary set of first virtual objects and respective bounding volumes presented by a computer system within a three-dimensional environment. The bounding volumes are utilized by computer system 101 as part of adding to, or removing objects from, container objects, as will be described later. For example, FIG. 7A includes three-dimensional first virtual objects 702a (e.g., spherical virtual object), 704a (e.g., cylindrical virtual object), 710a (e.g., first virtual car), 712a (e.g., cuboidal virtual object), 714a (e.g., second virtual car). and 716a (e.g., triangular virtual object). In some embodiments, and as will be described with reference to FIGS. 7B-7BB and method(s) 800 and 900, as the computer system moves the first virtual objects within the three-dimensional environment in response to user input, the computer system applies respective bounding volumes to facilitate adding and/or removing the first virtual object to second virtual objects. In some embodiments, the bounding volume is based on one or more dimensions of the respective first virtual object. In some embodiments, a size (or optionally one or more dimensions) of the bounding volume changes as will be described with reference to FIGS. 7B-7BB and method(s) 800 and 900. For example, virtual object 702a has a bounding volume 702b that is a shape similar to virtual object 702a (e.g., spherical shape). Virtual object 704a is a different shape from virtual object 702a. In some embodiments, virtual object 704a has a bounding volume 704b that is a shape similar to virtual object 704a (e.g., cylindrical shape).

In some embodiments, the computer system scales virtual objects by a same or different amounts to establish the corresponding bounding volumes for the objects. For example, the computer system optionally scales virtual object 712a by a first amount to have bounding volume 712b. The computer system optionally scales virtual object 704a by a second amount more than the first amount such that the bounding volume 704b of virtual object 704a is larger than the bounding volume 712b of virtual object 712a (optionally because virtual object 712a is smaller in height than the height of virtual object 704a). In another example, the computer system optionally scales virtual object 716a by the second amount (e.g., same amount applied to virtual object 704a) such that bounding volume 716b is similar in size to the bounding volume 704b of virtual object 704a. In some embodiments, when the virtual object is irregularly shaped such as virtual objects 710a and 714a representing cars, the computer system optionally applies and/or associates appropriately shaped bounding volumes. For example, virtual object 710a has a bounding volume that is a rectangular, cuboidal shape. In another example, virtual object 714a has a bounding volume 714b with a different shape from the bounding volume 710b of virtual object 710a. Bounding volume 714b is optionally a trapezoidal shape, that more closely aligns with the shape of the virtual object 714a than the shape of bounding volume 710b of virtual object 710a.

In some embodiments, the first virtual objects include two-dimensional objects, such as two-dimensional first objects 706a and 708a. In some embodiments, the respective bounding volumes 706b and 708b include respective depth dimensions that are independent of the respective size of two-dimensional first objects 706a and 708a. For example, in FIG. 7A, virtual object 706 has a bounding volume 706b with a first depth dimension. In some embodiments, the respective depth dimensions of bounding volume 706b and bounding volume 708b are the same as a bounding volume depth dimension associated with any one of the other virtual objects (e.g., virtual objects 702a, 704a, 710a, 712a, 714a, and/or 716a). In some embodiments, the virtual objects in FIG. 7A include one or more of the characteristics described with reference to method(s) 800 and/or 900.

FIG. 7B illustrates a computer system 101 (e.g., an electronic device) displaying, via a display generation component (e.g., display generation component 120 of FIG. 1), a three-dimensional environment 748 from a viewpoint of a user 730 (e.g., facing the back wall of the physical environment in which computer system 101 is located, as shown in overhead views 750 and 752 of the three-dimensional environment 748). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the computer system 101 is in communication with a touchpad 754 that is configured to detect touch input (e.g., via a contact provided by a finger of a hand 736A of the user). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 7B, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 748 and/or the physical environment is visible via display generation component 120. For example, three-dimensional environment 748 includes a representation 722A of a coffee table, which is optionally a representation of a physical coffee table in the physical environment, and a representation 724A of a sofa, which is optionally a representation of a physical sofa in the physical environment.

In FIG. 7B, three-dimensional environment 748 also includes a first virtual object 728 (e.g., “A” corresponding to virtual object 728 in overhead view 752), a second virtual object 718 (e.g., “Window A” corresponding to virtual object 718 in overhead view 752), a third virtual object 726 (e.g., “B” corresponding to virtual object 726 in overhead view 752 and corresponding to virtual object 726 in overhead view 750 in FIGS. 7C-7O), and a fourth virtual object 720 (e.g., “Window B” corresponding to virtual object 720 in overhead view 752 and corresponding to virtual object 720 in overhead view 750 in FIGS. 7C-7O). In some embodiments, the first virtual object 728 and the third virtual object 726 are any of the virtual objects described with reference to FIG. 7A. In some embodiments, the first virtual object 728 is a digital image, video, or media content (or a representation of a digital image, video, or media content). In some embodiments, in response to user input, as will be described later, the computer system 101 moves the first virtual object 728 to a respective location corresponding to the second virtual object 718, which is optionally a user interface container or window virtual object that is configured to accept and/or display the first virtual object 728. In some embodiments, in response to user input, as will be described later, the computer system 101 moves the first virtual object 728 to a respective location corresponding to the fourth virtual object 720, which is optionally a user interface container or window virtual object that is configured to accept and/or display the first virtual object 728. The third virtual object 726 has one or more characteristics of the first virtual object 728.

In FIG. 7B, the viewpoint of the user 730 has a first orientation relative to the second virtual object 718 (e.g., 15 degrees from perpendicular to a surface of the second virtual object 718). FIG. 7B also shows the viewpoint of the user 730 has a second orientation relative to the fourth virtual object 720 (e.g., 80 degrees from perpendicular to a surface of the fourth virtual object 720). In some embodiments, the first virtual object 728 and the third virtual object 726 are displayed in three-dimensional environment 748 with respective orientations based on the second virtual object 718 and/or the fourth virtual object 720 relative to a viewpoint of user 730 (e.g., prior to receiving input interacting with the virtual objects, which will be described later with reference to FIGS. 7C-7O). As shown in FIG. 7B, the first virtual object 728 has an orientation that is independent of the orientation of the second virtual object 718, the fourth virtual object 720, and the third virtual object 726 (e.g., the first virtual object 728 has an orientation that is based on a spatial arrangement (e.g., position and/or orientation) of the first virtual object relative to the viewpoint of the user 730 and/or optionally, a virtual object other than the second virtual object 718, the fourth virtual object 720, and the third virtual object 726). In FIG. 7B, the first virtual object 728 is in a location of the three-dimensional environment 748 that does not correspond to the second virtual object 718, the fourth virtual object 720, and the third virtual object 726. In some embodiments, because the first virtual object 728 is in a location of the three-dimensional environment 748 that does not correspond to the second virtual object 718, the fourth virtual object 720, and the third virtual object 726, the computer system displays a fifth virtual object 756 containing object 728. In some embodiments, the fifth virtual object 756 is optionally a temporary placeholder user interface container or window virtual object that is configured to temporarily accept and/or display the first virtual object 728. In some embodiments, the fifth virtual object 756 is temporary in that the computer system ceases to display the fifth virtual object 756 when the computer system detects that the location of the first virtual object is within a threshold distance (exemplary values of which are provided with reference to method(s) 800 and/or 900) of a user interface container or window virtual object, such as second virtual object 718 and fourth virtual object 720.

In FIG. 7B, the computer system 101 displays the third virtual object 726 at a location corresponding to the fourth virtual object 720 such that the third virtual object 726 is visually contained within the fourth virtual object 720. The computer system 101 also displays the third virtual object 726 with an orientation that is based on an orientation of the fourth virtual object 720 (e.g., the orientation of the third virtual object 726 is parallel to the fourth virtual object 720).

In some embodiments, the computer system 101 facilitates movement and/or placement of the first virtual object 728 and the third virtual object 726 with respect to the second virtual object 718 and the fourth virtual object 720. Particularly, in some embodiments, the computer system 101 selectively changes a path (and optionally an orientation of the first virtual object 728 and the third virtual object 726) in which the first virtual object 728 and the third virtual object 726 move (in response to user input) with respect to a threshold distance from (exemplary values of which are provided with reference to method(s) 800 and/or 900) the second virtual object 718 and the fourth virtual object 720.

FIG. 7B1 illustrates similar and/or the same concepts as those shown in FIG. 7B (with many of the same reference numbers). It is understood that unless indicated below, elements shown in FIG. 7B1 that have the same reference numbers as elements shown in FIGS. 7A-7O have one or more or all of the same characteristics. FIG. 7B1 includes computer system 101, which includes (or is the same as) display generation component 120. In some embodiments, computer system 101 and display generation component 120 have one or more of the characteristics of computer system 101 shown in FIGS. 7A-7BB and display generation component 120 shown in FIGS. 1 and 3, respectively, and in some embodiments, computer system 101 and display generation component 120 shown in FIGS. 7A-7BB have one or more of the characteristics of computer system 101 and display generation component 120 shown in FIG. 7B1.

In FIG. 7B1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7BB.

In FIG. 7B1, display generation component 120 is illustrated as displaying content that optionally corresponds to the content that is described as being displayed and/or visible via display generation component 120 with reference to FIGS. 7A-7BB. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7B1.

Display generation component 120 has a field of view (e.g., a field of view captured by external image sensors 314b and 314c and/or visible to the user via display generation component 120) that corresponds to the content shown in FIG. 7B1. Because display generation component 120 is optionally a head-mounted device, the field of view of display generation component 120 is optionally the same as or similar to the field of view of the user.

In FIG. 7B1, the user is depicted as performing an air pinch gesture (e.g., with hand 736A and/or hand 736B while attention of the user is directed to objects 728 and 726, as indicated by gaze points 798a and 798b) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7BB. Further, it is understood that inputs such as air pinch or other air gestures that are directed to the three-dimensional environment in FIGS. 7A-7BB are optionally analogously detected while attention of the user is directed to the targets of such inputs (e.g., analogous to as described with reference to gaze points 798a and 798b in FIG. 7B1).

In some embodiments, computer system 101 responds to user inputs as described with reference to FIGS. 7A-7BB.

In the example of FIG. 7B1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7BB and/or described with reference to the corresponding method(s) are optionally implemented on computer system 101 and display generation unit 120 in a manner similar or analogous to that shown in FIG. 7B1.

For example, from FIG. 7B to FIG. 7C, the computer system 101 detects an input provided by hand 736A corresponding to a request to move the first virtual object 728 within the three-dimensional environment 748. For example, as shown in FIG. 7C, the computer system 101 detects hand 736A provide an air gesture, such as an air pinch and drag gesture in which an index finger and thumb of the hand of the user come together to make contact, while a gaze of the user 730 is directed to the first virtual object 728, followed by movement of the hand 736A forward (e.g., away from a body of the user 730) while maintaining the pinch hand shape. In some embodiments, the movement of the first virtual object 728 corresponds to movement of the first virtual object 728 away from the viewpoint of the user 730 in the three-dimensional environment 748 to a first location as shown in FIG. 7C. In some embodiments, the location of the first virtual object 728 in FIG. 7C as shown in the overhead view 752 is further than the threshold distance (exemplary values of which are provided with reference to method(s) 800 and/or 900) from the second virtual object 718 and the fourth virtual object 720 such that the first virtual object 728 is contained within the fifth virtual object 756. The computer system 101 also displays the first virtual object 728 with an orientation that is based on the viewpoint of the user 730 (e.g., oriented towards the viewpoint of user 730). In some embodiments, as described further with reference to FIGS. 7O-7BB, the computer system 101 displays a virtual shadow 753 visually indicating that virtual object 726 is able to be snapped to virtual object 720. In FIG. 7C, the virtual shadow 753 is displayed with one or more visual properties, including a scale relative to virtual object 720, an opacity, a blurring effect, and/or a brightness. In some embodiments, a position of one or more simulated light sources casting light toward virtual objects determines visual properties, including a size, scale, opacity, and/or brightness of the virtual shadow. For example, in FIG. 7C, the simulated light source causing the visual appearance of virtual shadow 753 is relatively close to a normal extending from a surface of the virtual object 720. In FIG. 7C, the virtual shadow is displayed at a first, relatively modest size and well-aligned with a projection of virtual object 726 onto the surface of virtual object 720 in accordance with the simulated light source.

In another example, from FIG. 7B to FIG. 7C, the computer system 101 detects an input provided by hand 736B corresponding to a request to move the third virtual object 726 away from the fourth virtual object 720. For example, as shown in FIG. 7C, the computer system 101 detects hand 736B provide an air gesture, such as an air pinch and drag gesture in which an index finger and thumb of the hand of the user come together to make contact, while a gaze of the user 730 is directed to the third virtual object 726, followed by movement of the hand 736B backwards (e.g., towards the body of the user 730) while maintaining the pinch hand shape. In some embodiments, the movement of the third virtual object 726 corresponds to movement of the third virtual object 726 away from the fourth virtual object 720 to a first location as shown in FIG. 7C. In some embodiments, the first location of the third virtual object 726 in FIG. 7C as shown in the overhead view 752 is within the threshold distance (exemplary values of which are provided with reference to method(s) 800 and/or 900) of the fourth virtual object 720. In some embodiments, and as shown in FIG. 7C, the third virtual object 726 is associated a first bounding volume (shown in the overhead view 752 as the dashed line box) that intersects with the fourth virtual object 720. Accordingly, the computer system 101 moves the third virtual object along a path (e.g., corresponding to path 742) perpendicular from the surface of the fourth virtual object 720 as shown in the overhead view 750 in accordance with the input.

From FIG. 7C to FIG. 7D, the computer system 101 detects further movement from the input provided by hand 736A corresponding to a request to move the first virtual object 728 away from the viewpoint of the user 730 in the three-dimensional environment 748. In response to the detecting the input provided by hand 736A, the computer system moves the first virtual object to a second location closer to a location of the second virtual object 718 as shown in FIG. 7D than the first location of the first virtual object 728 in FIG. 7C. In some embodiments, the location of the first virtual object 728 in FIG. 7D is not within the threshold distance (exemplary values of which are provided with reference to method(s) 800 and/or 900) of the second virtual object 718. FIG. 7D also displays a first bounding volume associated with the first virtual object 728 with a size based on one or more dimensions of the first virtual object 728, as described previously. Because the bounding volume of object 728 does not intersect with object 718 in FIG. 7D, object 728 is further than the above-mentioned threshold distance from object 718, and continues to be displayed with an orientation based on the viewpoint of user 730 (e.g., oriented towards the viewpoint of user 730).

Turning to the third virtual object 726, from FIG. 7C to FIG. 7D, the computer system 101 detects further movement from the input provided by hand 736B corresponding to a request to move the third virtual object 726 away from the fourth virtual object 720. In response, the computer system moves the third virtual object to a second location as shown in the overhead view 752. Because the second location of the third virtual object 726 is still within the threshold distance (exemplary values of which are provided with reference to method(s) 800 and/or 900) of the fourth virtual object 720 (e.g., the first bounding volume of the third virtual object 726 intersects with the fourth virtual object 720), the computer system 101 displays the third virtual object with an orientation based on the orientation of the fourth virtual object 720 as shown in FIG. 7D and in the overhead view 750. As depicted in the overhead view 750, the computer system 101 moves the third virtual object along a path (e.g., corresponding to path 742) perpendicular to the surface of the fourth virtual object 720. However, the orientation of object 726, as it moves further from object 720, starts to be based less on the orientation of object 720, and more on the viewpoint of user 730 (e.g., object 726 begins to tilt towards being oriented towards the viewpoint of user 730). In FIG. 7D, the virtual shadow 753 is displayed with one or more visual properties, including a scale relative to virtual object 720, an opacity, a blurring effect, a brightness, and/or a position that changes relative to as shown in FIG. 7C. For example, the simulated light source casting virtual shadow 753 is modified to be further away and further off-angle from the surface of virtual object 720, causing a further offset (e.g., exacerbating alignment like a drop shadow effect) in FIG. 7D. As a result, the virtual shadow 753 is displayed further offset in FIG. 7D from the dimensions of virtual shadow 726, and/or with a different level of brightness than in FIG. 7C. Additionally or alternatively, the virtual shadow in 726 is relatively more diffuse in FIG. 7D as compared to FIG. 7C, to emulate the simulated light source moving further away in a depth direction from virtual object 720.

In some embodiments, and as shown from FIG. 7D to FIG. 7E, the computer system 101 selectively changes a path in which the first virtual object 728 and the third virtual object 726 move (in response to user input) with respect to the second virtual object 718 and the fourth virtual object 720, respectively. For example, in FIG. 7E, the computer system detects movement from the input provided by hand 736A corresponding to a request to move the first virtual object 728 to a third location. In response to the detecting the input provided by hand 736A, the computer system moves the first virtual object 728 to a third location that is not yet within a threshold distance (exemplary values of which are provided with reference to method(s) 800 and/or 900) of the second virtual object 718. In some embodiments, and as depicted in the overhead view 752, the computer system 101 begins moving the third virtual object 726 based on a continued projection, to the second virtual object 718, of a line 744 from a viewpoint of the user 730 through a control location 740 that moves in accordance with the input provided by hand 736A. The control location 740 is optionally located at a center of object 728. For example, the computer system 101 detects movement of the input provided by hand 736A as shown in FIG. 7E to FIG. 7H corresponding to a request to move the first virtual object 728 to the second virtual object 718. Accordingly, the control location 740 moves in a direction and/or with magnitude corresponding to a direction and/or magnitude of the movement of the input provided by hand 736A as shown in FIG. 7E to FIG. 7I. FIG. 7E to FIG. 7I also illustrate that, as the computer system 101 moves object 728 along the above-described projection of line 744 towards a location on the surface of object 718, the computer system 101 changes the orientation of the first virtual object 728 from an orientation based on the viewpoint of the user 730 (e.g., being oriented towards the viewpoint of user 730) towards an orientation that is based on the orientation of the second virtual object 718 (e.g., being oriented parallel to object 718). As object 728 gets closer to object 718, computer system 101 optionally orients object 728 more and more based on the orientation of object 718, and less and less based on the viewpoint of user 730.

Turning back to FIG. 7E, the computer system 101 initiates display of the virtual shadow 755 and changes the virtual shadow 753 in accordance with the movement of virtual object 728 and virtual object 726, respectively. For example, similar to the scenario described previously, as virtual object 726 in FIG. 7E moves away from the virtual object 720, the position and/or angle of the simulated light source casting light and causing display of virtual shadow 753 becomes larger and further off-angle relative to a projection of virtual object 726 onto virtual object 720. In FIG. 7E, computer system 101 detects input moving virtual object 728 within the threshold distance of the virtual object 718, and accordingly initiates display of virtual object 755. Similar to as described with reference to virtual object 726, virtual shadow 728 in FIG. 7E is displayed at a relatively large size, relatively offset from a projection of virtual object 728 onto the surface of virtual object 718, and relatively diffuse, as compared to when the virtual object 728 is moved closer to virtual object 718.

In FIG. 7I, and as shown in the overhead view 752, the computer system 101 moves the first virtual object 728 to a location corresponding to a respective location of the second virtual object 718 such that the bounding volume of the first virtual object 728 intersects with the second virtual object 718. In response, and without further input from the user, the computer system 101 adds (e.g., snaps) the first virtual object 728 to the second virtual object 718 as shown in FIG. 7I. In some embodiments, the computer system associates a second bounding volume to the first virtual object 728 different from the first bounding volume of the first virtual object 728 shown in FIGS. 7D to 7H once the computer system 101 adds the first virtual object 728 to the second virtual object 718, as shown in FIG. 7I. In some embodiments, and as shown in FIG. 7I, the second bounding volume applied to the first virtual object 728 is larger in one or more dimensions than the first bounding volume such that very small hand movement (e.g., hand jitter) does not cause the computer system to unsnap the first virtual object 728 from the second virtual object 718.

Turning to the third virtual object 726, from FIG. 7D to FIG. 7E, the computer system 101 detects further movement from the input provided by hand 736B corresponding to a request to move the third virtual object 726 away from the fourth virtual object 720. In response, the computer system 101 optionally moves the third virtual object 726 away from the fourth virtual object 720 by a greater distance than the distance the third virtual object 726 was moved perpendicularly as shown in FIG. 7C to FIG. 7D. Accordingly, the third virtual object 726 at the third location in FIG. 7E is further than the threshold distance from the fourth virtual object 720 (e.g., the bounding volume of object 726 no longer intersects with object 720). In FIG. 7E, the computer system 101 also displays the third virtual object 726 with an orientation moving more towards an orientation based on the viewpoint of the user 730 as shown in the overhead view 750 (e.g., being oriented towards the viewpoint of user 730). In some embodiments, once object 726 is further than the threshold distance from object 720, object 726 is fully oriented based on the viewpoint of user 730, and is no longer oriented based on the orientation of object 720.

From FIG. 7E to FIG. 7F, the computer system 101 moves the simulated light sources causing display of the virtual shadow 755 and virtual shadow 753 in accordance with the movement of virtual object 728 and virtual object 726, respectively. For example, as virtual object 728 moves closer to virtual object 718, the virtual shadow 755 is displayed with a smaller scale, better-aligned with the projection of virtual object 728 onto virtual object 718, and relatively less diffuse in FIG. 7F compared to in FIG. 7E. Further, virtual shadow 753 is displayed with a larger scale, less aligned with the projection of virtual object 726, and more diffuse in FIG. 7F as compared to in FIG. 7E.

From FIG. 7F to FIG. 7G, because the computer system 101 detects that the third virtual object is at a location that is further than the threshold distance from the fourth virtual object 720, the computer system 101 changes the bounding volume of the third virtual object 726 from the first bounding volume (e.g., a larger bounding volume) to a second bounding volume (e.g., a smaller bounding volume) as shown in FIG. 7G that is based on the one or more dimensions of the third virtual object 726. Additionally, computer system 101 ceases display of a virtual shadow corresponding to virtual object 726 in FIG. 7G to indicate that the virtual object 726 is beyond the threshold distance from the fourth virtual object 720. In FIG. 7G, computer system 101 moves the virtual object 728 closer to virtual object 718 than in FIG. 7F, and accordingly changes a position of the simulated light source casting virtual shadow 755. As described previously, virtual shadow 755 is moved, scaled, and/or made less diffuse to indicate a progressively closer relationship between virtual object 728 and virtual object 718 in FIG. 7G. In FIG. 7G, the computer system 101 selectively changes the path in which the third virtual object 726 moves. For example, and as depicted in the overhead view 750, the computer system 101 moves the third virtual object 726 towards the viewpoint of the user in a curved path through control location 740 that moves in accordance with the input provided by hand 736B. For example, the computer system 101 detects movement of the input provided by hand 736B as shown in FIG. 7G to FIG. 7I corresponding to a request to move the third virtual object 726 towards the user 730. Accordingly, the control location 740 moves in a direction and/or with magnitude corresponding to a direction and/or magnitude of the movement of the input provided by hand 736B as shown in FIG. 7G to FIG. 7I. FIG. 7G to FIG. 7I also illustrate that the computer system 101 changes the orientation of the third virtual object 726 from an orientation based on the orientation of the fourth virtual object 720 towards an orientation that is independent of the orientation of the fourth virtual object 720.

From FIG. 7G to FIG. 7H, computer system 101 moves the virtual object 728 toward virtual object 718, and accordingly changes the position of the simulated source casting virtual shadow 755 onto virtual object 718. In FIG. 7H, the virtual shadow 755 is moved and/or scaled to appear spatially tighter relative to the border of virtual object 728, and optionally is brighter and/or less diffuse than in FIG. 7G.

In FIG. 7I, and with respect to first virtual object 728, the computer system 101 detects an input provided by hand 736A corresponding to a request to move the first virtual object 728 in a lateral direction away from the respective location corresponding the second virtual object 718 towards the fourth virtual object 720. In response, the computer system moves the first virtual object 728 by a greater distance than the distance the third virtual object 726 was moved perpendicularly as shown in FIG. 7C to FIG. 7D. In FIG. 7I, computer system 101 further darkens, tightens a spatial profile of, and/or moves the virtual shadow 755 relative to in FIG. 7H to convey the corresponding moving of virtual object 728 toward virtual object 718. From FIG. 7I to FIG. 7J, computer system 101 moves the virtual shadow 755 in accordance with the movement of virtual object 728 relative to virtual object 718. For example, virtual shadow 755 is progressively darker, tighter in spatial profile, and/or moved in accordance with the movement of virtual object 728. In some embodiments, computer system 101 provides less resistance to movement of objects laterally away from container objects than to movement of objects perpendicularly away from container objects. Accordingly, the first virtual object 728 at the location in FIG. 7K is further than the threshold distance from the second virtual object 718 (e.g., the bounding volume of object 728 is no longer intersecting object 718). In FIG. 7K, the computer system displays the first virtual object 728 with an orientation independent of the second virtual object 718. Additionally, in FIG. 7K, computer system 101 ceases display of a virtual shadow corresponding to virtual object 728 due to the movement of virtual object 728 beyond the threshold distance from the second virtual object 718.

From FIG. 7K to FIG. 7L, the computer system 101 detects further movement of the input provided by hand 736A corresponding to a request to move the first virtual object 728 towards the fourth virtual object 720. In response, the computer system 101 moves the first virtual object 728 to a location shown in FIG. 7L. At the location shown in FIG. 7L, the bounding volume of the first virtual object 728 intersects the fourth virtual object 720 (e.g., the first virtual object 728 is within the threshold distance from the fourth virtual object 720). Computer system 101 in FIG. 7L initiates display of the virtual shadow 757, corresponding to a shadow cast by a simulated light source. The virtual shadow 757 is displayed at a portion of virtual object 720 corresponding to the relative position of virtual object 728 relative to virtual object 720, such as along the left edge of virtual object 720. Accordingly, the computer system 101 snaps the first virtual object 728 to the respective location corresponding to the fourth virtual object 720 as shown in FIG. 7M. The computer system 101 also changes the bounding volume of the first virtual object 728 to a bounding volume that is larger than it was when object 728 was not snapped to object 720. In FIG. 7N, computer system 101 moves the virtual shadow 757 to overlay portions of virtual object 720 corresponding to the updated position of virtual object 728 relative to virtual object 720. In FIG. 7O, computer system 101 moves the virtual shadow 757 to reflect the updated position of virtual object 728 relative to virtual object 720.

Turning to the third virtual object 726, from FIG. 7I to FIG. 7K, the computer system 101 detects further movement from the input provided by hand 736B corresponding to a request to move the third virtual object 726 within the three-dimensional environment 748. In response, the computer system 101 determines that the movement is further than the threshold distance from the second virtual object 718 and the fourth virtual object 720, and in response to the determination that the movement is further than the threshold distance from the second virtual object 718 and the fourth virtual object 720 (or optionally, in response to determining that the movement is further than the threshold distance from the second virtual object 718 and the fourth virtual object 720), the computer system moves the third virtual object 726 along a curved path around the user 730 as shown in FIGS. 7I to 7K and the corresponding overhead views 750, and orients object 726 based on the viewpoint of user 730 (e.g., oriented towards the viewpoint of user 730) and not based on the orientations of objects 718 or 720.

In FIGS. 7L to 7N, the computer system 101 detects further movement of the input provided by hand 736B corresponding to a request to move the third virtual object 726 towards the fourth virtual object 720. In response, the computer system 101 moves the third virtual object 726 to a location shown in FIG. 7N. At the location shown in FIG. 7N, the bounding volume of the third virtual object 726 intersects the fourth virtual object 720 (e.g., the third virtual object 726 is within the threshold distance from the fourth virtual object 720). Accordingly, the computer system 101 snaps the third virtual object 726 to the respective location corresponding to the fourth virtual object 720 as shown in FIG. 7O. In some embodiments, the computer system repositions the first virtual object 728 such that the third virtual object 726 and the first virtual object 728 are spaced apart within the fourth virtual object 720. In some embodiments, the computer system 101 stacks the third virtual object 726 and the first virtual object 728 on top of each other within the fourth virtual object 720 (e.g., without repositioning the first virtual object 728). In FIG. 7O, the computer system 101 also changes the bounding volume of the third virtual object 726 to a larger bounding volume that is larger than it was when object 726 was not snapped to object 720. In FIG. 7O, computer system 101 initiates display of the virtual shadow 759 to reflect the proximity between virtual object 726 relative to virtual object 720. Virtual shadow 759 has characteristics similar to or the same as the additional virtual shadows described herein.

FIGS. 7P-7BB illustrate a computer system presenting visual feedback while a first virtual object moves relative to other virtual objects.

In FIG. 7P, three-dimensional environment 701 has one or more characteristics of three-dimensional environment 748 discussed above. In some embodiments, virtual object 768 and virtual object 760 have one or more characteristics of the virtual objects described with reference to FIG. 7A-7O, such as virtual object 718 and/or virtual object 720. In FIG. 7P, virtual object 768 and virtual object 760 are optionally two-dimensional virtual objects. Virtual object 768 and 760 optionally include respective user interfaces, such as user interfaces of a web browsing application. In FIG. 7P, virtual object 760 is displayed having an “active” focus state including a first level of visual prominence relative to three-dimensional environment 701, indicated by the white fill of virtual object 760. In FIG. 7P, virtual object 760 is displayed opaque, fully visible, and with a first level of brightness. Also, in FIG. 7P, virtual object 768 is displayed with an “inactive” focus state including a second level of visual prominence, different from the first level of visual prominence, relative to three-dimensional environment 701, indicated by the gray fill overlaying virtual object 768. For example, the virtual object 768 is displayed with more translucency and/or not displayed (e.g., as indicated by the portion of 768 that is obscured by the virtual object 760), with a decreased level of saturation, and/or with a lower level of brightness relative to the active state.

In FIG. 7P, menu 766 is a virtual object that is associated with virtual object 760. Menu 766 is displayed concurrently with and/or overlaying virtual object 760 in FIG. 7P. It is understood that menu 766 is thus included in and/or associated with virtual object 760. Virtual object 712 in FIG. 7P is a two-dimensional object including an image (e.g., a photo, a thumbnail, or media including video). In FIG. 7P, virtual object 727 is a three-dimensional virtual object corresponding to a model of a car, having a spatial profile that is similar to the contours and/or dimensions of a physical car. Virtual object 727 is associated with virtual object 768, similar to the association between menu 766 and virtual object 760.

In FIG. 7P, computer system 101 detects user input provided by hand 716. In some embodiments, the user input provided by hand 716 has one or more characteristics of the user input described with reference to FIGS. 7A-7O, such as provided by hand 736A and/or hand 736B. For example, hand 716 in FIG. 7P performs an air pinch gesture, including a request to initiate movement of virtual object 712, such as an air drag gesture, while attention 707 is directed to virtual object 712. It is understood that in FIGS. 7P-7BB, attention 707 is optionally indicative of the user's attention being directed to respective virtual content (e.g., virtual object 712), and that user input optionally continues to be directed to the respective virtual content because attention 707 is directed to the respective virtual content.

From FIG. 7P to FIG. 7Q, computer system 101 moves the virtual object 712 in accordance with movement of hand 716 maintaining the air pinch gesture. As described further with reference to FIGS. 7A-7O, computer system 101 displays a virtual shadow 770 in accordance with a determination that the virtual object 712 is within a snapping threshold distance of the virtual object 760, described further with reference to method 800. For example, the computer system 101 determines that the virtual object 712 is overlaying the virtual object 760 relative to the viewpoint of user 714, and/or is within the snapping threshold distance described further with reference to FIGS. 7A-7O of virtual object 760. In FIG. 7Q, computer system 101 displays virtual shadow 770 in accordance with a position and/or orientation of a simulated light source casting simulated light (optionally not shown) toward virtual object 712 and onto the surface of virtual object 760. In FIG. 7Q, computer system 101 displays visual indication 705 to indicate that the virtual object 712 is currently snapping and/or will snap to virtual object 760. Additionally, in FIG. 7Q, visual indication 705 indicates that the virtual object is able to be added to virtual object 760.

In some embodiments, computer system 101 dynamically scales a virtual object in response to input moving the virtual object. For example, in FIG. 7Q as illustrated in the overhead view, virtual object 712 is displayed with a consistent scale relative to the viewport of the computer system 101 (e.g., the portion of three-dimensional environment 701 visible via display 120), however, virtual object 712 is relatively less wide than in FIG. 7P. In response to moving the virtual object 712 further from the viewpoint of user 714, computer system 101 increases the scale of the virtual object 712, thus presenting a consistent scale as perceived by user 714. It is understood that the virtual object 712 is dynamically scaled in the FIGS. 7P-7BB.

In some embodiments, computer system 101 adds first virtual content to second virtual content. For example, as described with reference to FIGS. 7A-7O, virtual object 760 is a container virtual object. In response to termination of the air pinch gesture while visual indication 705 is displayed, computer system 101 optionally “adds” virtual object 712 to virtual object 760. In such embodiments, the computer system 101 treats virtual object 712 as included in virtual object 760, moving the two virtual objects concurrently, in a same direction, and/or by a same magnitude in response to input requesting movement of virtual object 760. Thus, after virtual object 712 is added to virtual object 760, the computer system optionally treats the virtual objects as a single, moveable entity, at least until one or more inputs are detected moving virtual object 712 away from the virtual object 760 (e.g., to a distance beyond a threshold distance (e.g., 0.001, 0.005, 0.01, 0.05, 0.1, 0.125, 0.15, or 0.2 m) from virtual object 760) and/or disassociating virtual object 712 from the virtual object 760.

As described further with reference to method 800, computer system 101 in FIG. 7Q positions a simulated light source relatively above the virtual object 712, oriented toward the surface of virtual object 760, and pointing leftward relative to the viewpoint of user 714. It is understood that additional or alternative simulated light sources optionally cast simulated light toward virtual content; thus computer system 101 is capable of displaying the virtual shadow 770 optionally differently in spatial profile, position, and/or scale than virtual shadow 770 in FIG. 7Q in accordance with the additional or alternative simulated light sources. In some embodiments, computer system 101 changes the position and/or orientation of the simulated light source in accordance with changes in a spatial relationship between virtual object 760 and virtual object 712. For example, in response to moving the virtual object 712 closer to the surface of virtual object 760, the computer system 101 optionally moves the simulated light source closer to a normal extending from virtual object 760, and/or closer to virtual object 712. In response to moving virtual object 712 further from the surface of virtual object 760, computer system 101 optionally moves the simulated light source further from the normal extending from virtual object 760, and/or further from virtual object 712. It is understood that the simulated light source optionally is oriented toward a respective portion of virtual object 712 that optionally is the same as the virtual object 712 is moved relative to virtual object 760, or optionally changes as the virtual object 712 is moved relative to virtual object 760.

From FIG. 7Q to FIG. 7R, computer system 101 detects the air pinch maintained by hand 716 moving, and in response moves the virtual object 712 toward the surface of virtual object 760. In response to the movement of hand 716, computer system 101 moves virtual object 712 closer to the surface of virtual object 760. Accordingly, in FIG. 7R, computer system 101 moves the virtual shadow 770, scales the virtual shadow 770, increases a darkness of virtual shadow 770, displays the virtual shadow (e.g., a periphery of the virtual shadow 770) less diffuse than its previous appearance, and/or increases an opacity of virtual shadow 770 as compared to in FIG. 7Q. It is understood that the aforementioned aspects of the virtual shadow are at times referred to as “visual properties” that optionally comprise a visual appearance of the virtual shadow 770. The visual appearance of virtual shadow 770 in FIG. 7R optionally corresponds to movement of the simulated light source casting virtual shadow 770 toward the normal extending from virtual object 760, and/or closer to virtual object 712 relative to the simulated light source in FIG. 7Q. For example, the virtual shadow 770 has a spatial profile (e.g., generally rectangular shaped) that corresponds to the spatial profile of virtual object 712. From FIG. 7Q to FIG. 7R, the spatial profile of virtual shadow 770 is generally maintained, and/or the virtual shadow 770 is translated along the surface of virtual object 760 drawing closer to a position surrounding, and/or sharing a center with virtual object 712 relative to the viewpoint of user 714. FIG. 7S illustrates a further movement of virtual object 712 (e.g., automatically without an express user input or in response to movement of hand 716), and a further change in the simulated light source casting virtual shadow 770 to nearly align the center of virtual object 712 with the virtual shadow 770. Virtual shadow 770 in FIG. 7S is changed in visual appearance relative to in FIG. 7R, mimicking the moving of the simulated light source moving closer in a depth direction-along the normal extending from virtual object 760—toward the virtual object 712.

In some embodiments, computer system 101 changes a scale of an object progressively to visually indicate that the virtual object is snapping towards another virtual object. For example, because virtual object 712 in FIG. 7Q moves into the snapping threshold distance of virtual object 760, computer system 101 initiates an increasing of a scale of the virtual object (e.g., different from the dynamic scaling described herein) relative to three-dimensional environment 701. From FIG. 7Q to FIG. 7R, computer system 101 optionally scales the virtual object 712 relative to the three-dimensional environment 701, greater than an amount of scaling that would otherwise preserve the perceived scale of virtual object 712 relative to the user's viewpoint. From FIG. 7R to FIG. 7S, computer system 101 further scales virtual objet 712, displaying virtual object 712 at a relatively larger size. In FIG. 7T, because virtual object 712 reaches a snapping location relative to virtual object 712 and/or menu 766, computer system 101 forgoes further scaling of virtual object 712, aside from scaling in accordance with the dynamic scaling behavior described further herein.

From FIG. 7S to FIG. 7T, computer system 101 moves the virtual object 712 in accordance with detected movement of hand 716 maintaining the air pinch gesture. In some embodiments, computer system 101 changes a position of virtual content that is moving in accordance with a “height” of underlying virtual content (e.g., a distance between the virtual object and the underlying virtual content). For example, in FIG. 7R, virtual object 712 is displayed at a position or location having a height relative to the surface of virtual object 760 as indicated in the overhead view of the three-dimensional environment 701. From FIG. 7S to FIG. 7T, the movement of hand 716 includes a request to move the virtual object 712 parallel to the front surface of virtual object 760 (optionally not including a request to move virtual object 712 along the normal extending from virtual object 760), such as leftward movement of the hand without forward or backward movement of the hand toward virtual object 760. In FIG. 7T, the height of virtual object 712 (e.g., along the normal) changes automatically, without an express request to change the height, because a height of content is raised by the height of menu 766 relative to virtual object 760 as indicated in the overhead view of the three-dimensional environment 701. Thus, in accordance with a determination that the virtual object 712 moves over virtual content of a first height, the virtual object 712 is moved to a first distance (e.g., height) relative to virtual object 720. In accordance with a determination that the virtual object 712 moves over virtual content of a second height (e.g., including virtual object 720 and/or menu 766) in FIG. 7T, computer system 101 displays the virtual object 712 at a second height relative to virtual object 720.

In some embodiments, the height of virtual object 712 relative to underlying virtual content is a predetermined, or fixed distance. For example, virtual object 712 in FIG. 7S and in FIG. 7T is displayed at the predetermined distance from the virtual object 760, and from menu 766, respectively. In some embodiments, in response to detecting movement of the virtual object 712 rightward overlaying virtual object 760, and no longer overlaying menu 766, computer system 101 optionally again displays virtual object 712 at its height illustrated in the overhead view in FIG. 7S.

From FIG. 7T to FIG. 7U, computer system 101 detects movement of hand 716 maintaining the air pinch gesture. In response to detecting the movement, computer system 101 moves virtual object 712 to correspond to (e.g., overlap with) virtual object 768 in FIG. 7U. In some embodiments, when a virtual object (e.g., 712) is moved to within a threshold distance (e.g., 0.001, 0.005, 0.01, 0.05, 0.1, 0.125, 0.15, 0.25, 0.5, or 1 m) of a recipient (e.g., container) virtual object, the computer system 101 changes a focus state of the recipient virtual object. For example, in FIG. 7U, virtual object 768 is displayed with the active focus state. In some embodiments, because virtual object 768 in FIG. 7U is displayed with the active focus state, virtual object 760 is displayed with the inactive focus state. For example, menu 766 and/or virtual object 760 are no longer displayed (e.g., indicated by the dashed borders) and/or are no longer visible to the user 714, despite being closer to the viewpoint of user 714 than virtual object 768 in the overhead view in FIG. 7U.

In FIG. 7U, computer system 101 displays the virtual shadow 772 overlaying virtual object 768, similar to the virtual shadow 770. It is understood that the virtual shadow 772 has one or more characteristics of virtual shadow 770, relative to virtual object 768 instead of virtual object 760. For example, because the virtual object 712 is relatively close to the surface of virtual object 768, computer system 101 positions a simulated light source such that the spatial profile of virtual shadow 772 is centered, or nearly centered with the virtual object 712, is displayed with a relatively dark visual appearance, and is displayed with a scale such that the virtual shadow 772 extends modestly away from a border of virtual object 712.

From FIG. 7U to FIG. 7V, computer system 101 moves virtual object 712 upward relative to a face of virtual object 768 in response to detected movement of hand 716 maintaining the air pinch gesture. In some embodiments, computer system 101 does not offset and/or change a height of a virtual object (e.g., while moving, and/or after moving) in accordance with a determination that the virtual object is moved over three-dimensional objects relative to the viewpoint of user 714. From FIG. 7U to FIG. 7V, as illustrated in the overhead view, computer system 101 maintains the height between virtual object 712 and virtual object 768 despite the presence of virtual object 727. In FIG. 7V, computer system 101 instead decreases a level of visual prominence (e.g., opacity) of virtual object 727 (e.g., ceases display of the dashed portions), and/or forgoes changing a height of virtual object 712 relative to virtual object 768. In contrast with the virtual object 712 moving over menu 766 described herein, computer system 101 does not increase a height of virtual object 712 to remain the predetermined distance from virtual object 727.

From FIG. 7V to FIG. 7W, computer system 101 moves virtual object 712 to within the threshold distance (e.g., described previously) of virtual object 760, initiating a snapping of virtual object 712 to virtual object 760 and changing the focus states of virtual object 760 and virtual object 768. For example, in FIG. 7W, virtual object 760 has the active focus state and virtual object 768 has the inactive focus state. In FIG. 7W, computer system 101 reinitiates display of virtual shadow 770.

In FIG. 7X, computer system 101 detects a termination of the air pinch gesture, and in response adds the virtual object 712 to virtual object 760. Accordingly, the computer system 101 ceases display of virtual shadow 770 and visual indication 705 illustrated in FIG. 7W.

In some embodiments, computer system 101 forgoes display of a virtual shadow when moving a virtual object that has been added to another virtual object. For example, from FIG. 7X to FIG. 7Y, computer system 101 moves the virtual object 712 leftward, and/or does not display a virtual shadow despite the ongoing movement (e.g., a maintaining of the air pinch pose formed by hand 716).

In some embodiments, computer system 101 displays an animation of a virtual shadow. In some embodiments, the virtual shadow is delayed when moving a virtual object away from another virtual object. For example, from FIG. 7Y to FIG. 7Z, computer system 101 detects a movement of hand 716 forming the air pinch pose away from the surface of virtual object 760. In some embodiments, computer system 101 immediately initiates display of virtual shadow 770 to indicate that virtual object 712 is no longer added to and/or included in virtual object 760 in response to the movement. For example, in FIG. 7Z, computer system 101 displays virtual shadow 770.

In some embodiments, in response to the movement, and/or in accordance with a determination that a requested movement of the virtual object 712 satisfies one or more criteria (e.g., includes a request to move the virtual object 712 more than a threshold distance and/or at a speed greater than a threshold speed away from virtual object 760 described further with reference to method 800), computer system 101 moves virtual object 712 away from virtual object 760. In some embodiments, immediately after and/or after a threshold period of time (e.g., 0.01, 0.05, 0.1, 0.2, 0.3, 0.4, 0.5, 0.75, 1, 1.25, 1.5, or 2 seconds) of moving virtual object 712 away from virtual object 760, computer system 101 forgoes display of the virtual shadow. After the period of time has passed, the computer system 101 optionally gradually displays the virtual shadow, optionally without detecting further movement of the virtual object. For example, in FIG. 7AA, computer system 101 moves virtual object 712 away from virtual object 760, and after the threshold period of time has elapsed, displays virtual shadow 770.

From FIG. 7AA to FIG. 7BB, computer system 101 does not detect movement of hand 716, and consequentially does not move virtual object 712. Computer system 101, however, changes the position of the simulated light source casting virtual shadow 770, similar to as though the virtual object 712 were moving further from the surface. Such an animation effectively presents a visual “catching up” of the virtual shadow, moving and changing visual appearance of virtual shadow 770 as though the virtual object 712 were moving. FIG. 7BB illustrates a ceasing of the virtual shadow at the conclusion of the animation, thus visually indicating that the virtual object 712 is no longer within a snapping threshold distance of virtual object 760.

In some embodiments, computer system 101 changes a scale of an object that is being moved progressively to visually indicate that the virtual object is moving away from a snapping location relative and/or another virtual object. For example, because virtual object 712 from FIG. 7Y to FIG. 7Z begins to move away from the snapping location relative to virtual object 760, computer system 101 initiates a decreasing of a scale of the virtual object (e.g., different from the dynamic scaling described herein). From FIG. 7Y to FIG. 7Z, computer system 101 optionally scales down the virtual object 712 relative to the three-dimensional environment 701, greater than an amount of scaling that would otherwise preserve the perceived scale of virtual object 712 relative to the user's viewpoint. From FIG. 7Z to FIG. 7AA, computer system 101 further scales virtual objet 712 to a smaller scale relative to three-dimensional environment 701.

FIG. 8 is a flowchart illustrating an exemplary method of facilitating the movement and/or placement of first virtual objects with respect to second virtual objects in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., 101) in communication with a display generation component (e.g., 120) and one or more input devices (e.g., 314). For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system displays (802a), via the display generation component, a first virtual object at a first location and a second virtual object at a second location, different from the first location, in a three-dimensional environment, such as the first virtual object 728 and the second virtual object 718 in the three-dimensional environment 748 in FIGS. 7B and 7B1. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., optical, true, or real passthrough). In some embodiments, a representation of the physical environment is displayed in the three-dimensional environment via the display generation component (e.g., virtual or video passthrough). In some embodiments, the computer system displays the first virtual object at the first location and the second virtual object at the second location in the three-dimensional environment that is in the field of view of a user of the computer system from a viewpoint of the user of the three-dimensional environment.)

In some embodiments, the second virtual object is a container that is able to contain the first virtual object, and wherein the first location is greater than a threshold distance (e.g., 0.1, 0.5, 1, 5, 10, 50, 100, 200, 300, 400, 500, 600, 700, 800, 900, or 1000 centimeters) from the second location, such as the first location of virtual object 728 a distance from the second location of the second virtual object 718 in FIGS. 7B and 7B1. In some embodiments, the first virtual object and/or the second virtual object is a three-dimensional virtual object or a two-dimensional virtual object. In some embodiments, the first virtual object and/or the second virtual object are associated with an application, such as a photo management application, file management application, media content management application, messaging application, or email application. For example, the first virtual object is a digital image, video, or media content (or a representation of a digital image, video, or media content) that can be placed at a drop location (e.g., second location) corresponding to the second virtual object, which is optionally a user interface container or window virtual object that can accept and/or display the digital image, video, and/or media content (e.g., the second virtual object is a user interface of a messaging application that includes a text entry field into which a digital image can be dropped to be added to a messaging conversation displayed in the second virtual object) and which is located greater than the threshold distance from the first location corresponding to the first virtual object (e.g., behind or to the left or to the right of the first virtual object from a perspective of a viewpoint of a user of the computer system in the three-dimensional environment). In some embodiments, when the computer system detects that a location of the first virtual object in the three-dimensional environment satisfies one or more first criteria as described with reference to claim 5, the computer system initiates an operation to add the first virtual object to the second virtual object (e.g., move the first virtual object from the first location to the second location corresponding to the second virtual object).

In some embodiments, while displaying, via the display generation component, the first virtual object at the first location and the second virtual object at the second location, the computer system detects (802b), via the one or more input devices, a first input corresponding to a request to move the first virtual object away from the first location in the three-dimensional environment, such as first input 736A in FIGS. 7B and 7B1. For example, detecting the first input optionally includes detecting a portion (e.g., a hand, arm, and/or finger) of the user performing an air pinch gesture (e.g., two or more fingers of a user's hand such as the thumb and index finger moving together and touching each other) to form a pinch hand shape while attention (e.g., gaze) of the user is directed to the first virtual object while the portion of the user is greater than a second threshold distance (e.g., 2, 4, 6, 8, 10, 15, 20, 30, 40, 50, 100, 200, 300, 400, 500, 600, 700, 800, 900, or 1000 centimeters) from the first virtual object, or a pinch of the thumb and index finger followed by movement of the hand in the pinch hand shape irrespective of the location of the attention of the user when the hand of the user is less than the second threshold distance from the first virtual object. In some embodiments, the request to move the first virtual object away from the first location in the three-dimensional environment is a movement of the hand towards the viewpoint of the user, which optionally corresponds to a request to move the first virtual object towards the viewpoint of the user or a movement of the hand away from the viewpoint of the user, which optionally corresponds to a request to move the first virtual object away from the viewpoint of the user in the three-dimensional environment. In some embodiments, the request to move the first virtual object away from the first location in the three-dimensional environment is a movement of the hand vertically (e.g., up or down) which optionally corresponds to a request to move the first virtual object vertically or a movement of the hand horizontally (e.g., left or right) which optionally corresponds to a request to move the first virtual object horizontally in the three-dimensional environment. In some embodiments, the first input includes movement of a stylus and/or pointing device in communication with the computer system and/or movement of a finger contacting a trackpad detected by the computer system.

In some embodiments, in response to (and/or while) detecting the first input (802c), the computer system moves (802d) the first virtual object in the three-dimensional environment in accordance with the first input, such as the first virtual object moving from a first location in FIGS. 7B and 7B1 to a second location in FIG. 7C. For example, moving the first virtual object away from the first location in the three-dimensional environment based on the movement of the hand of the user. For example, the first virtual object is moved in a direction (e.g., left, right, upwards, downwards, forward, and/or backward) to a location that is within the threshold distance of the second location of the second virtual object as described with reference to claim 1 or further than the threshold distance from the second location of the second virtual object as described with reference to claim 1. In some embodiments, the magnitude, speed, acceleration and/or direction of the movement of the first virtual object corresponds to the magnitude, speed, acceleration and/or direction of the movement of the hand of the user during the first input.

In some embodiments, in accordance with a determination that the first input corresponds to movement of the first virtual object to a third location in the three-dimensional environment that is within the threshold distance of the second location of the second virtual object, the computer system displays (802e) the first virtual object with an orientation in the three-dimensional environment that is based on an orientation of the second virtual object, such as the orientation of the first virtual object 728 in FIG. 7G. In some embodiments, the computer system initially displays the first virtual object and/or the second virtual object (e.g., before detecting the first input) with an orientation that includes a normal extending from a surface of the respective virtual object towards the viewpoint of the user in the three-dimensional environment. For example, when the first virtual object is moved to the third location, different from the first location, and/or within the threshold distance of the second location of the second virtual object, the computer system optionally displays the first virtual object with an orientation that is not based on the viewpoint of the user of the computer system (e.g., not based on a spatial arrangement (e.g., position and/or orientation) of the first virtual object relative to the viewpoint of the user), but optionally displays the first virtual object with an orientation that is based on an orientation of the second virtual object. For example, the computer system optionally displays the first virtual object with an orientation parallel to the second virtual object, even if no input is provided to display the first virtual object with an orientation parallel to the second virtual object. In some embodiments, when the second virtual object is a window virtual object, the orientation of the first virtual object is optionally parallel to a surface of the window virtual object. In some embodiments, the orientation of the first virtual object does not change relative to the three-dimensional environment as the first virtual object changes in spatial arrangement (e.g., position and/or orientation) relative to the viewpoint of the user (or alternatively changes differently than it would change if the first virtual object was greater than the threshold distance from the second virtual object). In some embodiments, the computer system displays the first virtual object with an orientation that is not directed towards the viewpoint of the user, as described in more detail below. In some embodiments, the computer system maintains display of the first virtual object with an orientation that is based on the orientation of the second virtual object as the computer system moves the first virtual object in the three-dimensional environment until the computer system detects that a location of the first virtual object in the three-dimensional environment is further than the threshold distance from the second location of the second virtual object.

In some embodiments, in accordance with a determination that the first input corresponds to movement of the first virtual object to a fourth location in the three-dimensional environment that is further than the threshold distance from the second location of the second virtual object, the computer system displays (802f) the first virtual object with an orientation that is independent of (e.g., not based on) an orientation of the second virtual object, such as the orientation of the first virtual object 728 in FIG. 7C. (e.g., based on a spatial arrangement (e.g., position and/or orientation) of the first virtual object relative to the viewpoint of the user and/or optionally, a virtual object other than the second virtual object as described below). For example, when the first virtual object is moved to the fourth location, different from the first location, and/or further than the threshold distance from the second location of the second virtual object (and, optionally, away from any other container virtual objects), the computer system optionally displays the first virtual object with an orientation that is not based on the orientation of the second virtual object, but optionally displays the first virtual object with an orientation that is based on the viewpoint of the user of the computer system. For example, the computer system optionally displays the first virtual object with an orientation that is directed towards the viewpoint of the user of the computer system, even if no input is provided to display the first virtual object with an orientation directed towards the viewpoint of the user of the computer system (e.g., orienting the first virtual object toward the viewpoint of the user includes orienting the first virtual object so that a front of the first virtual object or a side of the first virtual object that is presented to a user by default when the first virtual object is initially displayed (e.g., and before detecting the first input) is oriented towards the viewpoint of the user (e.g., the front or side of the first virtual object is facing or is perpendicular or normal to the viewpoint of the user)). For example, when the first virtual object is moved within the three-dimensional environment, the computer system tilts the first virtual object away from the default orientation such that a front-facing surface of the first virtual object continues to face toward the viewpoint of the user. In some embodiments, the rotation of the first virtual object is based on a direction of movement of the first virtual object. For example, if the first virtual object is moved horizontally in the three-dimensional environment, the computer system tilts the first virtual object relative to a vertical axis through the first virtual object. In some embodiments, if the first virtual object is moved vertically in the three-dimensional environment, the computer system tilts the first virtual object relative to a horizontal axis through the first virtual object. In some embodiments, the first virtual object is tilted about a center of the first virtual object in the three-dimensional environment. In some embodiments, if the first virtual object is moved toward or away from the viewpoint of the user (e.g., without changing the angle of elevation of the first virtual object), the first virtual object is not rotated in the three-dimensional environment.). In some embodiments, the orientation of the first virtual object changes relative to the three-dimensional environment as the first virtual object changes in spatial arrangement (e.g., position and/or orientation) relative to the viewpoint of the user (or alternatively changes differently than it would change if the first virtual object was less than the threshold distance from the second virtual object). In some embodiments, the computer system maintains displaying the first virtual object with an orientation that is based on the viewpoint of the user of the computer system as the computer system moves the first virtual object in the three-dimensional environment until the computer system detects that a location of the first virtual object in the three-dimensional environment is within the threshold distance of the second location of the second virtual object. Changing the orientation of the first virtual object when moved to a location corresponding to the second virtual object enables a user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, while detecting the first input (and/or in response to detecting the first input), such as input 736A in FIG. 7D and in accordance with a determination (e.g., in response to determining) that the first virtual object is further than the threshold distance from any virtual object that is a container that is able to contain the first virtual object, such as the second virtual object 718 and the fourth virtual object 720, the computer system displays the first virtual object with an orientation that is based on a viewpoint of a user of the computer system, such as the orientation of the first virtual object 728 in FIGS. 7B and 7B1. In some embodiments, the same techniques described above with reference to detecting whether the first virtual object is further than the threshold distance away from the second virtual object and displaying the first virtual object accordingly is applied to any virtual object that is a container. Thus, as described throughout, when determining whether the first virtual object is further than the threshold distance away from any virtual object or whether the first virtual object is within the threshold distance of any virtual object, the computer system performs any of the techniques described above to detect the location of the first virtual object with respect to the location of any virtual object. In some embodiments, virtual objects including the second virtual object that are able to contain the first virtual object are user interface elements or objects such as windows, platters, backplanes, or other defined areas of the three-dimensional environment. In some embodiments, the computer system displays any virtual object at any location in the three-dimensional environment and with any orientation. In some embodiments, when the first virtual object is moved further than the threshold distance from any virtual object including the second virtual object, the computer system displays the first virtual object with an orientation that is not based on the orientation of any virtual object including the second virtual object, but with an orientation that is based on the viewpoint of the user of the computer system, as described with reference to method(s) 800. Changing the orientation of the first virtual object when moved to a location that is further than the threshold distance from any virtual object provides feedback to the user that the first virtual object is moving further away from any virtual object and enables the user to quickly position the first virtual object appropriately with respect to any virtual object, thereby reducing errors in interacting with virtual objects, which provides a more efficient user-computer system interface, reduces power consumption, and improves battery life of the computer system.

In some embodiments, the computer system displays, via the display generation component, a third virtual object at a third location, different from the second location of the second virtual object, in the three-dimensional environment, wherein the third virtual object is a second container that is able to contain the first virtual object, such as the fourth virtual object 720 in FIGS. 7B and 7B1. In some embodiments, the first location of the first virtual object is greater than the threshold distance (e.g., described above) from the third location of the third virtual object. In some embodiments, the orientation of the third virtual object is the same as or different from the orientation of the second virtual object. In some embodiments, the third virtual object is associated with the same or different application than the application associated with the second virtual object.

In some embodiments, while moving the first virtual object in the three-dimensional environment in accordance with the first input, detecting that the first virtual object is within the threshold distance of the third location of the third virtual object, such as third virtual object 726 in FIG. 7E.

In some embodiments, in response to detecting that the first virtual object is within the threshold distance of the third location of the third virtual object, the computer system displays the first virtual object with an orientation that is based on an orientation of the third virtual object, such as the orientation of such as third virtual object 726 in FIG. 7E. In some embodiments, the computer system displays the first virtual object with an orientation that is optionally not based on the orientation of the second virtual object. For example, the computer system optionally displays the first virtual object with an orientation that is not based on the viewpoint of the user of the computer system (e.g., not based on a spatial arrangement (e.g., position and/or orientation) of the first virtual object relative to the viewpoint of the user), but optionally displays the first virtual object with an orientation that is based on an orientation of the third virtual object (even when no input is provided to display the first virtual object with an orientation that is based on the orientation of the third virtual object), similarly to as described with reference to method(s) 800 with respect to the second virtual object. Changing the orientation of the first virtual object when moved to a location that is within the threshold distance of the third location of the third virtual object provides feedback to the user that the first virtual object is moving closer to the third virtual object and enables the user to quickly position the first virtual object appropriately with respect to the third virtual object, thereby facilitating adding the first virtual object to the third virtual object and reducing errors in interacting with virtual objects, which provides a more efficient user-computer system interface, reduces power consumption, and improves battery life of the computer system.

In some embodiments, the first virtual object is spatially arranged at a distance apart from the second virtual object while the first virtual object is within the threshold distance of the second virtual object, such as third virtual object 726 in FIG. 7E. For example, and as described above with reference to moving the first virtual object in the three-dimensional environment in accordance with the first input, the computer system displays the first virtual object at the third location that is within the threshold distance of the second virtual object. In some embodiments, and as will be described below with reference to displaying the first virtual object at the location of the second virtual object, the third location of the first virtual object is within the threshold distance from the second virtual object and as such, is spatially arranged at a distance apart (e.g., 0.01, 0.05, 0.1, 0.2, 0.5, 1, 3, 5, 10, 15, or 20 cm) from the second virtual object. In some embodiments, the first virtual object and the second virtual object are spaced apart from each other at a minimum distance such that the computer system identifies and interacts with the first virtual object over the second virtual object or any other virtual object. Spatially arranging the first virtual object a distance apart from the second virtual object enables the user to quickly select and position the first virtual object appropriately with respect to the second virtual object, thereby reducing errors in interacting with virtual objects, which provides a more efficient user-computer system interface, reduces power consumption (e.g., the computer system readily recognizes virtual objects individually), and improves battery life of the computer system.

In some embodiments, while moving the first virtual object in the three-dimensional environment in accordance with the first input, such as input 736B in FIG. 7C, and in accordance with a determination that the first virtual object is within the threshold distance of the second location of the second virtual object, moving the first virtual object in a linear path in accordance with at least a portion of the first input, such as path 742 in the overhead view 750 in FIG. 7C. For example, in response to detecting at least a portion of the first input that includes detecting movement of the hand requesting to move the object that satisfies a first criteria (e.g., the first virtual object is moved to a location that is within the threshold distance of the second location of the second virtual object) without optionally satisfying a second criteria (e.g., the first virtual object is moved to a location that is further than the threshold distance of the second location of the second virtual object), the computer system optionally moves the first virtual object in a linear path between the first location to the third location that is within the threshold distance of the second location of the second virtual object. In some embodiments, moving the first virtual object in the linear path includes or is a direction that is parallel to the surface of the second virtual object, a direction that is perpendicular to the surface of the second virtual object, or an orientation relative to the surface of the second virtual object as described herein and with reference to method(s) 800. In some embodiments, the computer system deviates from moving the first virtual object in the linear path when the computer system detects movement of the hand requesting to move the object that satisfies the second criteria as described below.

In some embodiments, in accordance with a determination that the first virtual object is further than the threshold distance from the second location of the second virtual object, the computer system moves the first virtual object along a curved path in accordance with the at least the portion of the first input, such as a path of the third virtual object 726 from FIG. 7I to FIG. 7J. For example, in response to detecting at least a portion of the first input that includes detecting movement of the hand requesting to move the object that satisfies the second criteria as described above without optionally satisfying the first criteria described above, the computer system optionally moves the first virtual object in a curved path between the first location to the fourth location that is further than the threshold distance from the second location of the second virtual object. In some embodiments, moving the first virtual object in the curved path included one or more characteristics of moving the first virtual object relative to the second virtual object as described herein and with reference to method(s) 800. In some embodiments, the computer system deviates from moving the first virtual object in the curved path when the computer system detects movement of the hand requesting to move the object that satisfies the first criteria as described above. In some embodiments, the computer system moves the first virtual object along the curved path relative to the viewpoint of the user. In some embodiments, the curved path that is designated by the computer system lies in the user's field of view of the three-dimensional environment. Changing the path of movement of the first virtual object when within the threshold distance of the second location of the second virtual object or when further than the threshold distance of the second location of the second virtual provides feedback to the user that the first virtual object is moving closer or further from the second virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, while moving the first virtual object in the three-dimensional environment in accordance with the first input, the computer system detects that at least a portion of the first input corresponds to moving the first virtual object away from the second virtual object (or away from the second location of the first virtual object), such as 736B in FIG. 7E. For example, moving the first virtual object away from a location that is different from the second location. In some embodiments, the at least the portion of the first input includes an air drag gesture. For example, the computer system optionally detects movement of a portion of the user, such as movement of the hand of the user in space while the hand is holding the pinch hand shape (e.g., the tips of the thumb and index finger remain touching).

In some embodiments, in response to detecting the at least the portion of the first input corresponding to moving the first virtual object away from the second virtual object, the computer system moves the first virtual object along a curved path away from the second virtual object, such as a path of the third virtual object 726 from FIG. 7E to FIG. 7F. In some embodiments, moving the first virtual object along the curved path has one or more characteristics of moving the first virtual object along a curved path in accordance with the at least the portion of the first input described above. In some embodiments, the first virtual object is moving along the curved path away from the second virtual object toward a particular location in the three-dimensional environment as described below. In some embodiments, when the computer system detects an end of the air drag gesture (e.g., a release of the air drag gesture), the computer system ceases moving the first virtual object along a curved path away from the second virtual object, even if the computer system detects continued movement of the hand in space corresponding to moving the first virtual object away from the second virtual object. For example, the end of the air drag gesture corresponds to a release of the air pinch (e.g., the index finger and thumb of the hand are no longer in contact) and/or predefined movement of the hand to a resting state position (e.g., at the user's side and/or out of the user's field of view), irrespective of further movement of hand in space. Moving the first virtual object along a curved path in response to detecting movement of the first virtual object away from the second virtual object produced by an air drag gesture in the three-dimensional environment provides feedback to the user that the first virtual object is moving further from the second virtual object and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while moving the first virtual object in the three-dimensional environment in accordance with the first input, detecting that the first virtual object reaches a location that is within the threshold distance of the second virtual object in the three-dimensional environment, such as the first virtual object 728 in FIG. 7H. In some embodiments, the threshold distance is less than the threshold distance described above.

In some embodiments, in response to detecting that the first virtual object reaches the location that is within the threshold distance of the second virtual object in the three-dimensional environment, such as shown by the first virtual object 728 within the threshold distance of the second virtual object 718 in FIG. 7H, the computer system moves the first virtual object to a respective location corresponding to the second virtual object without detecting input for moving the first virtual object to the respective location corresponding to the second virtual object, such as the second virtual object 718 in FIG. 7I. For example, the respective location corresponding to the second virtual object is optionally a snap location. In some embodiments, when the computer system determines that the first virtual object reaches a location that is within a threshold distance of the second virtual object, the computer system performs a “snapping” operation to snap the first virtual object to the second virtual object such that the first virtual object is visually contained within the second virtual object. In some embodiments, moving the first virtual object to the respective location corresponding to the second virtual object is performed without requiring input from the user to precisely position the first virtual object to align with the second virtual object. In some embodiments, when the first virtual object is moved to the respective location corresponding to the second virtual object, the computer system outputs visual, audio and/or haptic feedback indicating that the first virtual object is added to the second virtual object. Moving the first virtual object to a particular location corresponding to the second virtual object when the first virtual object is within the threshold distance of the second virtual object provides a quick and efficient way of aligning the first virtual object to the second virtual object without requiring the user to provide further inputs to precisely position the first virtual object appropriately with respect to the second virtual object, thereby reducing errors in interacting with virtual objects, which provides a more efficient user-computer system interface, reduces power consumption, and improves battery life of the computer system.

In some embodiments, moving the first virtual object to the respective location corresponding to the second virtual object includes changing a size of the first virtual object to display the first virtual object with a size at the respective location that is based on a size of the second virtual object, such as the first virtual object 728 changing from a first size shown in FIG. 7H to a second size shown in FIG. 7I. In some embodiments, the first virtual object includes a dynamic size based on the location of the first virtual object with respect to the respective location corresponding to the second virtual object. For example, when the computer system detects movement of the first virtual object away from the viewpoint of the user that does not correspond to the second virtual object, the computer system optionally changes the size of the first virtual object (e.g., larger) as the first virtual object is moved away from the viewpoint of the user. In another example, when the computer system detects movement of the first virtual object towards the viewpoint of the user that does not correspond to the second virtual object, the computer system optionally changes the size of the first virtual object (e.g., smaller) as the first virtual object is moved closer to the viewpoint of the user. In some embodiments, the computer system does not change the size of the first virtual object with respect to moving away or towards the viewpoint of the user when the first virtual object is in a respective location corresponding to the second virtual object as described herein. In some embodiments, the computer system changes the size of the first virtual object (e.g., relative to the size of the first virtual object while the first virtual object was displayed at a location that is further than the threshold distance from the second respective location corresponding to the second virtual object) based on a size of the second virtual object. For example, when the computer system moves the first virtual object to the respective location corresponding to the second virtual object, the computer system optionally increases the size of the first virtual object to prevent unintentionally adding/snapping the first virtual object to the second virtual object as will be described below with respect to a bounding volume associated with the first virtual object. In another example, when the computer system moves the first virtual object to a location that is further than the threshold distance from the second virtual object, the computer system optionally decreases the size of the first virtual object. In some embodiments, changing the size of the first virtual object to display the first virtual object with a size at the respective location that is based on a size of the second virtual object includes applying a scale factor (e.g., 10, 15, 20, 25, 30, 40, 50, 60, 70, 80, 90, 100, 125, 150, or 200%) that varies based on the display size of the second virtual object or other factors that will be described below. For example, the computer system optionally applies a scale factor to the first virtual object such that the height and/or width (or height, width, and/or depth) that reflects the size of the second virtual object as will be described below with reference to a bounding volume associated with the first virtual object. In some embodiments, the larger the second virtual object is, the larger the size the computer system scales the first virtual object to when it snaps to the second virtual object, and the smaller the second virtual object is, the smaller the size the computer system scales the first virtual object to when it snaps to the second virtual object. In some embodiments, in accordance with a determination that the second virtual object is at a first location and/or first distance relative to the current viewpoint of the user, the computer system displays the first virtual object with a first size (optionally different from a size of the first virtual object when at a respective location not corresponding to the second virtual object) at the respective location. In some embodiments, in accordance with a determination that the second virtual object is at a second location and/or second distance, different from the first location and/or first distance, relative to the current viewpoint of the user, the computer system displays the first virtual object with a second size (optionally different from a size of the first virtual object when at a respective location not corresponding to the second virtual object) at the respective location, different from the first size at the respective location. Changing the size of the first virtual object to display the first virtual object with a size at the respective location that is based on a size of the second virtual object enables the user to quickly position the first virtual object appropriately with respect to the second virtual object, thereby reducing errors in interacting with virtual objects (e.g., prevent unintentionally adding the first virtual object to the second virtual object), which provides a more efficient user-computer system interface, reduces power consumption, and improves battery life of the computer system.

In some embodiments, moving the first virtual object to the respective location corresponding to the second virtual object includes moving the first virtual object closer to the second virtual object, such as shown by the first virtual object 728 moving from a location in FIG. 7G to a location in FIG. 7H. For example, in response to the first input described above, the computer system optionally moves the first virtual object in the three-dimensional environment closer to a location that is within the threshold distance of the second virtual object in the three-dimensional environment. In some embodiments, while the first virtual object is being moved closer to the second virtual object, the computer system displays an animation of the first virtual object moving and gradually changing appearance (e.g., size and/or color) and/or the computer system outputs audio and/or haptic feedback indicating that the first virtual object is closer to the second virtual object. Moving the first virtual object closer to the second virtual object provides feedback to the user that the first virtual object is moving closer to the second virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, moving the first virtual object to the respective location corresponding to the second virtual object includes changing an orientation of the first virtual object to display the first virtual object with an orientation in the three-dimensional environment that is based on the orientation of the second virtual object, such as the orientation of the first virtual object 728 that is based on the orientation of the second virtual object 718 in FIG. 7H. In some embodiments, changing an orientation of the first virtual object to display the first virtual object with an orientation in the three-dimensional environment that is based on the orientation of the second virtual object has one or more characteristics of displaying the first virtual object with an orientation in the three-dimensional environment that is based on an orientation of the second virtual object described above. In some embodiments, the orientation of the first virtual object gradually changes as the computer system moves the first virtual object to the respective location corresponding to the second virtual object. For example, the orientation of the first virtual object optionally includes a respective face (e.g., front-facing surface) on which content associated with first virtual object is displayed, and the computer system tilts and/or rotates the first virtual object such that the respective face is parallel to the second virtual object. Changing the orientation of the first virtual object to display the first virtual object with an orientation that is based on the orientation of the second virtual object enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while displaying the first virtual object at the respective location corresponding to the second virtual object, detecting, via the one or more input devices, a second input corresponding to a request to move the first virtual object away from the second virtual object in the three-dimensional environment (e.g., an input similar to or corresponding to the first input described above), such as input 736B in FIG. 7C.

In some embodiments, in response to (optionally while) detecting the second input, and in accordance with a determination that the second input corresponds to movement of the first virtual object to a distance greater than the threshold distance and less than a second threshold distance (e.g., 0.2, 0.5, 1, 3, 5, 10, 20, 40, 50, 100, 150, or 200 centimeters) from the second virtual object, the computer system moves the first virtual object to a location corresponding to the second virtual object where the orientation of the first virtual object is at least partially based on the orientation of the second virtual object, such as moving the third virtual object 726 from a location in FIGS. 7B and 7B1 to a location in FIG. 7C. In some embodiments, when the first virtual object is displayed at the respective location corresponding to the second virtual object, the computer system resists moving the first virtual object away from the respective location corresponding to the second virtual object. For example, in response to detecting movement of the first virtual object away from the second virtual object, the computer system optionally applies a simulated magnetic force to resist moving the first virtual object away from the second virtual object. In some embodiments, the computer system determines that the second input corresponding to movement of the first virtual object to a distance greater than the threshold distance and less than a second threshold distance from the second virtual object does not overcome the simulated magnetic force to move the first virtual object to a location other than a location corresponding to the second virtual object. Accordingly, the computer system optionally moves the first virtual object to a location corresponding to the second virtual object and displays the second virtual object with an orientation that is partially based on the orientation of the second virtual object. In some embodiments and as will be described below, the computer system presents varied simulated magnetic forces based on distance and/or direction of the movement of the first virtual object away from the second virtual object.

In some embodiments, in accordance with a determination that the second input corresponds to movement of the first virtual object to a distance greater than the second threshold distance from the second virtual object, moving the first virtual object in the three-dimensional environment to a location that does not correspond to the second virtual object where the orientation of the first virtual object is not based on the orientation of the second virtual object, such as moving the third virtual object 726 from a location in FIG. 7H to a location in FIG. 7I. For example, the computer system determines that the second input corresponding to movement of the first virtual object to a distance greater than the threshold distance from the second virtual object does overcome the simulated magnetic force to move the first virtual object to a location other than a location corresponding to the second virtual object. Accordingly, the computer system optionally moves the first virtual object to a location that does not correspond to the second virtual object and displays the second virtual object with an orientation that is not based on the orientation of the second virtual object. Resisting movement of the first virtual object away from the second virtual object provides confirmation that the user intends to move the first virtual object away from the second virtual object, thereby reducing errors in interacting with virtual objects (e.g., avoiding unintentional un-snapping of virtual objects due to minor movements) and reducing inputs needed to correct such errors, which provides a more efficient user-computer system interface, reduces power consumption, and improves battery life of the computer system.

In some embodiments, in accordance with a determination that the location of the first virtual object relative to the second virtual object when it reaches the threshold distance from the second virtual object is a first respective location, the respective location corresponding to the second virtual object is a second respective location, such as the location of the first virtual object 728 in FIG. 7L to FIG. 7M. For example, when the computer system detects that the first virtual object reaches the first respective location (e.g., the location that is within the threshold distance of the second virtual object in the three-dimensional environment), the computer system optionally moves the first virtual object to a second respective location (e.g., the respective location corresponding to the second virtual object). In some embodiments, the computer system detects movement of the first virtual object as it moves to the first respective location, and selects a particular location (e.g., the second respective location) at which to snap the first virtual object to the second virtual object (e.g., move the first virtual object to the second respective location corresponding to the second virtual object) without detecting input for moving the first virtual object to the particular location corresponding to the second virtual object. In some embodiments, the second respective location is based on the respective location of the virtual object when it reaches the threshold distance from the second virtual object (e.g., the first respective location).

In some embodiments, in accordance with a determination that the location of the first virtual object relative to the second virtual object when it reaches the threshold distance from the second virtual object is a third respective location, different from the first respective location, the respective location corresponding to the second virtual object is a fourth respective location, different from the second respective location, such as the location of the first virtual object 728 in FIG. 7N to FIG. 7O. In some embodiments, the particular location at which to snap the first virtual object to the second virtual object varies. For example, the fourth respective location at which to snap the first virtual object to the second virtual object is optionally different from the second respective location. In some embodiments, the fourth respective location is based on the respective location of the virtual object when it reaches the threshold distance from the second virtual object (e.g., the third respective location). Selecting a particular location at which to snap the first virtual object to the second virtual object based on the location at which the first virtual object reaches the threshold distance from the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, the respective location corresponding to the second virtual object is based on a projection, to the second virtual object, of a line between a viewpoint of the user and the location of the first virtual object relative to the second virtual object when the first virtual object reaches the threshold distance from the second virtual object, such as line 744 in FIG. 7I. For example, the projection is a line between a first point corresponding to a location of the viewpoint of the user and a second point corresponding to a location of the first virtual object relative to the second virtual object when the first virtual object reaches the threshold distance from the second virtual object. In some embodiments, the projection extends to a third point corresponding to a location of a respective face (e.g., front-facing surface) on which content associated with the second virtual object is displayed. In some embodiments, the projection continues from the viewpoint of the user through a location of the first virtual object when the computer system determines that the first virtual object reaches the threshold distance from the second virtual object, and onto the surface of the second virtual object. In some embodiments, the location of the first virtual object when at the respective location corresponding to the second virtual object corresponds to a point at which the projection reaches and/or intersects with the surface of the second virtual object. Identifying a projection at which to snap the first virtual object to the second virtual object based on a line, to the second virtual object, and between a viewpoint of the user and the location of the first virtual object relative to the second virtual object when the first virtual object reaches the threshold distance from the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, the respective location corresponding to the second virtual object is based on a perpendicular projection from a surface of the second virtual object to the location of the first virtual object relative to the second virtual object when it reaches the threshold distance from the second virtual object, such as shown by projection 742 in FIG. 7D. For example, the projection is based on an intersection of a first point corresponding to the location of the first virtual object relative to the second virtual object when it reaches the threshold distance from the second virtual object and a line orthogonal to a respective face (e.g., front-facing surface) on which content associated with the second virtual object is displayed. In some embodiments, the location of the first virtual object when at the respective location corresponding to the second virtual object corresponds to a point at which the perpendicular projection reaches and/or intersects with the surface of the second virtual object. Identifying a projection at which to snap the first virtual object to the second virtual object based on a perpendicular projection from a surface of the second virtual object to the location of the first virtual object relative to the second virtual object when it reaches the threshold distance from the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, the respective location corresponding to the second virtual object is based on a respective angle of a viewpoint of the user relative to the second virtual object, such as the viewpoint of the user 730 relative to the fourth virtual object 720 in FIG. 7E. In some embodiments, the user changes their position and/or orientation in the physical environment to view the first virtual object and second virtual object from a range of viewing angles. For example, the computer system detects a change in the respective angle of the viewpoint of the user satisfies one or more criteria (e.g., within a range of angles described below), and in response, the computer system selects a particular location at which to snap the first virtual object to the second virtual object based on the respective angle of the viewpoint of the user relative to the second virtual object, and selects a different location at which to snap the first virtual object to the second virtual object if the angle of the viewpoint of the user is within a different range of angles. Selecting a particular location at which to snap the first virtual object to the second virtual object based on the respective angle of the viewpoint of the user relative to the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, while moving the first virtual object in the three-dimensional environment in accordance with the first input and in response to detecting that the first virtual object reaches the location that is within the threshold distance of the second virtual object in the three-dimensional environment, such as the first virtual object 728 in FIG. 7E, and in accordance with a determination that the respective angle of the viewpoint of the user relative to the second virtual object is within a first range of angles (e.g., the difference in the orientation of the viewpoint relative to a perpendicular line extending from the surface of the second object is within 2, 5, 10, 15, or 20 degrees), such as the viewpoint of the user 730 relative to the second virtual object 718 in FIG. 7E, the computer system displays the first virtual object at a respective location corresponding to the second virtual object based on a projection, to the second virtual object, of a line between a viewpoint of the user and the location of the first virtual object relative to the second virtual object when the first virtual object reaches the threshold distance from the second virtual object, such as projection 744 in the overhead view 752 in FIG. 7E. In some embodiments, a projection, to the second virtual object, of a line between a viewpoint of the user and the location of the first virtual object relative to the second virtual object when the first virtual object reaches the threshold distance from the second virtual object has one or more characteristics of the projection, to the second virtual object, of the line between the viewpoint of the user and the location of the first virtual object relative to the second virtual object when the first virtual object reaches the threshold distance from the second virtual object described above. In some embodiments, displaying the first virtual object at a respective location corresponding to the second virtual object based on said projection includes displaying the first virtual object at a respective location within a path of said projection (e.g., within an angular range of the path of said projection). In some embodiments, the projection continues from the viewpoint of the user through a location of the first virtual object when the computer system determines that the first virtual object reaches the threshold distance from the second virtual object, and onto the surface of the second virtual object. In some embodiments, the location of the first virtual object when at the respective location corresponding to the second virtual object corresponds to a point at which the projection reaches the surface of the second virtual object.

In some embodiments, in accordance with a determination that the respective angle of the viewpoint of the user relative to the second virtual object is within a second range of angles (e.g., the difference in the orientation of the viewpoint relative to a perpendicular line extending from the surface of the second object is within 20, 30, 40, 50, 60, 70, or 80 degrees), different from the first range of angles, such as the viewpoint of the user 730 relative to the fourth virtual object 720 in FIG. 7E, the computer system displays the first virtual object at a respective location corresponding to the second virtual object based on a perpendicular projection from a surface of the second virtual object to the location of the first virtual object relative to the second virtual object when the first virtual object reaches the threshold distance from the second virtual object, such as projection 742 in the overhead view 750 in FIG. 7E. In some embodiments, a perpendicular projection from a surface of the second virtual object to the location of the first virtual object relative to the second virtual object when the first virtual object reaches the threshold distance from the second virtual object has one or more characteristics of the perpendicular projection from a surface of the second virtual object to the location of the first virtual object relative to the second virtual object when the first virtual object reaches the threshold distance from the second virtual object described above. In some embodiments, displaying the first virtual object at a respective location corresponding to the second virtual object based on said perpendicular projection includes displaying the first virtual object at a respective location within a path of said perpendicular projection (e.g., within an angular range of the path of said projection). In some embodiments, the location of the first virtual object when at the respective location corresponding to the second virtual object corresponds to a point at which the perpendicular projection reaches the surface of the second virtual object. Displaying the first virtual object at a respective location corresponding to the second virtual object based on a respective projection that is selected in response to determining that the respective angle of the viewpoint of the user relative to the second virtual object is within a particular range of values provides the user with visual feedback that the computer system is responsive to the viewpoint of the user relative to the second virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, the threshold distance is based on a respective bounding volume associated with the first virtual object, wherein the respective bounding volume is based on one or more dimensions of the first virtual object, such as shown by the various virtual objects in FIG. 7A. For example, minimum and/or maximum height, width, and depth dimensions of the first virtual object. In some embodiments, the bounding volume is a cube, rectangular prism, or other shape that matches the shape of the first virtual object. In some embodiments, when the first virtual object includes an amount of padding, the bounding volume extends beyond the amount of padding of the first virtual object. In some embodiments, the computer system determines whether the respective bounding volume is within a threshold distance of the second virtual object. For example, while moving the first virtual object, the computer system detects that at least a portion of the respective bounding volume associated with the first virtual object reaches a location that is within the threshold distance of the second virtual object and in response to detecting that the at least the portion of the respective bounding volume associated with the first virtual object reaches the location that is within the threshold distance of the second virtual object, the computer system optionally moves the first virtual object to the respective location corresponding to the second virtual object without detecting input for moving the first virtual object to the respective location corresponding to the second virtual object. In some embodiments, in accordance with a determination that the first virtual object is a first size and/or first shape (e.g., spherical, cubic, prismatic, and/or other regular shape), the computer system associates a first bounding volume to the first virtual object. In some embodiments, the first bounding volume has a first size and/or a first shape based on the one or more dimensions of the first virtual object. In some embodiments, in accordance with a determination that the first virtual object is a second size and/or second shape (e.g., irregular polygons) that is different from the first size and/or first shape, the computer system associates a second bounding volume, different from the first bounding volume, to the first virtual object. In some embodiments, the second bounding volume has a second size larger or smaller than the first size of the first bounding volume. In some embodiments, the second shape is a cuboid shape based on the one or more dimensions of the first virtual object. For example, given a first virtual object with a first width and a first height and a third virtual object with the first width and a second height different from the first height (e.g., the second height is larger or smaller than the first height), the computer system associates a different bounding volumes to the first virtual object and the third virtual object (e.g., because the heights of the objects are different). Moving the first virtual object to a particular location corresponding to the second virtual object when the respective bounding volume associated with the first virtual object is within the threshold distance of the second virtual object provides a quick and efficient way of aligning the first virtual object to the second virtual object without requiring the user to provide further inputs to precisely position the first virtual object appropriately with respect to the second virtual object, thereby reducing errors in interacting with virtual objects, which provides a more efficient user-computer system interface, reduces power consumption, and improves battery life of the computer system.

In some embodiments, and in accordance with a determination that the first virtual object is a two-dimensional object, the respective bounding volume has a depth dimension that is independent of a size of the first virtual object, such as virtual objects 706a and 708a in FIG. 7A. In some embodiments, when the first virtual object includes an amount of padding, the bounding volume extends in the depth dimension beyond the amount of padding of the first virtual object. For example, while moving the first virtual object that is a two-dimensional object, the computer system detects that a portion of the depth plane of the respective bounding volume associated with the first virtual object reaches a location that is within the threshold distance of the second virtual object and in response to detecting that a portion of the depth plane of the respective bounding volume associated with the first virtual object reaches the location that is within the threshold distance of the second virtual object, the computer system optionally moves the first virtual object to the respective location corresponding to the second virtual object without detecting input for moving the first virtual object to the respective location corresponding to the second virtual object. In some embodiments, the computer system displays a third virtual object that is a two-dimensional object and is a size different (e.g., smaller or larger) than the first virtual object. In some embodiments, the third virtual object has a bounding volume depth dimension that is the same as the bounding volume depth dimension associated with the first virtual object. Moving the first virtual object to a particular location corresponding to the second virtual object when the respective bounding volume associated with the first virtual object is within the threshold distance of the second virtual object provides a quick and efficient way of aligning the first virtual object to the second virtual object without requiring the user to provide further inputs to precisely position the first virtual object appropriately with respect to the second virtual object, thereby reducing errors in interacting with virtual objects, which provides a more efficient user-computer system interface, reduces power consumption, and improves battery life of the computer system.

In some embodiments, while displaying, via the display generation component, the first virtual object in the three-dimensional environment, the computer system detects, via the one or more input devices, a second input corresponding to a request to move the first virtual object away from the second virtual object (e.g., an input similar to or corresponding to the first input described above), such as input 736B in FIG. 7C.

In some embodiments, in response to detecting the second input, and in accordance with a determination that the first virtual object was within the threshold distance of the second virtual object when the second input was detected, the computer system moves the first virtual object away from the second virtual object by a first distance, such as shown by the third virtual object 726 in FIGS. 7B and 7B1 to FIG. 7C. For example, similar to as described above with reference to the computer system optionally applying a simulated magnetic force to resist moving the first virtual object away from the second virtual object, the computer system optionally resists moving the first virtual object away from the first virtual object. In some embodiments, and as described herein, in response to the second request, the computer system moves the first virtual object while within the threshold distance of the second virtual object by a first distance, different than similar movement performed while the first virtual object is further than the threshold distance from the second virtual object.

In some embodiments, in accordance with a determination that the first virtual object was further than the threshold distance from the second virtual object (and any other virtual object that can contain the first virtual object) when the second input was detected, moving the first virtual object away from the second virtual object by a second distance, greater than the first distance, such as shown by the third virtual object 726 in FIG. 7H to 7I. For example, the computer system optionally applies little to no simulated resistance when the first virtual object is further than the threshold distance from the second virtual object. Resisting movement of the first virtual object away from the second virtual object provides confirmation that the user intends to move the first virtual object away from the second virtual object, thereby reducing errors in interacting with virtual objects (e.g., avoiding unintentional un-snapping of virtual objects due to minor movements) and reducing inputs needed to correct such errors, which provides a more efficient user-computer system interface, reduces power consumption, and improves battery life of the computer system.

In some embodiments, the request to move the first virtual object away from the second virtual object includes movement in a depth direction relative to the second virtual object, such as the direction shown by path 742 in the overhead view 750 in FIG. 7C. For example, the depth direction is optionally a direction perpendicular to the surface of the second virtual object. In some embodiments and as will be described below, the computer system applies varied simulated resistance based on distance and/or direction of the movement of the first virtual object away from the second virtual object. For example, while the first virtual object is within the threshold distance of the second virtual object, the computer system detects the second input includes movement in a depth direction relative to the second virtual object, and in response, the computer system optionally moves the first virtual object away from the second virtual object by the first distance similarly to the first distance described above. In another example, while the first virtual object is within the threshold distance of the second virtual object, the computer system detects the second input includes movement in a direction relative to the second virtual object other than a depth direction, and in response, the computer system optionally moves the first virtual object away from the second virtual object by the second distance, greater than the first distance described above. Resisting movement of the first virtual object away from the second virtual object in response to input movement in a depth direction relative to the second virtual object provides confirmation that the user intends to move the first virtual object away from the second virtual object, thereby reducing errors in interacting with virtual objects (e.g., avoiding unintentional un-snapping of virtual objects due to minor movements) and reducing inputs needed to correct such errors, which provides a more efficient user-computer system interface, reduces power consumption, and improves battery life of the computer system.

In some embodiments, the request to move the first virtual object away from the second virtual object includes movement in a lateral direction (e.g., horizontal or vertical direction) relative to the second virtual object, such as shown by the first virtual object 728 moving laterally from the location in FIG. 7I to the location in FIG. 7J. For example, the lateral direction is optionally a direction parallel to the surface of the second virtual object. For example, while the first virtual object is within the threshold distance of the second virtual object, the computer system detects the second input includes movement in a lateral direction relative to the second virtual object, and in response, the computer system optionally moves the first virtual object away from the second virtual object by a respective distance greater than a distance associated with movement in a direction other than a lateral direction relative to the second virtual object, such as a depth direction described above. Resisting movement of the first virtual object away from the second virtual object in response to input movement in a lateral direction relative to the second virtual object provides confirmation that the user intends to move the first virtual object away from the second virtual object, thereby reducing errors in interacting with virtual objects (e.g., avoiding unintentional un-snapping of virtual objects due to minor movements) and reducing inputs needed to correct such errors, which provides a more efficient user-computer system interface, reduces power consumption, and improves battery life of the computer system.

In some embodiments, in response to detecting the second input and in accordance with the determination that the first virtual object was within the threshold distance of the second virtual object when the second input was detected, such as third virtual object 726 in FIG. 7C.

In some embodiments, in accordance with a determination that the second input corresponds to movement of the first virtual object in a depth direction relative to the second virtual object, the computer system moves the first virtual object away from a respective location corresponding to the second virtual object by a first respective distance, such as shown by the third virtual object 726 in the overhead view 750 moving in a depth direction from the location in FIG. 7C to the location in FIG. 7D For example, the computer system optionally moves the first virtual object away from the respective location corresponding to the second virtual object by the first respective distance similarly to the first distance described above with respect to the request to move the first virtual object away from the second virtual object in a depth direction relative to the second virtual object.

In some embodiments, in response to detecting the second input and in accordance with the determination that the first virtual object was within the threshold distance of the second virtual object when the second input was detected, and in accordance with a determination that the second input corresponds to movement of the first virtual object in a lateral direction relative to the second virtual object, the computer system moves the first virtual object away from the respective location corresponding to the second virtual object by a second respective distance, greater than the first respective distance, such as shown by the first virtual object 728 moving laterally from the location in FIG. 7I to the location in FIG. 7J. For example, the computer system optionally moves the first virtual object away from the respective location corresponding to the second virtual object by the second respective distance similarly to the respective distance described above with respect to the request to move the first virtual object away from the second virtual object in a lateral direction relative to the second virtual object. Responding with varying simulated resistances in response to different movement directions provides the user with visual feedback that the computer system is responsive to the user's input of moving the first virtual object in different movement directions and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, moving the first virtual object away from the second virtual object by the first distance includes moving the first virtual object based on a first simulated spring between the second virtual object and the first virtual object, such as shown by line 742 in the overhead view 750 in FIG. 7D and a second simulated spring between the first virtual object and a location in the three-dimensional environment corresponding to the second input, wherein the location corresponding to the second input changes in accordance with the second input, such as shown by representation 746 in the overhead view 750 in FIG. 7D. For example, the computer system optionally moves the first virtual object based on relative simulated forces applied to the first virtual object by the first simulated spring and the second simulated spring. In some embodiments, the computer system moves the first virtual object away from the second virtual object when the second simulated spring applies a simulated force greater than the simulated force applied by the first simulated spring. In some embodiments, the computer system moves the first virtual object towards the second virtual object when the first simulated spring applies a simulated force greater than the second simulated spring. In some embodiments, the length of the first simulated spring is shorter than the length of the second simulated spring. In some embodiments, moving the first virtual object based on the first simulated spring is different from moving the first virtual object based on the second simulated spring. For example, similar to as described above with reference to the computer system optionally applying a simulated magnetic force to resist moving the first virtual object away from the second virtual object, the computer system optionally resists moving the first virtual object away from the first virtual object. In some embodiments, the first simulated spring between the second virtual object and the first virtual object is associated with a first level of simulated resistance and the second simulated spring between the first virtual object and the location corresponding to the second input is associated with a second level of simulated resistance less than the first level of simulated resistance. For example, similar to applying an amount of force to a spring so that its elastic limit is exceeded, while the first virtual object is within the threshold distance of the second virtual object, and when the computer system detects the second input includes a first amount of movement (corresponding to a simulated force applied to the first virtual object) away from the second virtual object as will be described below, the computer system moves the first virtual object in the three-dimensional environment away from the second virtual object to a location that does not correspond to the second virtual object. In another example, once the first virtual object is further from the threshold distance from the second virtual object, the computer system detects a second amount of movement less than the first amount of movement to move the first virtual object further away from the second virtual object to a location that does not correspond to the second virtual object. Utilizing simulated springs when moving the first virtual object away from the second virtual object provides the user with visual feedback that the computer system is responsive to the user's input of moving the first virtual object in different amounts translated to simulated force and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, in response to detecting the second input, such as input 736A in FIG. 7H, and in accordance with a determination that the second input corresponds to movement of the first virtual object to a location that is less than a second threshold distance (e.g., 0.2, 0.5, 1, 3, 5, 10, 20, 40, 50, 100, 150, or 200 centimeters) away from the second virtual object, the computer system moves the first virtual object to a respective location corresponding to the second virtual object, such as shown by the location of the first virtual object 728 in FIG. 7H to the location of the first virtual object 728 in FIG. 7I. For example, the second input includes a first movement a first distance corresponding to movement of the first virtual object to a location that is less than a second threshold distance away from the second virtual object. In response, to detecting movement of the first virtual object less than the second threshold distance, the computer system optionally presents a first level of simulated resistance to the first movement to the first distance. Accordingly, in some embodiments, the computer system moves the first virtual object a first amount due to the first level of simulated resistance (e.g., the first virtual object is moved to a respective location corresponding to the second virtual object).

In some embodiments, in response to detecting the second input and in accordance with a determination that the second input corresponds to movement of the first virtual object to a location that is greater than the second threshold distance away from the second virtual object, the computer system moves the third virtual object to a respective location in the three-dimensional environment that does not correspond to the second virtual object, such as shown by the location of the first virtual object 728 in FIG. 7J to the location of the first virtual object 728 in FIG. 7K. For example, the second input includes a second movement a second distance, greater than the first distance, corresponding to movement of the first virtual object to a location that is greater than the second threshold distance away from the second virtual object. In response, to detecting movement of the first virtual object greater than the second threshold distance, the computer system optionally presents a second level of simulated resistance, less than the first level of simulated resistance, to the second movement to the second distance. Accordingly, in some embodiments, the computer system moves the first virtual object a second amount, greater than the first amount, due to the second level of simulated resistance (e.g., the first virtual object is moved to a respective location that does not correspond to the second virtual object). In some embodiments, the simulated resistance decreases proportionally based on a distance the first virtual object is moved beyond the second threshold distance. Moving the first virtual object to locations in response to movement with respect to a second threshold distance away from the second virtual object provides the user with visual feedback that the computer system is responsive to the user's input of moving the first virtual object by different distances and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, the second threshold distance is based on a respective bounding volume associated with the first virtual object, wherein the respective bounding volume is based on one or more dimensions of the first virtual object, such as the respective bounding volumes shown by the various virtual objects in FIG. 7A. In some embodiments, the respective bounding associated with the first virtual object has one or more characteristics of the respective bounding volume associated with the first virtual object described above. In some embodiments, the computer system determines whether the first virtual object is greater than the second threshold distance away from the second virtual object (e.g., the bounding volume does not intersect with the second virtual object) and in response, the computer system optionally moves the first virtual object to the respective location that does not correspond to the second virtual object. In some embodiments, the computer system controls the first virtual object with a first bounding volume as described above when the location of the first virtual object does not correspond to the second virtual object. In some embodiments, the computer system controls the first virtual object with a second bounding volume, larger (or smaller) than the first bounding volume, as described above when the location of the first virtual object corresponds to the second virtual object (e.g., the bounding volume scales with the first virtual object when the first virtual object scales when it snaps to the second virtual object). Utilizing a bounding volume of the first virtual object reduces errors in interacting with virtual objects (e.g., avoiding unintentional snapping of virtual objects due to minor movements) and reducing inputs needed to correct such errors, which provides a more efficient user-computer system interface, reduces power consumption, and improves battery life of the computer system.

In some embodiments, in accordance with a determination that the first virtual object is a two-dimensional object, the respective bounding volume associated with the first virtual object has a depth dimension that is independent of a size of the first virtual object, such as two-dimensional virtual objects 706a and 708a and their respective bounding volumes in FIG. 7A. In some embodiments, the respective bounding associated with the first virtual object has one or more characteristics of the respective bounding volume associated with a two-dimensional virtual object described above. For example, while moving the first virtual object that is a two-dimensional object, the computer system detects that a portion of the depth plane of the respective bounding volume associated with the first virtual object is greater than the second threshold distance away from the second virtual object (e.g., the bounding volume does not intersect with the second virtual object) and in response, the computer system optionally moves the first virtual object to the respective location that does not correspond to the second virtual object. In some embodiments, the computer system displays a third virtual object that is a two-dimensional object and is a size different (e.g., smaller or larger) than the first virtual object. In some embodiments, the third virtual object has a bounding volume depth dimension that is the same as the bounding volume depth dimension associated with the first virtual object. Utilizing a bounding volume of the first virtual object reduces errors in interacting with virtual objects (e.g., avoiding unintentional snapping of virtual objects due to minor movements) and reducing inputs needed to correct such errors, which provides a more efficient user-computer system interface, reduces power consumption, and improves battery life of the computer system.

In some embodiments, the second threshold distance, such as the distance of the first virtual object 728 from the second virtual object 718 in FIG. 7I is different from the threshold distance, such as the distance of the first virtual object 728 from the second virtual object 718 in FIG. 7H. In some embodiments, the second threshold distance is less than the threshold distance. In some embodiments, the second threshold distance is greater than the threshold distance. In some embodiments, the second threshold distance is based on a respective bounding volume that is based on one or more dimensions of the first virtual object as described above with respect to the threshold distance that is based on a respective bounding volume associated with the first virtual object. Utilizing different threshold distances when facilitating adding the first virtual object to the second virtual object and/or facilitating removing the first virtual object from the second virtual object provides the user with visual feedback that the computer system is responsive to the user's input of moving the first virtual object and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while receiving the second input and before the second input corresponds to movement of the first virtual object to the location that is greater than the second threshold distance away from the second virtual object, the computer system moves the first virtual object by a first amount (e.g., distance) in accordance with the second input, such as shown by the third virtual object 726 at the location in FIG. 7E to the location in FIG. 7F. For example, the computer system optionally displays an animation of the first virtual object moving away from the second virtual object in the three-dimensional environment. In some embodiments, the first virtual object is moved an amount proportional to a magnitude of the movement of the hand of the user during the first input. In some embodiments, the first virtual object does not yet reach the second threshold distance away from the second virtual object after the first virtual object is moved by the first amount in accordance with the second input. In some embodiments, the computer system moves the first virtual object while the first virtual object has not yet reached the second threshold distance away from the second virtual object by a first amount, different than an amount corresponding to the second input (e.g., an amount the first virtual object would move in response to the same input if the first virtual object were further than the second threshold distance away from the second virtual object), while the first virtual object has not yet reached the second threshold distance away from the second virtual object. Moving virtual objects by a first amount in accordance with the second input provides the user with visual feedback that the computer system is responsive to the user's input of moving the first virtual object and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while receiving the second input and in response to the second input corresponding to movement of the first virtual object to the location that is greater than the second threshold distance away from the second virtual object, the computer system moves the first virtual object with a second amount of velocity, greater than a first amount of velocity, in accordance with the second input, wherein the first virtual object is moved with the first amount of velocity while receiving the second input and before the first virtual object reaches the second threshold distance away from the second virtual object, such as shown by the first virtual object 728 at a location in FIG. 7D to the location in FIG. 7E. In some embodiments, the speed with which the first virtual object is animated as moving in the three-dimensional environment is based on the speed of the second input (e.g., the portion of the user providing the second input), such as being higher if the second input has a higher speed, and lower if the second input has a lower speed. In some embodiments, the speed with which the first virtual object is animated as moving in the three-dimensional environment is higher when moving to the target location (e.g., a location of the three-dimensional environment that does or does not correspond to empty space). For example, the computer system optionally moves the first virtual object at a first speed when the first virtual is less than the second threshold distance away from the second virtual object. In another example, the computer system moves the first virtual object at a second speed, faster than the first speed when the first virtual object is greater than the second threshold distance away from the second virtual object. More generally, the closer the first virtual object is to the second virtual object, the computer system moves the first virtual object at a lower speed, and the further the first virtual object is from the second virtual object, the computer system moves the first virtual object at a. higher speed. Moving virtual objects with higher speeds for movement to target locations provides the user with visual feedback that the computer system is responsive to the user's input of moving the first virtual object to targeted locations and enables the user to quickly position the first virtual object appropriately with respect to targeted locations, thereby reducing errors in interacting with virtual objects, which provides a more efficient user-computer system interface, reduces power consumption, and improves battery life of the computer system.

In some embodiments, while receiving the second input and before the second input corresponds to movement of the first virtual object to the location that is greater than the second threshold distance away from the second virtual object, the computer system changes an orientation of the first virtual object so that it is not oriented based on the second virtual object (and optionally towards being based on the viewpoint of the user), such as the orientation of the third virtual object 726 in FIG. 7G. In some embodiments, the computer system changes the orientation of the first virtual object so that it is oriented in between an orientation of the second virtual object and an orientation that is directed towards the viewpoint of the user of the computer system. In some embodiments, the computer system changes the orientation of the first virtual object so that it is oriented towards the viewpoint of the user of the computer system. Gradually changing the orientation of the first virtual object in response to movement of the first virtual object to the location that is greater than the second threshold distance away from the second virtual object provides the user a visual indication that the first virtual object is changing location in the three-dimensional environment and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while receiving the second input and in response to the second input corresponding to movement of the first virtual object to the location that is greater than the second threshold distance away from the second virtual object, the computer system changes the orientation of the first virtual object with a rate of change towards not being oriented based on the second virtual object (and optionally towards being based on the viewpoint of the user), such as shown in by the orientation of the third virtual object 726 in FIG. 7H to the orientation of the third virtual object 726 in FIG. 7I. In some embodiments, the speed with which the first virtual object is animated as moving away from the second virtual object corresponds with a rate of change towards not being oriented based on the second virtual object (e.g., as the first virtual object moves away from the second virtual object, the orientation of the first virtual object changes towards not being oriented based on the second virtual object at a gradual rate). In some embodiments, the speed with which the first virtual object is animated as moving away from the second virtual object (optionally once the location of the first virtual object is greater than the second threshold distance away from the second virtual object) corresponds with a rate of change towards not being oriented based on the second virtual object (e.g., as the first virtual object moves further away from the second virtual object, the orientation of the first virtual object changes at a faster rate towards not being oriented based on the second virtual object). Changing the orientation of the first virtual object at a rate of change when the location of the first virtual object is greater than the second threshold distance away from the second virtual object provides the user a visual indication that the first virtual object is changing location in the three-dimensional environment and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, moving the first virtual object away from the second virtual object by the first distance in accordance with the second input includes changing an appearance of the first virtual object to indicate that the first virtual object is moving away from the second virtual object, such as changing a size and/or color of the third virtual object 726 as it moves from the location in FIGS. 7B and 7B1 to the location in FIG. 7C. For example, when the first virtual object is displayed at the respective location corresponding to the second virtual object, the computer system optionally displays the first virtual object with a first appearance (e.g., first size, first color, and/or first visual effect). In some embodiments, changing the appearance of the first virtual object to indicate that the first virtual object is moving away from the second virtual object includes displaying the first virtual object with a second appearance, different from the first appearance (e.g., second size less than or greater than the first size). For example, the computer system optionally changes the size of the first virtual object to its original size (or at least partially toward its original size) prior to moving the first virtual object towards the second virtual object. Changing a visual appearance of the first virtual object to indicate movement of the first virtual object away from the second virtual object provides confirmation that the user intends to move the first virtual object away from the second virtual object and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, while moving the first virtual object away from the second virtual object in accordance with the second input, such as input 736A in FIG. 7C, the computer system detects termination of the second input. For example, the computer system optionally detects termination of the second input when the computer system detects an end of the air drag gesture (e.g., a release of the air drag gesture, such as cessation of the movement of the hand of the user and/or detecting the index finger and thumb of the hand no longer touching and/or moving apart).

In some embodiments, in response to detecting the termination of the second input, in accordance with a determination that a current location of the first virtual object is not within the threshold distance of any virtual object that is a container that is able to contain the first virtual object (e.g., empty space), the computer system displays a third virtual object, such as fifth virtual object 756 in FIG. 7C at the current location of the first virtual object, wherein the third virtual object contains the first virtual object at the current location of the first virtual object, such as shown in FIG. 7C with the first virtual object 728 contained within the fifth virtual object 756, and the third virtual object was not displayed in the three-dimensional environment prior to detecting the termination of the second input, such as the first virtual object 728 in FIG. 7D. For example, the third virtual object is optionally a quick look container (e.g., window virtual object) that is optionally temporary, such that movement of the first virtual object to a location that does not correspond to the third virtual object (e.g., to a location corresponding to the second virtual object) causes the computer system to cease to display the third virtual object. In some embodiments, the third virtual object is optionally associated with one or more controls for controlling the placement, display, or other characteristics of the first virtual object. In some embodiments, the third virtual object optionally includes and/or is displayed with one or more selectable controls associated with container virtual objects (optionally similar to or corresponding to controls associated with the second virtual object) to perform operations to resize, move, edit, and/or share the first virtual object with another application. Displaying the first virtual object in a third virtual object when the first virtual object is dropped in empty space within the three-dimensional environment provides confirmation that the user intends to move the first virtual object away from any container virtual objects and enables the user to quickly position the first virtual object appropriately in the three-dimensional environment, thereby reducing errors in interacting with virtual objects, which provides a more efficient user-computer system interface, reduces power consumption, and improves battery life of the computer system.

In some embodiments, the three-dimensional environment further includes a third virtual object, wherein the third virtual object is a container that is able to contain the first virtual object, such as fourth virtual object 720 in FIG. 7L. In some embodiments, the third virtual object has one or more characteristics of the second virtual object described above.

In some embodiments, while moving the first virtual object away from the second virtual object in accordance with the second input, in accordance with a determination that the first virtual object is within the threshold distance of the third virtual object, the computer system displays the first virtual object at a respective location corresponding to the third virtual object, including displaying the first virtual object with an orientation in the three-dimensional environment that is based on an orientation of the third virtual object, such as the first virtual object 728 in FIG. 7M. For example the computer system optionally displays the first virtual object with an orientation in the three-dimensional environment that is based on an orientation of the third virtual object as described above with reference to method(s) 800. In some embodiments, in response to moving the first virtual object away from the second virtual object, the computer system changes the location of the first virtual object from corresponding to the second virtual object to correspond to the third virtual object; and the computer system changes the display of the first virtual object with an orientation based on an orientation of the second virtual object towards having an orientation that is based on the orientation of the third virtual object. In some embodiments, while moving the first virtual object away from the second virtual object towards the third virtual object, the computer system displays the first virtual object with an orientation that is based on the viewpoint of the user of the computer system as described above with reference to moving the first virtual object to a location in the three-dimensional environment that is further than the threshold distance from the respective location of the respective virtual object (e.g., the second virtual object and/or the third virtual object). In some embodiments, while moving the first virtual object away from the second virtual object in accordance with the second input, in accordance with a determination that the first virtual object is greater than the threshold distance of the third virtual object, displaying the first virtual object at a location that does not correspond to the third virtual object, including displaying the first virtual object with an orientation in the three-dimensional environment that is independent of (e.g., not based on) an orientation of the third virtual object, such as described above with reference to method(s) 800. Moving the first virtual object to a particular location corresponding to the third virtual object when the first virtual object is within the threshold distance of the third virtual object provides a quick and efficient way of aligning the first virtual object to the third virtual object without requiring the user to provide further inputs to precisely position the first virtual object appropriately with respect to the third virtual object, thereby reducing errors in interacting with virtual objects, which provides a more efficient user-computer system interface, reduces power consumption, and improves battery life of the computer system.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIG. 9 is a flowchart illustrating an exemplary method of utilizing different movement algorithms for moving objects in a three-dimensional environment in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system (e.g., 101) in communication with a display generation component (e.g., 120) and one or more input devices (e.g., 314). In some embodiments, the computer system, the display generation component, and the one or more input devices have one or more characteristics described with reference to method(s) 800.

In some embodiments, the computer system displays (902a), via the display generation component, a first virtual object at a first location and a second virtual object at a second location, different from the first location, in a three-dimensional environment, wherein the second virtual object is a container that is able to contain the first virtual object, such as virtual object 726 and virtual object 720 in the three-dimensional environment 748 in FIGS. 7B and 7B1. In some embodiments, the first virtual object, the second virtual object, and the three-dimensional environment have one or more of the characteristics described with reference to method(s) 800. In some embodiments, the first location is within a threshold distance of the second virtual object (e.g., such as described with reference to method(s) 800).

In some embodiments, while displaying, via the display generation component, the first virtual object at the first location and the second virtual object at the second location, the computer system detects (902b), via the one or more input devices, a first input corresponding to a request to move the first virtual object away from the first location in the three-dimensional environment, wherein the first input includes a movement component, such as input 736B in FIGS. 7B and 7B1. In some embodiments, detecting the first input corresponding to the request to move the first virtual object away from the first location in the three-dimensional environment has one or more characteristics of the first input that corresponds to the request to move the first virtual object away from the first location in the three-dimensional environment described with reference to method(s) 800. For example, the computer system optionally detects movement of a portion of the user, such as movement of the hand of the user in space while the hand is holding the pinch hand shape (e.g., the tips of the thumb and index finger remain touching) such as an air drag gesture. In some embodiments, movement of the first input includes a movement component, such as a vertical movement component (e.g., of the hand and/or corresponding to the movement of the hand), a horizontal movement component (e.g., of the hand and/or corresponding to the movement of the hand), and/or a diagonal movement component (e.g., of the hand and/or corresponding to the movement of the hand) that correspond to movement away from the first location in the three-dimensional environment.

In some embodiments, in response to (and/or while) detecting the first input, moving the first virtual object in the three-dimensional environment in accordance with the first input, including (902c): in accordance with a determination that a viewpoint of a user of the computer system has a first orientation relative to the second virtual object, the computer system moves (902d) the first virtual object with first movement that is based on the movement component of the first input (e.g., determined according to a first translation between the movement component of the first input and the movement of the first virtual object), such as moving object 728 from a location in FIG. 7I to the location in FIG. 7E. In some embodiments, the first orientation corresponds to an angle between the orientation of the viewpoint of the user and a first vector optionally extending from a front surface of the second virtual object. In some embodiments, the front surface of the second virtual object is the surface of the second virtual object that is configured to contain and/or accept the first virtual object into the second virtual object when the first virtual object moves within a threshold distance of the front surface of the second virtual object (e.g., as described with reference to method(s) 800). In some embodiments, in accordance with the determination that the viewpoint of the user of the computer system has the first orientation relative to the second virtual object, moving the first virtual object according to the first translation between the movement component of the first input and the movement of the first virtual object includes the computer system translating movement of the hand of the user into the movement of the first virtual object, which is described later with reference to method(s) 800, according to a first set of one or more rules (e.g., a certain amount of movement of the hand of the user in a certain direction results in a certain amount of movement of the first virtual object in a certain direction).

In some embodiments, in accordance with a determination that the viewpoint of the user of the computer system has a second orientation relative to the second virtual object, different from the first orientation, the computer system moves (902e) the first virtual object with second movement that is based on the movement component of the first input (e.g., determined according to a second translation between the movement component of the first input and the movement of the first virtual object), wherein the second movement is different from the first movement (e.g., at least in part because the second translation is different from the first translation), such as moving object 726 from a location in FIGS. 7B and 7B1 to the location in FIG. 7G. In some embodiments, the second orientation corresponds to an angle (e.g., between 60 to 80 degrees) greater than the first orientation (e.g., between 5 to 20 degrees from perpendicular to the front surface of the second virtual object). In some embodiments, an amount and/or manner in which the first virtual object is moved is based on a second translation, different from the first translation, which translates movement of the hand of the user into the movement of the first virtual object, example details of which will be described later with reference to method(s) 800, according to a second set of one or more rules, different from the first set of one or more rules (e.g., a certain amount of movement of the hand of the user in a certain direction results in a certain amount of movement of the first virtual object in a certain direction). In some embodiments, the translation of hand movement to object movement in the first and second translations is different. Thus, the computer system optionally moves the first virtual object based on different translations in accordance with the orientation of the viewpoint user of the computer system relative to the second virtual object. Using different translations to control movement of virtual objects in three-dimensional environments for different orientations of the viewpoint of the user of the computer system relative to the second virtual object allows the device to utilize translation algorithms that are better suited for the movement of virtual objects to facilitate improved location control for objects in the three-dimensional environment, thereby reducing errors in usage, which provides a more efficient user-computer system interface, reduces power consumption, and improves battery life of the computer system.

In some embodiments, the first movement has a first magnitude, corresponding to a first relationship to the movement component of the first input, such as can be been seen with moving object 728 from a location in FIG. 7I to the location in FIG. 7E, and the second movement has a second magnitude, different from the first magnitude, corresponding to a second relationship to the movement component of the first input, wherein the first relationship is different from the second relationship, such as can be seen with moving object 726 from a location in FIGS. 7B and 7B1 to the location in FIG. 7G. In some embodiments, the first magnitude (e.g., distance that the first virtual object moves in the three-dimensional environment) is greater than the second magnitude. In some embodiments, the first magnitude is less than the second magnitude. In some embodiments, there is a one-to-one relationship between the movement component of the first input (e.g., movement of the user's hand, for example) and movement of the first virtual object such that they occur substantially simultaneously. In some embodiments, the computer system changes from the one-to-one relationship between the movement component of the first input and movement of the first virtual object to a first relationship between the movement component of the first input and movement of the first virtual object resulting in moving the first virtual object a first respective amount in accordance with the first input. In some embodiments, the computer system changes from the one-to-one relationship between the movement component of the first input and movement of the first virtual object to a second relationship between the movement component of the first input and movement of the first virtual object resulting in moving the first virtual object a second respective amount in accordance with the first input, less than the first respective amount. Using different movement magnitudes corresponding to respective relationships between the movement component of the first input and movement of the first virtual object to control movement of the first virtual object in three-dimensional environments for different orientations of the viewpoint of the user of the computer system relative to the second virtual object allows the device to utilize relationships that are better suited for the movement of virtual objects to facilitate improved location control for objects in the three-dimensional environment, thereby reducing errors in usage, which provides a more efficient user-computer system interface, reduces power consumption, and improves battery life of the computer system.

In some embodiments, the first movement has a first direction, corresponding to a first relationship to the movement component of the first input, such as can be been seen with the direction of moving object 728 from a location in FIG. 7I to the location in FIG. 7E, and the second movement has a second direction, different from the first direction, corresponding to a second relationship to the movement component of the first input, wherein the first relationship is different from the second relationship, such as can be seen with the direction moving object 726 from a location in FIGS. 7B and 7B1 to the location in FIG. 7G. For example, the first direction is optionally a direction parallel to the front surface of the second virtual object while the second direction is optionally a direction perpendicular to the front surface of the second virtual object. In some embodiments, the direction of the movement of the first virtual object corresponds to the direction of the movement component of the first input. In some embodiments, the computer system applies a first relationship between the movement component of the first input and movement of the first virtual object resulting in moving the first virtual object a first direction parallel to the front surface of the second virtual object in accordance with the first input. In some embodiments, the computer system applies a second relationship between the movement component of the first input and movement of the first virtual object resulting in moving the first virtual object a second direction perpendicular to the front surface of the second virtual object in accordance with the first input. For example, for a direction of hand movement, the computer system optionally moves the first virtual object in one or more directions different from the direction of the hand movement based on whether the first relationship or the second relationship is being applied to object movement. Using different movement directions corresponding to respective relationships between the movement component of the first input and movement of the first virtual object to control movement of the first virtual object in three-dimensional environments for different orientations of the viewpoint of the user of the computer system relative to the second virtual object allows the device to utilize relationships that are better suited for the movement of virtual objects to facilitate improved location control for objects in the three-dimensional environment, thereby reducing errors in usage, which provides a more efficient user-computer system interface, reduces power consumption, and improves battery life of the computer system. In some embodiments, the first location is within a threshold distance (e.g., 0.1, 0.5, 1, 5, 10, 50, 100, 200, 300, 400, 500, 600, 700, 800, 900, or 1000 centimeters) of the second virtual object, such as virtual object 726 with the threshold distance of virtual object 720 in FIG. 7F.

In some embodiments, while the first virtual object is at a third location, further than the threshold distance from any virtual object that is configured to contain the first virtual object, the computer system detects, via the one or more input devices, a second input (e.g., an input similar to or corresponding to the first input described above) corresponding to a request to move the first virtual object away from the third location in the three-dimensional environment, wherein during the movement the first virtual object remains further than the threshold distance from any virtual object that is configured to contain the first virtual object, such as can be seen with moving virtual object 726 from a location in FIG. 7I to the location in FIG. 7L that is further than the threshold distance from virtual objects 718 and 720.

In some embodiments, in response to detecting the second input, the computer system moves the first virtual object in the three-dimensional environment along a curved path, such as can be seen with moving virtual object 726 from a location in FIG. 7I to the location in FIG. 7L. In some embodiments, the computer system moves the first virtual object along the curved path relative to the viewpoint of the user. In some embodiments, the curved path that is designated by the computer system lies in the user's field of view of the three-dimensional environment. In some embodiments, the computer system detects an end of the second input (e.g., a release of the air drag gesture). For example, the computer system optionally detects the end of the second input when the computer system detects an end of an air drag gesture (e.g., a release of the air drag gesture, such as cessation of the movement of the hand of the user and/or detecting the index finger and thumb of the hand no longer touching and/or moving apart) and/or a predefined movement of the hand to a resting state position (e.g., at the user's side and/or out of the user's field of view). In some embodiments, in response to detecting the end of the second input, the computer system ceases moving the first virtual object along a curved path, even if the computer system detects continued movement of the hand in space corresponding to moving the first virtual object. Moving the first virtual object along a curved path in response to detecting movement of the first virtual object produced by a second input provides feedback to the user that the first virtual object is moving in the three-dimensional environment and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, moving the first virtual object with first movement that is based on the movement component of the first input includes moving the first virtual object to a location within the second virtual object, wherein the location within the second virtual object is selected based on a continued projection, to the second virtual object, of a line from a viewpoint of a user of the computer system through a control location in the three-dimensional environment, wherein the control location moves in accordance with the movement component of the first input, such as the continued projection shown in FIG. 7E with dotted line 744, control location 740, and virtual objects 728 and 718 as shown in the overhead view 752. For example, the projection is a line between a first point corresponding to a location of the viewpoint of the user and a second point corresponding to a location of the first virtual object relative to the second virtual object when the first virtual object reaches the threshold distance from the second virtual object. In some embodiments, the projection extends to a third point corresponding to a location of a respective face (e.g., front-facing surface) on which content associated with the second virtual object is displayed. In some embodiments, the projection continues from the viewpoint of the user through a location of the first virtual object when the computer system determines that the first virtual object reaches the threshold distance from the second virtual object, and onto the surface of the second virtual object. In some embodiments, the control location is a location in the three-dimensional environment corresponding to the first input. In some embodiments, the location corresponding to the first input changes in accordance with the first input. For example, the control location optionally moves in a direction and/or with magnitude corresponding to a direction and/or magnitude of the movement of the first input even if the computer system does not move the first virtual object in a direction and/or with magnitude corresponding to a direction and/or magnitude of the movement of the first input because the computer system moves the first virtual object according to a first translation, second translation, or other translation as described herein and in method(s) 800 . . . . Identifying a projection at which to snap the first virtual object to the second virtual object based on a line, to the second virtual object, and between a viewpoint of the user and the location of the first virtual object relative to the second virtual object when the first virtual object reaches the threshold distance from the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, moving the first virtual object with second movement that is based on the movement component of the first input includes moving the first virtual object to a location within the second virtual object (or within a threshold distance of the second virtual object, or within a region corresponding to the second virtual object), wherein the location within the second virtual object is selected based on a perpendicular projection, to the second virtual object, from a control location in the three-dimensional environment, wherein the control location moves in accordance with the movement component of the first input, such as the perpendicular projection shown in FIG. 7E with dotted lines 742 and 744, control location 740, and virtual objects 726 and 720 as shown in the overhead view 750. For example, the projection is based on an intersection of a first point corresponding to the location of the first virtual object relative to the second virtual object when it reaches the threshold distance from the second virtual object and a line orthogonal to a respective face (e.g., front-facing surface) on which content associated with the second virtual object is displayed. In some embodiments, the control location as described above corresponds to the first input. For example, the control location optionally moves in a direction and/or with magnitude corresponding to a direction and/or magnitude of the movement of the first input even if the computer system does not move the first virtual object in a direction and/or with magnitude corresponding to a direction and/or magnitude of the movement of the first input because the computer system moves the first virtual object according to a first translation, second translation, or other translation as described herein and in method(s) 800. In some embodiments, when the first virtual object is moved to the location within the second virtual object, the first virtual object is manipulated in a same manner as the second virtual object is manipulated. For example, when the computer system moves and/or resizes the second virtual object (optionally in response to an input similar to or corresponding to the first input described above), the first virtual object is moved and/or resized along with the second virtual object. In another example, when the computer system closes or ceases to display the second virtual object (optionally in response to an input similar to or corresponding to the first input described above), the computer system ceases to display the first virtual object along with the second virtual object. Identifying a projection at which to snap the first virtual object to the second virtual object based on a perpendicular projection from a surface of the second virtual object to the location of the first virtual object relative to the second virtual object when it reaches the threshold distance from the second virtual object provides the user with visual feedback that the computer system is responsive to the user's input of moving the first virtual object and enables the user to quickly position the first virtual object appropriately with respect to the second virtual object, thereby facilitating adding the first virtual object to the second virtual object and reducing errors in interacting with virtual objects, which provides a more efficient user-computer system interface, reduces power consumption, and improves battery life of the computer system.

In some embodiments, the first orientation relative to the second virtual object is less than a first orientation threshold (e.g., 5, 10, 15, 20, 30, 40, or 50 degrees), and the second orientation relative to the second virtual object is greater than a second orientation threshold (e.g., 30, 40, 50, 60, 70, or 80 degrees), greater that the first orientation threshold. In some embodiments, moving the first virtual object in the three-dimensional environment in accordance with the first input includes, and in accordance with a determination that the viewpoint of the user of the computer system has an orientation (e.g., 2, 5, 10, 15, or 20 degrees) relative to the second virtual object that is less than the first orientation threshold, such as shown by the viewpoint of the user 730 relative to virtual object 718, moving the first virtual object according to a first translation between the movement component of the first input and the movement of the first virtual object. For example, moving the first virtual object to a location within the second virtual object, wherein the location within the second virtual object is selected based on a continued projection similar to or corresponding to the continued projection described above.

In some embodiments, moving the first virtual object in the three-dimensional environment in accordance with the first input includes, in accordance with a determination that the viewpoint of the user of the computer system has an orientation relative to the second virtual object that is greater than the second orientation threshold, such as shown by the viewpoint of the user 730 relative to virtual object 720, moving the first virtual object according to a second translation between the movement component of the first input and the movement of the first virtual object, wherein the second translation is different from the first translation. For example, moving the first virtual object to a location within the second virtual object, wherein the location within the second virtual object is selected based on a perpendicular projection similar to or corresponding to the continued projection described above. Using different translations to control movement of virtual objects in three-dimensional environments for different orientations of the viewpoint of the user of the computer system relative to the second virtual object allows the device to utilize translation algorithms that are better suited for the movement of virtual objects to facilitate improved location control for objects in the three-dimensional environment, thereby reducing errors in usage, which provides a more efficient user-computer system interface, reduces power consumption, and improves battery life of the computer system.

In some embodiments, in accordance with a determination that the viewpoint of the user of the computer system has an orientation relative to the second virtual object that is between the first orientation threshold (e.g., 5, 10, 15, 20, 30, 40, or 50 degrees) and the second orientation threshold (e.g., 30, 40, 50, 60, 70, or 80 degrees), moving the first virtual object in the three-dimensional environment in accordance with the first input includes moving the first virtual object according to a third translation between the movement component of the first input and the movement of the first virtual object, wherein the third translation is different from the second translation and the first translation, wherein the third translation is based on the first translation and the second translation, such as a translation that is based on the continued projection shown in FIG. 7E with dotted line 744, control location 740, and virtual objects 728 and 718 as shown in the overhead view 752; and the perpendicular projection shown in FIG. 7E with dotted lines 742 and 744, control location 740, and virtual objects 726 and 720 as shown in the overhead view 750. For example, the third translation includes moving the first virtual object to a location within the second virtual object, wherein the location within the second virtual object is selected based on a continued projection and a perpendicular projection similar to or corresponding to the respective projections described above. Using a third translation to control movement of virtual objects in three-dimensional environments for different orientations of the viewpoint of the user of the computer system relative to the second virtual object allows the device to utilize translation algorithms that are better suited for the movement of virtual objects to facilitate improved location control for objects in the three-dimensional environment, thereby reducing errors in usage, which provides a more efficient user-computer system interface, reduces power consumption, and improves battery life of the computer system.

In some embodiments, the third translation is an (optionally linear, quadratic, or other) interpolation between the first translation and the second translation based on a relationship of the orientation of the viewpoint of the user relative to the first orientation threshold and the second orientation threshold, such as an interpolation between the continued projection shown in FIG. 7E with dotted line 744, control location 740, and virtual objects 728 and 718 as shown in the overhead view 752; and the perpendicular projection shown in FIG. 7E with dotted lines 742 and 744, control location 740, and virtual objects 726 and 720 as shown in the overhead view 750. For example, the third translation includes moving the first virtual object based on smoothed movement of the continued projection and a perpendicular projection described above. For example, when the computer system detects that the viewpoint of the user of the computer system is closer to an orientation relative to the second virtual object that is less than the first orientation threshold, the computer system optionally moves the first virtual object to the location within the second virtual object closer to a continued projection placement described above, and when the computer system detects that the viewpoint of the user of the computer system is closer to an orientation relative to the second virtual object that is greater than the second orientation threshold, the computer system optionally moves the first virtual object to the location within the second virtual object closer to a perpendicular projection placement described above. In another example, when the computer system detects that the viewpoint of the user of the computer system is between the first orientation threshold and the second orientation threshold, the computer system optionally moves the first virtual object to a location that is based on a relative closeness between the orientation of the viewpoint of the user and the first orientation threshold and the second orientation threshold (e.g., an interpolation between the location associated with the continued projection placement and the location associated with the perpendicular projection placement). Using a third translation that is an interpolation between the first translation and the second translation to control movement of virtual objects in three-dimensional environments for different orientations of the viewpoint of the user of the computer system relative to the second virtual object allows the device to utilize translation algorithms that are better suited for the movement of virtual objects to facilitate improved location control for objects in the three-dimensional environment, thereby reducing errors in usage, which provides a more efficient user-computer system interface, reduces power consumption, and improves battery life of the computer system.

In some embodiments, while displaying, via the display generation component, the first virtual object, the computer system detects, via the one or more input devices, a second input corresponding to a request to move the first virtual object through the second virtual object (e.g., an input similar to or corresponding to the first input described above), such as input 736A in FIG. 7N.

In some embodiments, in response to receiving the second input, the computer system displays the first virtual object at a location of the second virtual object without moving the first virtual object through the second virtual object, such as virtual object 728 maintaining its location in FIG. 7N. For example, the computer system optionally applies a simulated resistance such that the first virtual object resists movement through the second virtual object when it reaches with the surface of the second virtual object, even if the computer system detects further second input corresponding moving the first virtual object through the surface of the second virtual object. Stopping first virtual object from moving through the second virtual object once it reaches the surface of the second virtual object provides feedback to the user that the first virtual object is no longer moving in the three-dimensional environment, thereby improving the user-device interaction.

In some embodiments, while displaying, via the display generation component, the first virtual object within a threshold distance (e.g., a threshold distance similar to or corresponding to the threshold distance described above) of the second virtual object, wherein the first virtual object is displayed adjacent (e.g., above, below, in front of, or to the side of the second virtual object) to a surface of the second virtual object, the computer system detects, via the one or more input devices, a second input (e.g., a second input similar to or corresponding to the first input described above) corresponding to a request to move the first virtual object away from the second virtual object, such as input 736A in FIG. 7J.

In some embodiments, in response to receiving the second input, and in accordance with a determination that the second input corresponds to a request to move the first virtual object in a first direction parallel to the surface of the second virtual object, the computer system moves the first virtual object a first distance in the first direction to a location in the three-dimensional that is further than the threshold distance from the second virtual object, such as moving virtual object 720 from a location in FIG. 7I to a location in FIG. 7J. For example, while the first virtual object is within the threshold distance of the second virtual object, the computer system detects the second input includes movement in a lateral direction that is parallel to the surface of the second virtual object, and in response, the computer system optionally moves the first virtual object away from the second virtual object by the first distance to a location that is further than the threshold distance from the second virtual object. In some embodiments, the first distance corresponds to an amount of movement of the hand of the user while providing the second input. Moving the first virtual object that is adjacent to the second virtual object to a location further than the threshold display from the second virtual object in response to user input provides the user with visual feedback that the computer system is responsive to the user's input of moving the first virtual object and enables the user to quickly position the first virtual object appropriately with respect to the second virtual object, thereby reducing errors in interacting with virtual objects, which provides a more efficient user-computer system interface, reduces power consumption, and improves battery life of the computer system.

In some embodiments, in response to receiving the second input, such as input 736A in FIG. 7J, and in accordance with a determination that the second input corresponds to a request to move the first virtual object in a second direction perpendicular to the surface of the second virtual object, the computer system moves the first virtual object a second distance, less than the first distance, in the second direction to a location in the three-dimensional that is further than the threshold distance from the second virtual object, such as shown with virtual object 726 moving from the location in FIGS. 7B and 7B1 to the location in FIG. 7C. In some embodiments, the computer system applies varied simulated resistance based on distance and/or direction of the movement of the first virtual object away from the second virtual object. For example, while the first virtual object is within the threshold distance of the second virtual object, the computer system detects the second input includes movement in a depth direction relative to the second virtual object, and in response, the computer system optionally moves the first virtual object away from the second virtual object by the second distance, less than the first distance. Thus, in some embodiments, when the computer system detects a same magnitude of hand movement, the computer system moves the first virtual object less when moving away from the surface of the second virtual object perpendicularly then when moving away from the surface of the second virtual object laterally, such that it appears to the user that it is easier to move the object laterally away from the second virtual object, than perpendicularly away from the second virtual object. Resisting movement of the first virtual object away from the second virtual object in response to a direction perpendicular to the surface of the second virtual object provides confirmation that the user intends to move the first virtual object away from the second virtual object, thereby reducing errors in interacting with virtual objects (e.g., avoiding unintentional un-snapping of virtual objects due to minor movements) and reducing inputs needed to correct such errors, which provides a more efficient user-computer system interface, reduces power consumption, and improves battery life of the computer system.

In some embodiments, while moving the first virtual object in the three-dimensional environment in accordance with a second input, the computer system detects a termination of the second input when the first virtual object is at a respective location in the three-dimensional environment, such as input 736A in FIG. 7C. For example, the computer system optionally detects termination of the second input when the computer system detects an end of the air drag gesture (e.g., a release of the air drag gesture, such as cessation of the movement of the hand of the user and/or detecting the index finger and thumb of the hand no longer touching and/or moving apart). For example, the respective location corresponds to the second virtual object (e.g., a snap location).

In some embodiments, in response to detecting the termination of the second input, and in accordance with a determination that the respective location is within a threshold distance (e.g., a threshold distance similar to or corresponding to the threshold distance as described with reference to method(s) 800) of the second virtual object, the computer system displays the first virtual object as contained within the second virtual object, such as virtual object 728 contained by virtual object 718 in FIG. 7I. In some embodiments, when the computer system determines that the first virtual object reaches a location that is within the threshold distance of the second virtual object, the computer system performs a “snapping” operation to snap the first virtual object to the second virtual object such that the first virtual object is visually contained within the second virtual object as described with reference to method(s) 800. In some embodiments, moving the first virtual object to the respective location corresponding to the second virtual object is performed without requiring input from the user to precisely position the first virtual object to align with the second virtual object. In some embodiments, when the first virtual object is moved to the respective location corresponding to the second virtual object, the computer system outputs visual, audio and/or haptic feedback indicating that the first virtual object is added to the second virtual object.

In some embodiments, in accordance with a determination that the respective location is further than the threshold distance of the second virtual object (and optionally any virtual object that can be a container for the first virtual object), the computer system displays the first virtual object as contained within a third virtual object, different from the second virtual object, such as virtual object 728 contained by virtual object 756 in FIG. 7C, wherein the third virtual object was not displayed in the three-dimensional environment when the termination of the second input was detected. In some embodiments, the computer system determines that the respective location of the first virtual object is not within the threshold distance of any virtual object that is a container that is able to contain the first virtual object as described with reference to method(s) 800. In some embodiments, the computer system displays the first virtual object as described with reference to method(s) 800 when the first virtual object is further than the threshold distance from any virtual object that can be a container for the first virtual object. For example, the third virtual object is optionally a quick look container (e.g., window virtual object) that is optionally temporary, such that movement of the first virtual object to a location that does not correspond to the third virtual object (e.g., to a location corresponding to the second virtual object) causes the computer system to cease to display the third virtual object. In some embodiments, the third virtual object is optionally associated with one or more controls for controlling the placement, display, or other characteristics of the first virtual object. Displaying the first virtual object in a third virtual object when the first virtual object is further than the threshold distance of the second virtual object within the three-dimensional environment provides confirmation that the user intends to move the first virtual object away from any container virtual objects and enables the user to quickly position the first virtual object appropriately in the three-dimensional environment, thereby reducing errors in interacting with virtual objects, which provides a more efficient user-computer system interface, reduces power consumption, and improves battery life of the computer system.

In some embodiments, in response to detecting the termination of the second input, and in accordance with a determination that the respective location is within the threshold distance of a fourth virtual object, different from the second virtual object and the third virtual object, the computer system displays the first virtual object as contained within the fourth virtual object, as virtual object 728 contained by virtual object 756 in FIG. 7C. In some embodiments, the fourth virtual object is at a respective location, different from the respective location of the second virtual object and the respective location of the third virtual object, in the three-dimensional environment, wherein the fourth virtual object is a container virtual object that is able to contain the first virtual object. In some embodiments, the orientation of the fourth virtual object is the same as or different from the orientation of the second virtual object. In some embodiments, the third virtual object is associated with the same or different application than the application associated with the second virtual object and the third virtual object. In some embodiments, in response to moving the first virtual to the respective location that is within the threshold distance of the fourth virtual object, the computer system further displays the first virtual object with an orientation based on an orientation of the fourth virtual object. In some embodiments, displaying the first virtual object as contained within the fourth virtual object includes displaying the first virtual object with an orientation that is based on the fourth virtual object. Accordingly, the computer system displays the first virtual object at a respective location corresponding to the fourth virtual object similar to as described in method(s) 800. In some embodiments, in response to detecting the termination of the second input, and in accordance with a determination that the respective location is greater than the threshold distance of the fourth virtual object, the computer system displays the first virtual object in a location that does not correspond to the fourth virtual object. In some embodiments, the computer system displays the first virtual object at the location that does not correspond to the fourth location with an orientation independent of (e.g., not based on) an orientation of the fourth virtual object, such as described with reference to method(s) 800. Moving the first virtual object to a particular location corresponding to the fourth virtual object when the first virtual object is within the threshold distance of the fourth virtual object provides a quick and efficient way of aligning the first virtual object to the fourth virtual object without requiring the user to provide further inputs to precisely position the first virtual object appropriately with respect to the fourth virtual object, thereby reducing errors in interacting with virtual objects, which provides a more efficient user-computer system interface, reduces power consumption, and improves battery life of the computer system.

In some embodiments, in response to detecting the first input, such as movement of hand 716 in FIG. 7P, and in accordance with the determination that the first input corresponds to movement of the first virtual object to the third location that is within the threshold distance of the second location of the second virtual object, such as the distance between virtual object 712 and virtual object 760 in FIG. 7Q, the computer system displays, via the display generation component, a virtual shadow of the first virtual object (optionally overlaid on and/or on the surface of the second virtual object), such as virtual shadow 770 in FIG. 7Q. In some embodiments, when the first virtual object is moved within the threshold distance of the second location and/or the second virtual object, the computer system displays a virtual shadow of the first virtual object as though light was cast onto the first virtual object. For example, the computer system optionally displays a virtual shadow, similar to as if a physical light source were illuminating a physical equivalent of the first virtual object and casting a physical shadow onto a physical equivalent of the second virtual object. In some embodiments, a position of a simulated light source-simulating the physical light source—is positioned at one or more positions and/or orientations relative to the first virtual object and the second virtual object, such as along a normal extending from a front surface of the first virtual object, elevated above the first and/or second virtual object, and/or at another suitable position and/or orientation relative to the virtual objects.

In some embodiments, the computer system initiates display of the virtual shadow, such as virtual shadow 770 in FIG. 7Q, in accordance with the determination that the first virtual object is moved, will soon move (e.g., while the first virtual object is selected), or recently moved to the third location. For example, the computer system optionally displays the virtual shadow as soon as the first virtual object is moved to the third location, after a first threshold period of time has elapsed from moving to the third location (e.g., 0.01, 0.05, 0.1, 0.2, 0.3, 0.4, 0.5, 0.75, 1, 1.5, or 2 seconds), and/or preemptively, in accordance with a determination that a simulated momentum of the first virtual object will move the first virtual object to the third location within a threshold period of time, similar to or the same as the first threshold period of time. In some embodiments, in accordance with a determination that the movement of the first virtual object to the third location is not within the threshold distance of the second location of the second virtual object, the computer system forgoes displaying of the virtual shadow of the first virtual object. Thus, the virtual shadow provides visual feedback indicating that the first virtual object is able to and/or will snap to the second virtual object, as described further herein.

In some embodiments, the virtual shadow is displayed with a color, saturation, level of opacity, blurring effect, and/or some combination of one or more of such visual properties, such as illustrated in FIG. 7Q. In some embodiments, the visual properties of the virtual shadow are uniform across one or more dimensions of the virtual shadow. In some embodiments, the visual properties are different across one or more dimensions of the virtual shadow. For example, a level of opacity of the virtual shadow at portions of the virtual shadow nearest to a visual boundary of the first virtual object at the third location, and/or relative to the user's viewpoint, is optionally different from (e.g., greater or lesser than) portions of the virtual shadow furthest from the visual boundary. Thus, the virtual shadow is optionally relatively more opaque close to the visual boundary of the first virtual object, and/or optionally gradually decreases in opacity further from the visual boundary. It is understood that additional or alternative values of additional or alternative visual properties optionally are uniform, or non-uniform, across one or more dimensions of the three-dimensional environment.

In some embodiments, the virtual shadow, such as virtual shadow 770 in FIG. 7Q, is generated based upon a position of one or more simulated light sources. The one or more light sources optionally have different respective positions and/or orientations relative to the first virtual object, such as a plurality of simulated light sources located at a same depth relative to the first virtual object, but different orientations. Accordingly, a spatial profile of the virtual shadow is optionally based upon the positions and/or orientations of a combination of some or all of the one or more light sources, similar to as though a combination of physical light sources were pointed toward the first virtual object. Displaying a virtual shadow indicates the distance between the first virtual object and the second virtual object, thus reducing the likelihood that the first virtual object will be, or might possibly be added to the second virtual object erroneously, thus reducing user input required to correct for such erroneous operations and thereby reducing computational load.

In some embodiments, displaying the virtual shadow of the first virtual object includes, in accordance with a determination that the third location is a first distance away from the second location, such as a distance between virtual object 712 and virtual object 760 in FIG. 7Q, displaying the virtual shadow of the first virtual object with a first visual property having a first value, such as a first value of a visual property of virtual shadow 770 in FIG. 7Q, and/or in accordance with a determination that the third location is a second distance away from the second location, different from the first distance, such as a distance between virtual object 712 and virtual object 760 in FIG. 7R, displaying virtual shadow of the first virtual object with the first visual property having a second value, different from the first value, such as the second value of the visual property of virtual shadow 770 in FIG. 7R. In some embodiments, one or more visual properties of the virtual shadow are modified in accordance with a spatial relationship between the third location of the first virtual object and the second location of the second virtual object. For example, the virtual shadow optionally scales upward or downward in one or more dimensions-optionally concurrently—in response to movement of the first virtual object closer to the second virtual object (e.g., while the first virtual object is within the threshold distance of the second virtual object). Thus, in accordance with the determination that a distance between the third location and the second location is a first distance, the virtual shadow is optionally displayed with a virtual shadow having a first visual property that has a first value. In accordance with the determination that the distance is a second distance, the virtual shadow is optionally displayed with the first visual property having a second value. In some embodiments, the virtual shadow scales downward or upward in one or more dimensions in response to movement of the first virtual object moving away from the second virtual object (e.g., and/or while the first virtual object is within the threshold distance of the second virtual object). Thus, the scaling of the virtual shadow is optionally proportional, inversely proportional, and/or otherwise increases or decreases in accordance with increases or decreases of the distance between the first virtual object and the second virtual object (e.g., between the second location and the third location), thus changing values of visual properties of the virtual shadow.

It is understood that in some embodiments, the visual properties of the virtual shadow includes additional or alternative aspects of a visual appearance of the virtual shadow, including the first visual property. For example, a visual appearance of the virtual shadow optionally includes a color, level of opacity, saturation, radius of an applied blurring effect (e.g., the same as, or different from the “scale” of the virtual shadow”), a simulated lighting effect, and/or similar visual properties of a border including a set of line(s) and/or curve(s) circumscribing and/or entirely surrounding edges of the virtual shadow. It is further understood that a magnitude of change of values of the visual properties (e.g., changes in level of opacity, saturation, radius of the blurring effect, simulated intensity of the simulated lighting, and/or similar properties of the border) optionally are determined in accordance with the distance (e.g., first distance, second distance, and/or another distance) between the location of the first virtual object and the second virtual object. Additionally or alternatively, the relative polarity of the change (e.g., increasing or decreasing) optionally is based upon the change in distance between the first and the second virtual object, similar to or the same as described with reference to the scale of the virtual shadow above.

In some embodiments, the first visual property of the virtual shadow is determined in accordance with a determination that the first virtual object has snapped and/or is contained by the second virtual object, such as the snapped location of the virtual object that is not displayed in FIG. 7X corresponding to virtual object 712. For example, in accordance with a determination that the first virtual object is contained by the second virtual object (e.g., has already snapped to the snap location relative to the second virtual object) when an input to move the first virtual object is detected, the computer system optionally determines that the first virtual object will not be displayed with a virtual shadow, optionally independently of the spatial relationship between the first virtual object and the second virtual object. For example, in response to detecting input moving the first virtual object while the first virtual object was already within the threshold distance of the second virtual object (and optionally in front of the second virtual object), the computer system forgoes display of the virtual shadow (e.g., sets the first visual property corresponding to opacity of the virtual shadow to 0% opacity). In some embodiments, the computer system initially displays the virtual shadow in response to the first virtual object coming within the threshold distance of the second virtual object. In some embodiments, the computer system initially displays the virtual shadow before the first virtual object comes within the threshold distance of the second virtual object. Changing visual properties of the virtual object in accordance with determinations of a distance between the first virtual object and the second virtual object provides visual feedback indicative of proximity between the first and the second virtual object, thus foreshadowing potential interactions between the first and the second virtual object, reducing the likelihood that the user erroneously initiates such interactions, and thereby reducing power consumption of the computer system processing erroneous interactions.

In some embodiments, displaying the virtual shadow of the first virtual object in response to moving the first virtual object to within the threshold distance of the second location includes displaying an animation of the virtual shadow appearing over a time period, including changing a visual property of the virtual shadow over the time period, such as an animation of virtual shadow 770 from FIG. 7Q to FIG. 7R. For example, the animation includes a changing of the one or more visual properties described herein over a period of time (e.g., 0.01, 0.05, 0.1, 0.2, 0.3, 0.4, 0.5, 0.75, 1, 1.5, or 2 seconds). As an example, in accordance with the determination that the first virtual object moves within the threshold distance of the second virtual object (e.g., to the third location) in response to the first input, and/or while a spatial relationship (e.g., distance and/or orientation) between the first and the second virtual object is maintained, the computer system optionally gradually increases an opacity, scale, saturation, brightness, radius of a blurring effect, and/or gradually increases similar visual properties of a border surrounding the virtual shadow. In some embodiments, the animation is initiated after a delay period. For example, when the first virtual object moves within the threshold distance, the computer system optionally initiates the animation after a threshold period of time (e.g., 0.01, 0.05, 0.1, 0.2, 0.3, 0.4, 0.5, 0.75, 1, 1.5, or 2 seconds), optionally without further moving the first virtual object and/or optionally while the first input requests maintenance of the virtual object at its position and/or orientation within the threshold distance.

In some embodiments, the animation includes a delayed display of the virtual shadow. As an example, the computer system optionally does not display the virtual shadow before the threshold period of time has elapsed in response to detecting that the first virtual object moved within the threshold distance of the second location, and/or initiates display of the virtual shadow after the threshold period of time has elapsed, such as an animation of the virtual shadow 770 from FIG. 7Y to FIG. 7Z. In some embodiments, however, the animation is displayed without delaying the animation (e.g., in response to movement of the first virtual object within the threshold distance of the second virtual object). In some embodiments, progression through the animation of the virtual shadow is based upon a rate of change of distance between the first and the second virtual object. For example, in response to detecting the first virtual object moving within the threshold distance and/or towards the second virtual object at a first virtual speed, the computer system displays a first animation including changing of a visual property (e.g., a scale, a blurring radius, a color, saturation, and/or hue) at a first rate. In response to detecting the first virtual object moving within the threshold distance and/or towards the second virtual object at a second virtual speed, the computer system optionally displays a second animation, similar to the first, but including a changing of the visual property at a second rate, different from (e.g., greater or slower than, corresponding to greater or slower movement towards the second virtual object, respectively) the first rate.

In some embodiments, the computer system displays the virtual shadow in response to detecting input requesting movement of the first virtual object away from the second virtual object, such as an animation of the virtual shadow 770 from FIG. 7Y to FIG. 7Z. For example, as the first virtual object moves while within the threshold distance, and/or generally away from the second location of the second virtual object, the computer system optionally displays a virtual shadow in accordance with a distance between the first and the second virtual objects. In some embodiments, the virtual shadow is displayed with an animation immediately or after a delay period in response to movement of the first virtual object away from the second virtual object. For example, in response to detecting the first virtual object moving while within the threshold distance and/or away from the second virtual object at a first virtual speed, the computer system displays a third animation including a changing of a visual property (e.g., as described previously) at a third rate, different from the first and/or second rate. In some embodiments, the visual property is changed in a direction (e.g., increasing or decreasing a value of the visual property, such as a level of opacity, brightness, scale, saturation, and/or hue) that opposes a direction of the first and/or second animation. As an example, the computer system displays an animation of the virtual shadow growing in scale in response to detecting input moving the first and second virtual objects further away from one another, and/or displays an animation of the virtual shadow shrinking in scale in response to detecting input moving the first and second virtual objects closer toward one another. In some embodiments, the animation of the virtual shadow while the first virtual object is moved away from the second virtual object is independent of a virtual speed at which the distance between the first and second virtual objects is changing. In some embodiments, the animation is dependent upon the virtual speed of the first virtual object relative to the second virtual object, similar as described with reference to movement within the threshold distance toward the second virtual object. Delaying a beginning of display of the virtual shadow reduces erroneous display when moving the first virtual object within the threshold distance of the second virtual object, thereby reducing power consumption and processing required to perform operations to display the virtual shadow.

In some embodiments, displaying the virtual shadow of the first virtual object in response to moving the first virtual object outside of the threshold distance (e.g., the same as, or different from, the threshold distance described with reference to moving the first virtual object into the threshold distance described previously) of the second location includes displaying an animation of the virtual shadow disappearing over a time period, including changing a visual property of the virtual shadow over the time period, such as an animation of the virtual shadow 770 growing larger from FIG. 7Y to FIG. 7Z. For example, the animation includes a changing of the one or more visual properties described herein over a period of time (e.g., 0.01, 0.05, 0.1, 0.2, 0.3, 0.4, 0.5, 0.75, 1, 1.5, or 2 seconds). As an example, in accordance with the determination that the first virtual object moves outside of the threshold distance of the second virtual object in response to the first input, and/or while a spatial relationship (e.g., distance and/or orientation) between the first and the second virtual object is maintained, the computer system optionally gradually decreases an opacity, scale, saturation, brightness, radius of a blurring effect, and/or gradually increases similar visual properties of a border surrounding the virtual shadow. In some embodiments, the animation is initiated after a delay period. For example, when the first virtual object moves outside of the threshold distance, the computer system optionally initiates the animation after a threshold period of time (e.g., 0.01, 0.05, 0.1, 0.2, 0.3, 0.4, 0.5, 0.75, 1, 1.5, or 2 seconds), optionally without further moving the first virtual object and/or optionally while the first input requests maintenance of the virtual object at its position and/or orientation within the threshold distance.

In some embodiments, the animation includes a delayed display of the virtual shadow, such as a delay of the animation of the virtual shadow 770 from FIG. 7Y to FIG. 7Z. As an example, the computer system optionally does not display the virtual shadow before the threshold period of time has elapsed in response to detecting that the first virtual object moved outside of the threshold distance of the second location, and/or ceases display of the virtual shadow after the threshold period of time has elapsed. In some embodiments, however, the animation is displayed without delaying the animation (e.g., in response to movement of the first virtual object outside of the threshold distance of the second virtual object). In some embodiments, progression through the animation of ceasing to display the virtual shadow is based upon a rate of change of distance between the first and the second virtual object. For example, in response to detecting the first virtual object moving outside of the threshold distance and/or away from the second virtual object at a first virtual speed, the computer system displays a first animation including changing of a visual property (e.g., a scale, a blurring radius, a color, saturation, and/or hue) at a first rate. In response to detecting the first virtual object moving outside of the threshold distance and/or away from the second virtual object at a second virtual speed, the computer system optionally displays a second animation, similar to the first, but including a changing of the visual property at a second rate, different from (e.g., greater or slower than, corresponding to greater or slower movement away from the second virtual object, respectively) the first rate.

In some embodiments, the computer system displays the virtual shadow in response to detecting input requesting movement of the first virtual object toward the second virtual object, such as virtual shadow 770 displayed in response to input from hand 716 from FIG. 7Q to FIG. 7R. For example, as the first virtual object moves while within the threshold distance, and/or generally toward the second location of the second virtual object, the computer system optionally displays a virtual shadow in accordance with a distance between the first and the second virtual objects. In some embodiments, the virtual shadow ceases to be displayed with an animation immediately or after a delay period in response to movement of the first virtual object toward the second virtual object. For example, in response to detecting the first virtual object moving while outside of the threshold distance and/or toward the second virtual object at a first virtual speed, the computer system displays a third animation including a changing of a visual property (e.g., as described previously) at a third rate, different from the first and/or second rate. In some embodiments, the visual property is changed in a direction (e.g., increasing or decreasing a value of the visual property, such as a level of opacity, brightness, scale, saturation, and/or hue) that opposes a direction of the first and/or second animation. As an example, the computer system displays an animation of the virtual shadow growing in scale in response to detecting input moving the first and second virtual objects further away from one another, and/or displays an animation of the virtual shadow shrinking in scale in response to detecting input moving the first and second virtual objects closer toward one another. In some embodiments, the virtual shadow is displayed with a progressively lower level of brightness and/or lower level of opacity as the virtual shadow increases in scale, and/or is displayed with a progressively higher level of brightness and/or higher level of opacity as the virtual shadow decreases in scale. In some embodiments, the animation of the virtual shadow while the first virtual object is moved toward the second virtual object is independent of a virtual speed at which the distance between the first and second virtual objects is changing. In some embodiments, the animation is dependent upon the virtual speed of the first virtual object relative to the second virtual object, similar as described with reference to movement within the threshold distance away from the second virtual object. Delaying ceasing to display the virtual shadow reduces erroneous display when moving the first virtual object outside of the threshold distance of the second virtual object, thereby reducing power consumption and processing required to perform operations to display the virtual shadow.

In some embodiments, the second virtual object includes content at a plurality of different heights relative to a reference plane for the second virtual object (e.g., a plane that is treated as a surface of the second virtual object and is optionally tilted to face a viewpoint of the user by default when the second virtual object is oriented relative to a viewpoint of the user), such as a height of content included in and/or not overlapping with menu 766, and/or a height of content corresponding to menu 766 in FIG. 7R. For example, the second virtual object includes and/or is associated with a third virtual object that is optionally concurrently displayed with the first and the second virtual object. In some embodiments, the third virtual object includes a user interface and/or visual representations of one or more settings associated with the second virtual object. It is understood that embodiments that are described with reference to “heights” of content include a distance that virtual content is located relative to a reference plane associated with the second virtual object. In some embodiments, the reference plane is parallel to the second virtual object, such as a when the second virtual object is a two-dimensional virtual object. In some embodiments, the “height” of the third virtual object optionally includes the distance between a surface of the third virtual object and the reference plane.

For example, the third virtual object is optionally a settings user interface includes one or more selectable options that optionally change one or more settings of the second virtual object and/or content included in the second virtual object, such as menu 766 in FIG. 7R. In some embodiments, the third virtual object is associated with the second virtual object due to a hierarchical relationship between the second and third virtual object. For example, the second virtual object is optionally a virtual window including a user interface for one or more software applications, and the third virtual object is optionally a virtual window and/or menu including settings, information, media, representations of users of other computer systems (e.g., video, depictions of audio levels, and/or image(s)) associated with the one or more software applications, optionally displayed in response to selection of an element (e.g., a button) displayed within the second virtual object (e.g., selection of a “menu” button). Thus, the second virtual object includes and/or corresponds to content (e.g., the third virtual object) at different heights relative to a reference plane for the second virtual object.

In some embodiments, the third virtual object is at least temporarily position and/or orientation locked relative to the second virtual object, such as the orientation and/or position of menu 766 relative to virtual object 760. For example, the third virtual object optionally is displayed with an orientation that is the same and/or different as the orientation of the second virtual object. In such an example, the computer system optionally changes the orientation of the third virtual object in a direction and by a magnitude in accordance with changes in orientation of the second virtual object (e.g., in a similar or same direction and/or by a similar or same magnitude). In some embodiments, the third virtual object is displayed at a location that is a respective height away from the second virtual object. For example, the third virtual object is optionally displayed with a same orientation, and at a predetermined height (e.g., 0.01, 0.05, 0.0.75, 0.1, 0.25, 0.5, 0.75, or 1 m) relative to the second virtual object. Thus, the second and the third virtual object optionally have different depths relative to the viewpoint of the user of the computer system. As an example, the third virtual object optionally is displayed closer to, obscuring, and/or otherwise overlaying the second virtual object relative to the viewpoint of the user. In some embodiments, in response to detecting changes in the location of the second virtual object, the computer system changes the location of the third virtual object (e.g., in a similar or same direction and/or by a similar or same magnitude).

In some embodiments, the position of the third virtual object presents a simulated overlapping with the second virtual object. For example, when the viewpoint of the user is normal to a front-surface of the second virtual object and/or the third virtual object, and the second virtual object is “behind” the third virtual object relative to the user's viewpoint, the third virtual object optionally is displayed with a relatively increased degree of visual prominence (e.g., opacity) and/or the second virtual object is displayed with a relatively decreased degree of visual prominence (e.g., opacity). In some embodiments, the portions of the respective virtual objects that are displayed with changed degrees of visual prominence mimic the effect of physical equivalents of the virtual objects placed at physical locations and presenting a physical obscuring relative to the user's viewpoint. Thus, in some embodiments, the third virtual object effectively is displayed at a fixed location and/or orientation relative to the second virtual object, similar to as though the third virtual object were hovering away from the second virtual object. In some embodiments, in response to an express request, the third virtual object is freed of an orientation and/or position lock relative to the second virtual object. In such embodiments, the computer system moves the third virtual object independent of its location and/or orientation relative to the second virtual object.

In some embodiments, while moving the first virtual object in the three-dimensional environment in accordance with the first input (e.g., while the first virtual object is snapped to the second virtual object), the computer system displays the first virtual object at a distance relative to the reference plane for the second virtual object that is selected based on a height of content over which the first virtual object is displayed, such as a height of content included in virtual object 760 and not overlapping with menu 766 relative to a reference plane corresponding to a surface of virtual object 760 as shown in FIG. 7S. For example, as described with reference to step(s) 802.

In some embodiments, displaying the first virtual object at the distance relative to the reference plan includes, in accordance with a determination that the first virtual object is over first content with a first height relative to the reference plane, the distance between the first virtual object and the reference plane is a first distance, and in accordance with a determination that the first virtual object is over second content with a second height, different from the first height, relative to the reference plane, the distance between the first virtual object and the reference plane is a second distance, different from the first distance, such as a height of content included in virtual object 760 and not overlapping with menu 766 relative to a reference plane corresponding to a surface of virtual object 760 as shown in FIG. 7S.

For example, the first virtual object is optionally displayed at a height relative to the reference plane of the second virtual object corresponding to a height of content included in and/or associated with the second virtual object. For example, content included in a user interface included in the second virtual object is optionally a first height relative to the reference plane. As an additional example, content included in the third user interface object is optionally a second height relative to the reference plane.

For example, the first virtual object is displayed with an orientation that is based on or independent of the orientation of the second virtual object as described with reference to step(s) 802. For example, during a movement of the first virtual object in accordance with the first input, the computer system displays the first virtual object relatively offset from a portion of the third virtual object. In response to a request to move the virtual object in a first direction, such as parallel to the front surface of the second virtual object and/or the third virtual object, the computer system optionally increases a relative height (e.g., distance) between the first and the second virtual objects, and/or the first and the third virtual objects. For example, movement of the user's hand maintaining an air pinch gesture-described further with reference to step(s) 802—in a first direction optionally is detected, and/or optionally corresponds to a request to translate the first virtual object in the first direction. In accordance with a determination that the requested location of the first virtual object is within the second threshold distance of the third virtual object (e.g., the respective location), the computer system optionally moves the first virtual object a first distance in the first direction, and additionally moves the first virtual object a second distance in a second direction (e.g., along an axis normal to a front surface of the third virtual object). Thus, the computer system optionally moves the first virtual object in a direction that is not expressly requested in accordance with a determination that the first virtual object moves over different content displayed at different heights relative to the second virtual object.

In some embodiments, the computer system maintains an offset (e.g., height) between the first virtual object relative to another respective virtual object while moving relative to the respective virtual object, such as a height between virtual object 712 and virtual object 760 from FIG. 7S to FIG. 7T. For example, while moving the first virtual object in accordance with user input, the computer system optionally offsets the first virtual object a height (e.g., 0.001, 0.005, 0.01, 0.05, 0.075, 0.1, 0.15, 0.25, 0.5, or 1 m) relative to a surface of the second virtual object in accordance with a determination that the first virtual is moving over the first virtual object, and not yet moving over the third virtual object. Additionally, the computer system optionally offsets the first virtual object a same, or similar height relative to the third virtual object while moving over the third virtual object. In some embodiments, the offset height that is maintained between the first virtual object and the second virtual object and/or between the first virtual object and the third virtual object is based upon the height between the second virtual object and the third virtual object. For example, in accordance with a determination that a virtual menu extruded from a virtual window (and/or the reference plane of the virtual window) is a first height, the offset between a virtual object (e.g., the first virtual object) being moved relatively close to and along a surface of the virtual window is a respective first height. In accordance with a determination that the virtual menu is extruded a second height, different form the first height, from the virtual window, the computer system maintains an offset of a respective second height, different from (e.g., greater or less than) the respective first height as the virtual object is moved across the virtual window and/or the virtual menu. In some embodiments, the computer system moves the first virtual object in accordance with a request for such movement, and/or forgoes the automatic movement in a direction and/or by a magnitude that was not expressly requested. For example, when the computer system detects that the first virtual object is moving outside of the second threshold height relative to the respective location and/or the third virtual object, the computer system forgoes applying an additional offset of the first virtual object relative to the virtual object while moving the first virtual object that remains displayed the second height from the second virtual object.

In some embodiments, the one or more first criteria additionally or alternatively include one or more respective criterion. For example, the one or more first criteria include a criterion that is satisfied when at least a first portion of the first virtual object overlaps with the third virtual object relative to the viewpoint of the user, a criterion that is satisfied when the first virtual object intersects with the third virtual object, and/or a criterion that is satisfied when an amount of the first virtual object that overlaps with the third virtual object is greater than a threshold amount (e.g., an area of a surface of the first virtual object, and/or a volume of the first virtual object exceeds a threshold area and/or volume). In some embodiments, the one or more criteria additionally or alternatively include a criterion that is satisfied when a particular portion of the first virtual object (e.g., a center of the first virtual object, a center of a face of the first virtual object, a corner of the first virtual object, and/or a point along a boundary of the first virtual object) intersects and/or is within a threshold height-similar to or the same as the threshold height(s) described herein—of the third virtual object. In some embodiments, the one or more criteria include respective criterion that are satisfied when the first virtual object overlaps with the third virtual object, independently of the viewpoint of the user. For example, the computer system offsets the first virtual object from the third virtual object in accordance with a determination that the first virtual object moves within the threshold height measured relative to a normal extending from a surface of the third virtual object (e.g., and/or of a reference plane of the third virtual object that has one or more characteristics of the reference plane of the second virtual object). It is understood that the one or more second criteria optionally apply to a spatial relationship between the first and the second virtual objects, the one or more second criteria similar to the one or more first criteria, but satisfied based upon the first virtual object moving relative to the second virtual object. Moving the first virtual object to the fifth or the sixth location in accordance with a determination that the one or more first criteria are satisfied reduces an apparent collision between the first virtual object and the third virtual object, thus reducing inputs required to expressly request resolution of the apparent collision and/or to avoid the apparent collision, thereby reducing processing and power consumption of the computer system.

In some embodiments, displaying the first virtual object with a distance relative to the reference plane for the second virtual object that is selected based on a height of content over which the first virtual object is displayed, includes adjusting a distance of the first virtual object from the reference plane based on a height of a first type of content in the second virtual object to a greater degree than adjusting a distance of the first virtual object from the reference plane based on a height of a second type of content in the second virtual object, such as a height of content virtual object and/or overlapping with virtual object 727 relative to a reference plane corresponding to a surface of virtual object 768 as shown in FIG. 7V. In some embodiments, the distance of the first virtual object from the reference plane is adjusted based on a height of a first type of content (e.g., a flat virtual object such as a window, menu, image or text) and/or not adjusting the distance of the first virtual object from the reference plane based on a height of a second type of virtual content (e.g., a three-dimensional object such as a three-dimensional model).

In some embodiments, the computer system offsets movement of the first virtual object in accordance with a determination that the first virtual object moves within a second threshold distance of the third virtual object that is a two-dimensional object (e.g., a flat virtual object, such as a window including a user interface of an application, a menu, an image, and/or text), such as virtual object 760 in FIG. 7R. Additionally or alternatively, the computer system offsets the first virtual object in accordance with a determination one or more criteria are satisfied, including a criterion satisfied when a simulated thickness and/or depth of the second virtual object is less than a threshold depth (e.g., 0.0001, 0.0005, 0.001, 0.005, 0.01, 0.05, 0.1, 0.2, 0.3, or 0.5 m). For example, the third virtual object optionally is a curved window that is nearly flat, or flat, along the curvature of the curved window. In some embodiments, the computer system forgoes the offsetting of the second virtual object relative to the third virtual object in accordance with a determination that the third virtual object is a three-dimensional object, such as virtual object 727 as shown in FIG. 7V. For example, the third virtual object extends in three dimensions relative to the three-dimensional environment, and is optionally a virtual model of a physical object, a virtually synthesized lacking a physical analog, and/or a plurality of virtual objects, such as a virtual representation of a scaled-down physical environment. Moving the first virtual object to the fifth location in accordance with a determination that the third virtual object is a two-dimensional object reduces the likelihood that the first distance that the first virtual object is moved to, relative to the respective location of the third virtual object, is not too close to the viewpoint of the user, thus reducing visibility of the third virtual object, and/or virtual content behind the first virtual object, and thereby reducing processing and power consumption required to perform operations erroneously requested based on the visual obstruction.

In some embodiments, aspects/operations of methods 800 and/or 900 may be interchanged, substituted, and/or added between these methods. For example, moving virtual objects in methods 800 and/or 900, the virtual objects of methods 800 and/or 900, the container objects of methods 800 and/or 900, and/or the movement rules of virtual objects of methods 800 and/or 900 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component and one or more input devices:
displaying, via the display generation component, a first virtual object at a first location and a second virtual object at a second location, different from the first location, in a three-dimensional environment, wherein the second virtual object is a container that is able to contain the first virtual object, and wherein the first location is greater than a threshold distance from the second location;
while displaying, via the display generation component, the first virtual object at the first location and the second virtual object at the second location, detecting, via the one or more input devices, a first input corresponding to a request to move the first virtual object away from the first location in the three-dimensional environment; and
in response to detecting the first input:
moving the first virtual object in the three-dimensional environment in accordance with the first input, including:
in accordance with a determination that the first input corresponds to movement of the first virtual object to a third location in the three-dimensional environment that is within the threshold distance of the second location of the second virtual object, displaying the first virtual object with an orientation in the three-dimensional environment that is based on an orientation of the second virtual object; and
in accordance with a determination that the first input corresponds to movement of the first virtual object to a fourth location in the three-dimensional environment that is further than the threshold distance from the second location of the second virtual object, displaying the first virtual object with an orientation that is independent of an orientation of the second virtual object.

2. The method of claim 1, further comprising:
while detecting the first input and in accordance with a determination that the first virtual object is further than the threshold distance from any virtual object that is a container that is able to contain the first virtual object, displaying the first virtual object with an orientation that is based on a viewpoint of a user of the computer system.

3. The method of claim 1, further comprising:
displaying, via the display generation component, a third virtual object at a third location, different from the second location of the second virtual object, in the three-dimensional environment, wherein the third virtual object is a second container that is able to contain the first virtual object;
while moving the first virtual object in the three-dimensional environment in accordance with the first input, detecting that the first virtual object is within the threshold distance of the third location of the third virtual object; and
in response to detecting that the first virtual object is within the threshold distance of the third location of the third virtual object, displaying the first virtual object with an orientation that is based on an orientation of the third virtual object.

4. The method of claim 1, wherein the first virtual object is spatially arranged at a distance apart from the second virtual object while the first virtual object is within the threshold distance of the second virtual object.

5. The method of claim 1, further comprising:
while moving the first virtual object in the three-dimensional environment in accordance with the first input:
in accordance with a determination that the first virtual object is within the threshold distance of the second location of the second virtual object, moving the first virtual object in a linear path in accordance with at least a portion of the first input; and
in accordance with a determination that the first virtual object is further than the threshold distance from the second location of the second virtual object, moving the first virtual object along a curved path in accordance with the at least the portion of the first input.

6. The method of claim 1, further comprising:
while moving the first virtual object in the three-dimensional environment in accordance with the first input, detecting that at least a portion of the first input corresponds to moving the first virtual object away from the second virtual object; and
in response to detecting the at least the portion of the first input corresponding to moving the first virtual object away from the second virtual object, moving the first virtual object along a curved path away from the second virtual object.

7. The method of claim 1, further comprising:
while moving the first virtual object in the three-dimensional environment in accordance with the first input, detecting that the first virtual object reaches a location that is within the threshold distance of the second virtual object in the three-dimensional environment; and in response to detecting that the first virtual object reaches the location that is within the threshold distance of the second virtual object in the three-dimensional environment, moving the first virtual object to a respective location corresponding to the second virtual object without detecting input for moving the first virtual object to the respective location corresponding to the second virtual object.

8. The method of claim 7, wherein moving the first virtual object to the respective location corresponding to the second virtual object includes changing a size of the first virtual object to display the first virtual object with a size at the respective location that is based on a size of the second virtual object.

9. The method of claim 7, wherein moving the first virtual object to the respective location corresponding to the second virtual object includes moving the first virtual object closer to the second virtual object.

10. The method of claim 7, wherein moving the first virtual object to the respective location corresponding to the second virtual object includes changing an orientation of the first virtual object to display the first virtual object with an orientation in the three-dimensional environment that is based on the orientation of the second virtual object.

11. The method of claim 7, further comprising:
while displaying the first virtual object at the respective location corresponding to the second virtual object, detecting, via the one or more input devices, a second input corresponding to a request to move the first virtual object away from the second virtual object in the three-dimensional environment; and
in response to detecting the second input:
in accordance with a determination that the second input corresponds to movement of the first virtual object to a distance greater than the threshold distance and less than a second threshold distance from the second virtual object, moving the first virtual object to a location corresponding to the second virtual object where the orientation of the first virtual object is at least partially based on the orientation of the second virtual object; and in accordance with a determination that the second input corresponds to movement of the first virtual object to a distance greater than the second threshold distance from the second virtual object, moving the first virtual object in the three-dimensional environment to a location that does not correspond to the second virtual object where the orientation of the first virtual object is not based on the orientation of the second virtual object.

12. The method of claim 7, wherein:
in accordance with a determination that the location of the first virtual object relative to the second virtual object when it reaches the threshold distance from the second virtual object is a first respective location, the respective location corresponding to the second virtual object is a second respective location; and
in accordance with a determination that the location of the first virtual object relative to the second virtual object when it reaches the threshold distance from the second virtual object is a third respective location, different from the first respective location, the respective location corresponding to the second virtual object is a fourth respective location, different from the second respective location.

13. The method of claim 12, wherein the respective location corresponding to the second virtual object is based on a projection, to the second virtual object, of a line between a viewpoint of a user of the computer system and the location of the first virtual object relative to the second virtual object when the first virtual object reaches the threshold distance from the second virtual object.

14. The method of claim 12, wherein the respective location corresponding to the second virtual object is based on a perpendicular projection from a surface of the second virtual object to the location of the first virtual object relative to the second virtual object when it reaches the threshold distance from the second virtual object.

15. The method of claim 12, wherein the respective location corresponding to the second virtual object is based on a respective angle of a viewpoint of a user relative to the second virtual object.

16. The method of claim 15, further comprising:
while moving the first virtual object in the three-dimensional environment in accordance with the first input and in response to detecting that the first virtual object reaches the location that is within the threshold distance of the second virtual object in the three-dimensional environment:
in accordance with a determination that the respective angle of the viewpoint of a user of the computer system relative to the second virtual object is within a first range of angles, displaying the first virtual object at a respective location corresponding to the second virtual object based on a projection, to the second virtual object, of a line between a viewpoint of the user and the location of the first virtual object relative to the second virtual object when the first virtual object reaches the threshold distance from the second virtual object; and
in accordance with a determination that the respective angle of the viewpoint of the user relative to the second virtual object is within a second range of angles, different from the first range of angles, displaying the first virtual object at a respective location corresponding to the second virtual object based on a perpendicular projection from a surface of the second virtual object to the location of the first virtual object relative to the second virtual object when the first virtual object reaches the threshold distance from the second virtual object.

17. The method of claim 7, wherein the threshold distance is based on a respective bounding volume associated with the first virtual object, wherein the respective bounding volume is based on one or more dimensions of the first virtual object.

18. The method of claim 17, wherein in accordance with a determination that the first virtual object is a two-dimensional object, the respective bounding volume has a depth dimension that is independent of a size of the first virtual object.

19. The method of claim 1, further comprising:
while displaying, via the display generation component, the first virtual object in the three-dimensional environment, detecting, via the one or more input devices, a second input corresponding to a request to move the first virtual object away from the second virtual object; and
in response to detecting the second input:
in accordance with a determination that the first virtual object was within the threshold distance of the second virtual object when the second input was detected, moving the first virtual object away from the second virtual object by a first distance; and
in accordance with a determination that the first virtual object was further than the threshold distance from the second virtual object when the second input was detected, moving the first virtual object away from the second virtual object by a second distance, greater than the first distance.

20. The method of claim 19, wherein the request to move the first virtual object away from the second virtual object includes movement in a depth direction relative to the second virtual object.

21. The method of claim 19, wherein the request to move the first virtual object away from the second virtual object includes movement in a lateral direction relative to the second virtual object.

22. The method of claim 19, further comprising:
in response to detecting the second input and in accordance with the determination that the first virtual object was within the threshold distance of the second virtual object when the second input was detected:
in accordance with a determination that the second input corresponds to movement of the first virtual object in a depth direction relative to the second virtual object, moving the first virtual object away from a respective location corresponding to the second virtual object by a first respective distance; and
in accordance with a determination that the second input corresponds to movement of the first virtual object in a lateral direction relative to the second virtual object, moving the first virtual object away from the respective location corresponding to the second virtual object by a second respective distance, greater than the first respective distance.

23. The method of claim 19, wherein moving the first virtual object away from the second virtual object by the first distance includes moving the first virtual object based on a first simulated spring between the second virtual object and the first virtual object, and a second simulated spring between the first virtual object and a location in the three-dimensional environment corresponding to the second input, wherein the location corresponding to the second input changes in accordance with the second input.

24. The method of claim 19, further comprising:
in response to detecting the second input:
in accordance with a determination that the second input corresponds to movement of the first virtual object to a location that is less than a second threshold distance away from the second virtual object, moving the first virtual object to a respective location corresponding to the second virtual object; and
in accordance with a determination that the second input corresponds to movement of the first virtual object to a location that is greater than the second threshold distance away from the second virtual object, moving a third virtual object to a respective location in the three-dimensional environment that does not correspond to the second virtual object.

25. The method of claim 24, wherein the second threshold distance is based on a respective bounding volume associated with the first virtual object, wherein the respective bounding volume is based on one or more dimensions of the first virtual object.

26. The method of claim 25, wherein in accordance with a determination that the first virtual object is a two-dimensional object, the respective bounding volume associated with the first virtual object has a depth dimension that is independent of a size of the first virtual object.

27. The method of claim 24, wherein the second threshold distance is different from the threshold distance.

28. The method of claim 24, further comprising while receiving the second input and before the second input corresponds to movement of the first virtual object to the location that is greater than the second threshold distance away from the second virtual object, moving the first virtual object by a first amount in accordance with the second input.

29. The method of claim 28, further comprising while receiving the second input and in response to the second input corresponding to movement of the first virtual object to the location that is greater than the second threshold distance away from the second virtual object, moving the first virtual object with a second amount of velocity, greater than a first amount of velocity, in accordance with the second input, wherein the first virtual object is moved with the first amount of velocity while receiving the second input and before the first virtual object reaches the second threshold distance away from the second virtual object.

30. The method of claim 19, further comprising while receiving the second input and before the second input corresponds to movement of the first virtual object to a location that is greater than a second threshold distance away from the second virtual object, changing an orientation of the first virtual object so that it is not oriented based on the second virtual object.

31. The method of claim 30, further comprising while receiving the second input and in response to the second input corresponding to movement of the first virtual object to the location that is greater than the second threshold distance away from the second virtual object, changing the orientation of the first virtual object with a rate of change towards not being oriented based on the second virtual object.

32. The method of claim 19, wherein moving the first virtual object away from the second virtual object by the first distance in accordance with the second input includes changing an appearance of the first virtual object to indicate that the first virtual object is moving away from the second virtual object.

33. The method of claim 19, further comprising:
while moving the first virtual object away from the second virtual object in accordance with the second input, detecting termination of the second input; and
in response to detecting the termination of the second input, in accordance with a determination that a current location of the first virtual object is not within the threshold distance of any virtual object that is a container that is able to contain the first virtual object, displaying a third virtual object at the current location of the first virtual object, wherein the third virtual object contains the first virtual object at the current location of the first virtual object, and the third virtual object was not displayed in the three-dimensional environment prior to detecting the termination of the second input.

34. The method of claim 19, wherein the three-dimensional environment further includes a third virtual object, wherein the third virtual object is a container that is able to contain the first virtual object, the method further comprising:
while moving the first virtual object away from the second virtual object in accordance with the second input, in accordance with a determination that the first virtual object is within the threshold distance of the third virtual object, displaying the first virtual object at a respective location corresponding to the third virtual object, including displaying the first virtual object with an orientation in the three-dimensional environment that is based on an orientation of the third virtual object.

35. The method of claim 1, further comprising:
in response to detecting the first input, and in accordance with the determination that the first input corresponds to movement of the first virtual object to the third location that is within the threshold distance of the second location of the second virtual object, displaying, via the display generation component, a virtual shadow of the first virtual object.

36. The method of claim 35, wherein displaying the virtual shadow of the first virtual object includes:
in accordance with a determination that the third location is a first distance away from the second location, displaying the virtual shadow of the first virtual object with a first visual property having a first value, and
in accordance with a determination that the third location is a second distance away from the second location, different from the first distance, displaying virtual shadow of the first virtual object with the first visual property having a second value, different from the first value.

37. The method of claim 35, wherein displaying the virtual shadow of the first virtual object in response to moving the first virtual object to within the threshold distance of the second location includes displaying an animation of the virtual shadow appearing over a time period, including changing a visual property of the virtual shadow over the time period.

38. The method of claim 35, wherein displaying the virtual shadow of the first virtual object in response to moving the first virtual object outside of the threshold distance of the second location includes displaying an animation of the virtual shadow disappearing over a time period, including changing a visual property of the virtual shadow over the time period.

39. The method of claim 1, wherein:
the second virtual object includes content at a plurality of different heights relative to a reference plane for the second virtual object; and
the method further comprises, while moving the first virtual object in the three-dimensional environment in accordance with the first input, displaying the first virtual object with a distance relative to the reference plane for the second virtual object that is selected based on a height of content over which the first virtual object is displayed, including:
in accordance with a determination that the first virtual object is over first content with a first height relative to the reference plane, the distance between the first virtual object and the reference plane is a first distance; and
in accordance with a determination that the first virtual object is over second content with a second height, different from the first height, relative to the reference plane, the distance between the first virtual object and the reference plane is a second distance, different from the first distance.

40. The method of claim 39, wherein displaying the first virtual object with a distance relative to the reference plane for the second virtual object that is selected based on a height of content over which the first virtual object is displayed, includes adjusting a distance of the first virtual object from the reference plane based on a height of a first type of content in the second virtual object to a greater degree than adjusting a distance of the first virtual object from the reference plane based on a height of a second type of content in the second virtual object.

41. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via the display generation component, a first virtual object at a first location and a second virtual object at a second location, different from the first location, in a three-dimensional environment, wherein the second virtual object is a container that is able to contain the first virtual object, and wherein the first location is greater than a threshold distance from the second location;
while displaying, via the display generation component, the first virtual object at the first location and the second virtual object at the second location, detecting, via the one or more input devices, a first input corresponding to a request to move the first virtual object away from the first location in the three-dimensional environment; and
in response to detecting the first input:
moving the first virtual object in the three-dimensional environment in accordance with the first input, including:
in accordance with a determination that the first input corresponds to movement of the first virtual object to a third location in the three-dimensional environment that is within the threshold distance of the second location of the second virtual object, displaying the first virtual object with an orientation in the three-dimensional environment that is based on an orientation of the second virtual object; and
in accordance with a determination that the first input corresponds to movement of the first virtual object to a fourth location in the three-dimensional environment that is further than the threshold distance from the second location of the second virtual object, displaying the first virtual object with an orientation that is independent of an orientation of the second virtual object.

42. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, a first virtual object at a first location and a second virtual object at a second location, different from the first location, in a three-dimensional environment, wherein the second virtual object is a container that is able to contain the first virtual object, and wherein the first location is greater than a threshold distance from the second location;
while displaying, via the display generation component, the first virtual object at the first location and the second virtual object at the second location, detecting, via the one or more input devices, a first input corresponding to a request to move the first virtual object away from the first location in the three-dimensional environment; and
in response to detecting the first input:
moving the first virtual object in the three-dimensional environment in accordance with the first input, including:
in accordance with a determination that the first input corresponds to movement of the first virtual object to a third location in the three-dimensional environment that is within the threshold distance of the second location of the second virtual object, displaying the first virtual object with an orientation in the three-dimensional environment that is based on an orientation of the second virtual object; and
in accordance with a determination that the first input corresponds to movement of the first virtual object to a fourth location in the three-dimensional environment that is further than the threshold distance from the second location of the second virtual object, displaying the first virtual object with an orientation that is independent of an orientation of the second virtual object.

43.-66. (canceled)
